(19) United States
(12) Patent Application Publication
(10) Pub. No.: US 2007/0072156 A1
(43) Pub. Date: Mar. 29, 2007

(54) Lifestyle coach behavior modification system

(75) Inventors: Neal Kaufman, Los Angeles, CA (US); Adam Kaufman, Los Angeles, CA (US)

Correspondence Address: PILLSBURY WINTHROP SHAW PITTMAN LLP, P.O BOX 10500, McLean, VA, 22102, US

(73) Assignee: ABK VENTURES, Los Angeles, CA (US)

(21) Appl. No.: 11/499,194

(22) Filed: Aug. 4, 2006

Related U.S. Application Data
(60) Provisional application No. 60/705,842, filed on Aug. 5, 2005.

(51) Int. Cl. G09B 19/00

(52) U.S. Cl. 434/236

(57) ABSTRACT

A method to support a user adopting healthy habits and behaviors includes viewing lectures on healthy habits and behaviors, the lectures being stored on a computing device. A current level of the user's behavior after receiving background information from the user is presented to the user. An action goal is set and stored. An action plan is created to reach the action goal and the action plan is stored. Behaviors of the user are tracked by receiving input regarding the behaviors and behavior measurements are generated. Results are generated by comparing the behavior measurements against the action goal and the action plan. Information is displayed to assist the user to overcome barriers in order to reach the action goal.

### CROSS-REFERENCE TO RELATED APPLICATIONS

This application claims priority to provisional application Ser. No. 60/705,842, filed Aug. 5, 2005.

### BACKGROUND OF THE INVENTION

1. Field of the Invention

The field of the invention is generally related to a computerized system to allow a user to modify behavior. Specifically, the invention is related to a device and a computer system to educate users about behavior modification, to display to users where the user is currently on a behavior scale, to establish a behavior goal for the user, to track activities completed by the user, and to compare the user's activities against the behavior goal.

2. Description of Related Art

Individuals face a number of challenges in attempting to maintain a healthy lifestyle. The lengthening of the work day, the prevalence of fast food and non-healthy eating choices, and long commutes make it difficult for individuals to eat right, engage in physical activity, and not participate in behaviors (like smoking) that can damage the individual's health. In addition, the individual may have established medical regiments to follow or the individual may have to monitor physiological parameters (such as blood pressure and blood sugar) on a frequent basis in order to maintain a healthy lifestyle. With all of an individual's other time commitments, it is sometimes difficult to engage in the appropriate behaviors.

Existing methodologies for changing lifestyle behaviors require that the individual interact with a professional in order for the methodology to be successful. For example, the individual may have to interface with a doctor, a personal trainer, a lifestyle coach, or a worksite wellness coordinator in order to utilize the existing methodologies. This type of design limits the amount of individuals that one professional can interact with. Also, because the professional can only interact with a limited amount of individuals, the cost of implementing these methodologies is prohibitively expensive.

### BRIEF DESCRIPTION OF THE DRAWINGS

FIG. 1(a) illustrates a Lifestyle Coach system according to an embodiment of the present invention;

FIG. 1(b) illustrates a Lifestyle Coach application software time cycle according to an embodiment of the present invention;

FIG. 1(c) illustrates a system utilizing the Lifestyle Coach system according to an embodiment of the present invention;

FIG. 2 illustrates a Lifestyle Coach device according to an embodiment of the invention;

FIG. 3 illustrates the Lifestyle Coach application client-side software according to an embodiment of the present invention;

FIG. 4 illustrates Lifestyle Coach online software according to an embodiment of the present invention;

FIGS. 5(a)-5(h) illustrate screen shots of the Lifestyle Coach application software according to an embodiment of the present invention;

FIGS. 6(a) and 6(b) illustrate an application process for a user of the Lifestyle Coach application software and a logon screen according to an embodiment of the invention;

FIGS. 7(a)-7(l) illustrate a lecture regarding diabetes that a user may view during the Learning phase of the Lifestyle Coach application software according to an embodiment of the present invention;

FIGS. 8(a)-8(g) illustrate sample content screens of the healthy living lecture or presentation each user views during the Learning phase of the Lifestyle Coach application software according to an embodiment of the present invention;

FIGS. 9(a)-9(m) illustrates a screen shot and content screens of an About You survey which is part of the Learning process of the Lifestyle Coach application software according to an embodiment of the invention;

FIG. 10(a) illustrates an input screen for the Journey Preparation stage according to an embodiment of the present invention;

FIG. 10(b) illustrates a flowchart identifying the Journey according to an embodiment of the present invention;

FIGS. 10(c)-10(q) illustrates content screens of the Lifestyle Coach Behavior Modification system according to an embodiment of the present invention;

FIGS. 11(a)-11(c) illustrate a sample activity grid and content pages describing an activity grid according to an embodiment of the invention;

FIGS. 12(a)-12(j) illustrate content screens regarding journey preparation and journey mapping according to an embodiment of the invention;

FIG. 12(k) illustrates operation of a history module of the Lifestyle Coach application software according to an embodiment of the present invention;

FIG. 12(l) is an illustrative my history page of the Lifestyle Coach application software;

FIG. 13(a) illustrates a content page highlighting the daily logon activities for the activity tracking of the Lifestyle Coach application software according to an embodiment of the invention;

FIG. 13(b) illustrates a content page highlighting the benefits of connecting to others during your Lifestyle Coach journey according to an embodiment of the invention;

FIG. 14 illustrates how, using physical activity as an example behavior, a user can select a next activity point goal according to an embodiment of the present invention;

FIG. 15(a) illustrates a content page of the activity selection module which identifies activities along with classification of activities which may be selected in the Lifestyle Coach application software according to an embodiment of the present invention;

FIG. 15(b) illustrates a screen shot of an activity grid according to an embodiment of the present invention;

FIG. 15(c) illustrates a pop-up menu for the activity selection module according to an embodiment of the present invention;

FIG. 15(d) illustrates a flowchart of the operation of the suggest activity module according to an embodiment of the present invention;

FIG. 15(e) illustrates operation of the activity suggestion module when the user selects a complete plan according to an embodiment of the present invention;

FIG. 15(f) illustrates operation of the activity commit module according to an embodiment of the present invention;

FIG. 16 illustrates operation of a part of an activity tracking module according to an embodiment of the present invention;

FIG. 17(a) illustrates operation of a progress review module according to an embodiment of the present invention;

FIG. 17(b) illustrates a content page of text that the Lifestyle Coach application software that a user may display to a user if the user has achieved the user's goal;

FIG. 17(c) illustrates a content page of text that the Lifestyle Coach application software may display to a user if the user does not meet the time period activity goals for one or two time periods, e.g., weeks according to an embodiment of the invention;

FIG. 18(a) illustrates a weekly success graph according to an embodiment of the invention;

FIG. 18(b) illustrates a daily detail page according to an embodiment of the present invention;

FIG. 19(a) illustrates operation of the address barrier and motivation module according to an embodiment of the present invention;

FIG. 20(a) illustrates actions which occur at the completion of a user phase according to an embodiment of the present invention;

FIG. 21(a) displays a coach coordinator homepage according to the present invention;

FIG. 21(b) illustrates an add users page of the coach coordinator module according to an embodiment of the present invention;

FIG. 21(c) illustrates a sample email of the coach coordinator module according to an embodiment of the invention;

FIG. 21(d) illustrates a view new users page according to an embodiment of the invention;

FIG. 21(e) illustrates a sample input screen for selecting what users are viewed according to an embodiment of the invention;

FIG. 21(f) illustrates a HIPAA designee homepage according to an embodiment of the present invention;

FIG. 21(g) illustrates an example of these reports according to an embodiment of the present invention; and

FIG. 22 illustrates an accelerometer data research site according to an embodiment of the invention.

### DETAILED DESCRIPTION OF THE INVENTION

The present invention described below with reference to flowchart illustrations of methods, apparatus, and computer program products. It will be understood that each block of the flowchart illustrations, and combinations of blocks in the flowchart illustrations, can be implemented by computer program instructions (as can any menu screens described in the Figures). These computer program instructions may be loaded onto a computer or other programmable data processing apparatus (such as a controller, microcontroller, or processor in a sensor electronics device to produce a machine, such that the instructions which execute on the computer or other programmable data processing apparatus create instructions for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks, and/or menus presented herein.

The Lifestyle Coach system is a computerized system developed to assist individuals in behavior modification in order for the individuals to create and maintain a healthy lifestyle. The Lifestyle Coach system is unique because the Lifestyle Coach system minimizes the time and effort required for healthcare providers or others (e.g., human resources personnel, dieticians, personal trainers, and other similar professionals) to interact with patients. The knowledge in the Lifestyle Coach behavior modification system is resident within the application software and software libraries coupled to the application software. The application software resides on server computers, user computers, and Lifestyle Coach devices. Illustratively, the behaviors modified may be a user's physical activity habits, a user's eating habits, and a user's mental attitude. For example, the Lifestyle Coach Behavior Modification system may be helping the user promote health promoting behaviors such as physical activity, health eating, smoking cessation, medical regiment adhering, blood sugar monitoring, blood pressure monitoring, or other physiologic parameter monitoring.

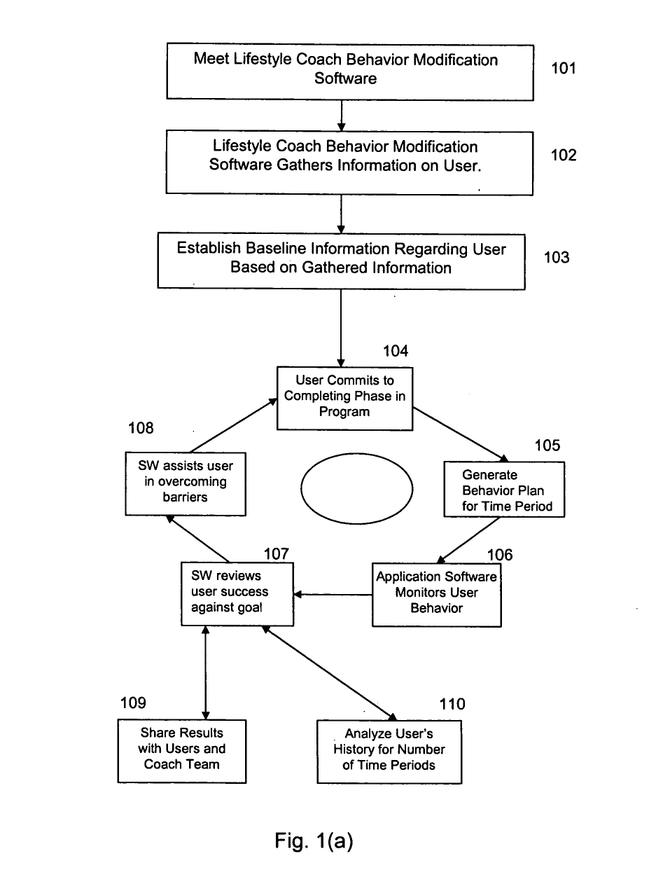

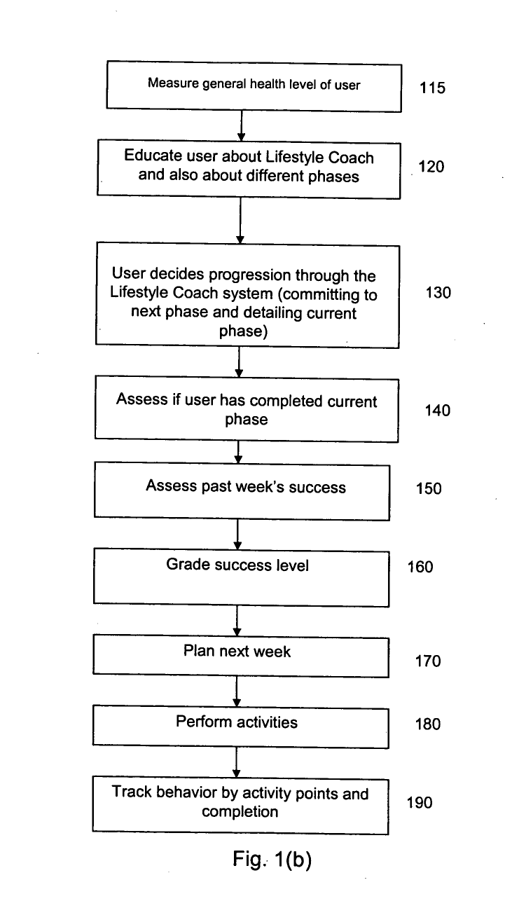

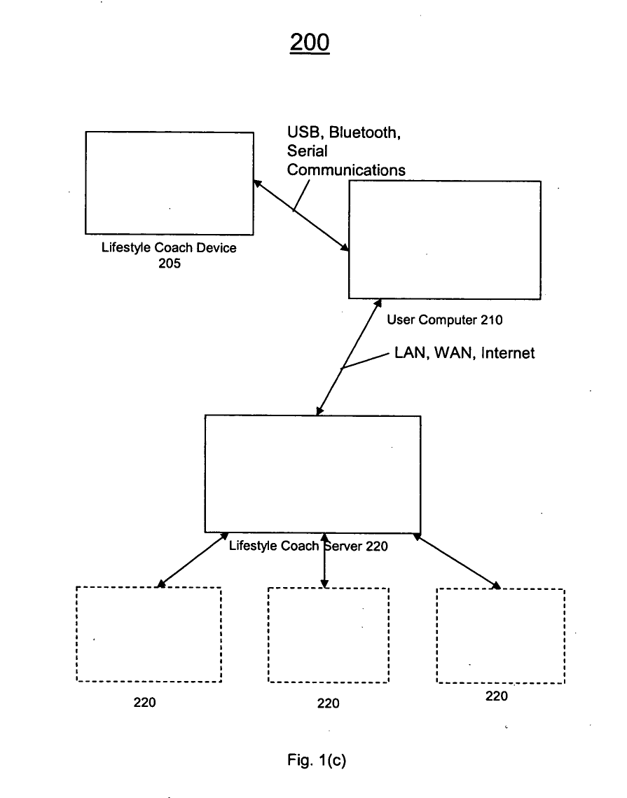

Generally, the Lifestyle Coach system can be divided into four general areas: 1) the user services area; 2) the human relationship area; 3) the quality improvements area; and 4) the technical support area. FIG. 1(a) illustrates a Lifestyle Coach system according to an embodiment of the present invention. In the embodiment of the invention illustrated in FIG. 1(a), the user may meet or be introduced to 101 the Lifestyle Coach system. This meeting process may include the user investigating an introductory web site of the Lifestyle Coach behavior modification system and then enrolling in the Lifestyle Coach behavior modification system. The Lifestyle Coach behavior modification system may educate and motivate the user to achieve a healthy living lifestyle. Under certain operating conditions, the Lifestyle coach behavior modification system may gather knowledge 102 about the user. This may be personal physical information, (such as height, weight, eating habits), psychological information (such as barriers to motivation, readiness to change, etc.), personal medical information, etc. After the user has provided knowledge to the Lifestyle Coach behavior modification system, the Lifestyle Coach behavior modification system may establish 103 baseline information for the user.

After the user's baseline information has been established, the Lifestyle Coach behavior modification system may ask the user to commit 104 to establishing a plan and goals for the behaviors that the user may want to change. In asking the user to commit, the Lifestyle Coach behavior modification system may provide human coaching through designated Lifestyle Coach trainers (i.e., via the computer). The Lifestyle Coach behavior modification system may also allow a user to connect to the user's healthcare team through the Lifestyle Coach behavior modification system. In addition, the Lifestyle Coach behavior modification system may also allow the user to have a support coaching team to assist the user in meeting the user's goals.

After the user has made a commitment to establishing a behavior plan, the Lifestyle Coach behavior modification system may work with the user to create 105 the behavior plan. Illustratively, the behavior plan may be an activity plan that is mapped out on an activity grid. The behavior plan may be a healthy eating plan that is mapped out on a calorie consumption grid. The behavior plan may be a plan to quit smoking, i.e., smoking cessation. The behavior plan may be a plan to take medications on a correct schedule or to monitor blood glucose, blood pressure, or other physiological parameters. After the behavior plan has been created, the user may then execute or perform the behaviors (e.g., perform the activity, eat selected meals, etc.). The Lifestyle Coach behavior modification system may then monitor 106 the user's behaviors as the user is executing the behaviors or after the user has completed the behavior. The Lifestyle Coach behavior modification system may monitor the user's results. The Lifestyle Coach behavior modification system may also work with health care providers and or the user's support team in order to improve intervention with a user if issues arise with the user.

After the Lifestyle Coach behavior modification system has monitored the user's behavior, the Lifestyle Coach behavior modification system may review 107 the user's success against the behavior plan. If the user meets the behavior goal outline in the behavior plan, the user may be advanced to a next level or phase of the behavior or to add one or more additional behaviors. If the user is advanced to a next level or phase, the user is returned to making a commitment 104 and making a behavior plan 105 for the next behavior level or the behavior phase. If the user has not advanced to the next level or phase, the Lifestyle Coach behavior modification system may work with the user to overcome barriers 108 that are present which are preventing the user from reaching his or her behavior goal. The Lifestyle Coach behavior modification system may also be utilized to motivate the user to meet his or her behavior goal. After the user has overcome the barrier, the user may reach the next user phase or goal and then move back to committing to completing the next user phase plus generating a new behavior plan.

The Lifestyle Coach behavior modification software may also allow the user to share 109 results with a number of individuals. One of the individuals may be a coach coordinator who may be overseeing a number of users within the Lifestyle Coach behavior modification system. Other individuals may be family members, friends, co-workers, sponsors, etc. Other individuals may be lifestyle coaches, health care providers, human resources personnel, personal trainers, or worksite wellness coordinators. Additional individuals may be a HIPAA designee. The Lifestyle Coach behavior modification software may also allow the user (or other individuals such as a Coach Coordinator or health care professional) to analyze 110 history of the user. In other words, the user or other individuals may view a number of time periods where the user's behavior has been tracked. The Lifestyle Coach behavior modification software may automatically generate a number of analytical reports. The Lifestyle Coach behavior modification software may also allow a user to create unique reports analyzing specific factors within the user's behavior.

The Lifestyle Coach application software may aid an individual user as the user works to increase an average daily number of activity points. An objective of utilizing the Lifestyle Coach application software is to decrease an individual's risk of developing, for example, Type II Diabetes, lung disease, kidney disease, cardiovascular disease, or other dehabilitating illnesses. An additional objective of the Lifestyle Coach application software is to generally improve the health of the user. The Lifestyle Coach application software is to assist the user in adopting small changes to the user's lifestyles. This may be advantageous for users who cannot afford or may not be able to travel to visit a physical trainer or a lifestyle coach. The Lifestyle Coach application software is a behavior modification, lifestyle change support module.

Illustratively, the Lifestyle Coach application software may be tailored to a certain group of individuals, e.g., a group of individuals who are at an elevated risk for Type II Diabetes or who have an elevated risk of high blood pressure or cardiovascular disease.

The Lifestyle Coach application software may have to segment the users in order to best address user's needs. Illustratively, the users may be segmented by basic demographic issues, the readiness of a user to change, a user's activity level, and the user's physical preparedness (e.g., fitness or disability level). For example, the demographic issues may be employment status, age, education level, and computer proficiency. The readiness of the user to change may include levels such as pre-contemplation, contemplation, preparation, action, and maintenance.

The segments of activity level may be 0-3,000 average daily activity points, 3,000-6,000 average daily activity points, 6,000-9,000 average daily activity points, and 9,000-12,000 average daily activity points. The segments of physical preparedness (or fitness/disability level) may be healthy, ambulatory/non-active, ambulatory and disease failure, frail or elderly, or wheelchair. Illustratively, an original user segment may be users that are employed, 45-65 years old, have a higher education level, and have a high computer proficiency (particularly with Internet applications).

The original user segment may also have a readiness to change (e.g., be in a contemplation, preparation, or activity level stage), have an activity level of 0-3,000 or 3,000-6,000 average activity points, and have a fitness level of health or ambulatory or non-active.

FIG. 1(b) illustrates a Lifestyle Coach application software time cycle according to an embodiment of the present invention. Illustratively, the user may complete some initial actions to setup the user's account in the Lifestyle Coach application software. After the user has established the account, the user utilizes the Lifestyle Coach application software. The user is assigned a phase and enters a phase cycle of the Lifestyle Coach application software. In the phase cycle, the user may interact with the Lifestyle Coach application software in order to measure 115 the general health level of the user. The Lifestyle Coach application software may then educate 120 the user about the Lifestyle Coach system and the different phases in the Lifestyle Coach application software. With the assistance of the Lifestyle Coach application software, the user may decide 130 the progression of the user. In deciding the progression, the user may commit to getting to the next phase. The user may also decide to maintain the current phase.

The user may then enter the weekly planning stage of the Lifestyle Coach application software. In the weekly planning stage, the user may assess 140 if the user has completed the currently assigned phase. In addition, the user, with the assistance of the Lifestyle Coach application software, may assess 150 the past time period's (e.g., week's) success. For example, when the behavior to be changed is physical activity, the user may evaluate the number of activity points earned against the activity point goal. In addition, the user may evaluate the user's daily activity success against the commitments the user has made. Further, the user may evaluate exercise activity success against the commitments the user made. After evaluating the past week's success, the Lifestyle Coach application software may grade 160 the success level of the user for the past week. Included in this evaluation is the user determining the next week's activity goals. The user, with the assistance of the Lifestyle Coach application software may plan 170 the next week's activities. Under the planning, the user may commit to a number of activities for the next time period, e.g., week. The user may also commit to a number of daily activities to work on. The user may also commit to a number of exercise activities to work on.

The user may then enter the daily stage of the Lifestyle Coach application software. In the daily stage, the user may perform 180 activities, either activities committed to or new activities. The user, with the help of the Lifestyle Coach application software, may also track 190 the activities. This may occur by tracking the activity completion which leads to the calculation of activity points for the user.

FIG. 1(c) illustrates a system utilizing the Lifestyle Coach system according to an embodiment of the present invention. The Lifestyle Coach system 200 includes a Lifestyle Coach device 205, a user computer 210, and one or more Lifestyle Coach servers 220, The Lifestyle Coach device may be coupled to the user computer utilizing a wired connection 230 or a wireless connection. In embodiments of the invention, the Lifestyle Coach device 205 may utilize Universal Serial Bus (USB), Bluetooth, or infrared technologies or protocols to communicate with the user computer 210. The user computer may be coupled to the Lifestyle Coach servers 220 via a global communication network 240, e.g., a Local Area Network (LAN), a wide area network (WAN), or the Internet. Lifestyle Coach application software may run on each of the Lifestyle Coach device 205, the user computer 210, and the Lifestyle Coach servers 220. The Lifestyle Coach application software installed on the Lifestyle Coach device may allow the user to track activities and monitor the choices that the user makes. The Lifestyle Coach application software installed on the Lifestyle Coach servers allow the user to establish his activity goals, setup an account, learn information about the Lifestyle Coach system and review the progress that the user has made during the time the user has been enrolled in the Lifestyle Coach program.

A Lifestyle Coach device 205 may be utilized as a personal fitness trainer, a dietician, and/or a life coach. The Lifestyle Coach device 205 may have a software application installed thereon, wherein the software application interacts with a user to assist a person in making lifestyle choices to decrease the user's risk of developing type II diabetes, lung disease, kidney disease, cardiovascular disease, or other dehabilitating illnesses. Under other circumstances, the Lifestyle Coach device 205 may assist a person in making lifestyle choices to curtail a user's progression of an illness. Under certain operating conditions, the Lifestyle Coach device utilizes a point system to assess the user's past and current progress and to motivate the user to reach his or her goal.

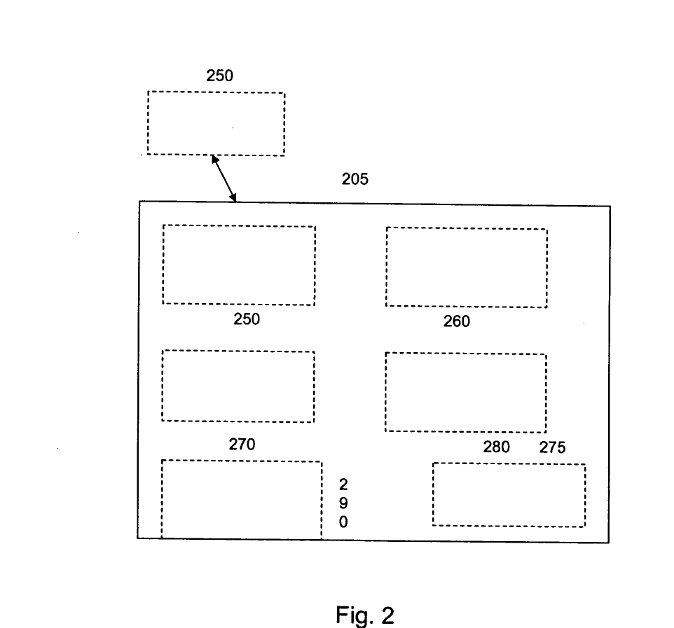

The Lifestyle Coach device 205 may include a device for user input 250, a screen 260 to display information for the user, interface buttons 270, an alert system 280, a user action measurement module or mechanism 275, and communication connection interface 290. The user action measurement module may be a pedometer or an accelerometer. FIG. 2 illustrates a block diagram of a Lifestyle Coach device according to an embodiment of the present invention. The screen may be a LCD screen or any portable device screen. The device for user input 250 may be, for example, a keyboard, a mouse, a voice recognition software. As illustrated in FIG. 2, the device for user input may be internal to the Lifestyle Coach device (keypad or voice recognition software) or external (attached keyboard or mouse). The interface buttons 270 may include scroll up/down, input buttons, or a stylus. The alert system 280 may be a vibration subsystem or a beeping subsystem that alerts a user of the Lifestyle Coach device 205 that an action has occurred. The measurement mechanism may be a pedometer or accelerometer. The communication connection interface 290 may utilize Blue Tooth, USB, infrared, parallel or serial communication protocols.

In an embodiment of the invention, the user may interact with the Lifestyle Coach device 205 via the user input 260. The user may also interact with the user computer 210 via the Lifestyle Coach device 205. In an embodiment of the invention, the user may interact with the Lifestyle Coach device 205 and may connect to the user computer 210 utilizing wireless or wired communication protocols. After the Lifestyle Coach device 205 has connected with the user computer 210, the Lifestyle Coach device 205 may be coupled with the Lifestyle Coach servers 220 via a communication network, such as the Internet, a Local Area Network (LAN) or a Wide Area Network. Once the Lifestyle Coach device 205 is connected to the Lifestyle Coach server(s) 220, the Lifestyle Coach device 205 may automate the transferring of tracking information to a Lifestyle Coach Online Automated Lifestyle Coaching Application (which may be referred to as the Lifestyle Coach application software), which has been installed on the Lifestyle Coach servers 220.

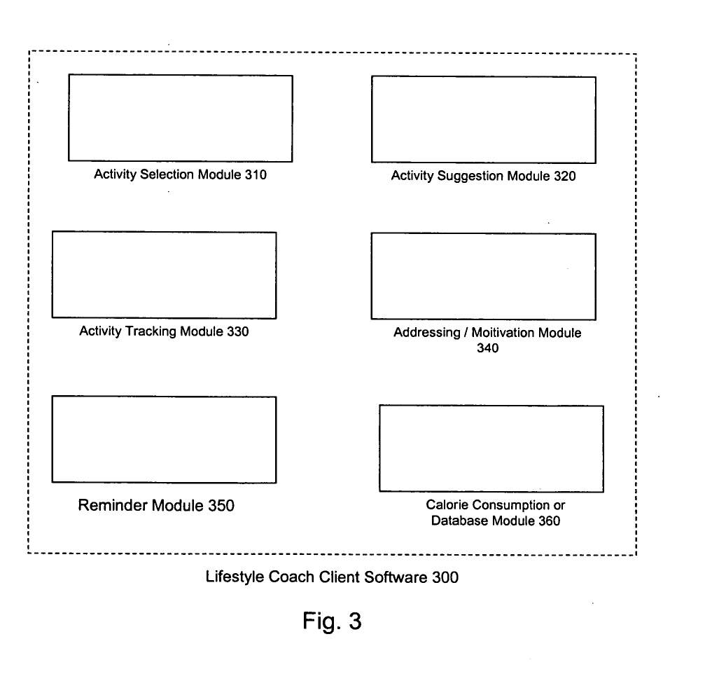

Lifestyle Coach application software may be installed on the Lifestyle Coach device. This may be referred to as client Lifestyle Coach software or client-side Lifestyle Coach software. FIG. 3 illustrates the Lifestyle Coach application client-side software according to an embodiment of the present invention. The Lifestyle Coach application software 300 may include an activity selection client module 310, an activity suggestion client module 320, an activity tracking client module 330, an addressing and motivation client module 340, a reminder client module 350, and a caloric consumption tracking client module 360. These modules may have similar modules on the server side of the Lifestyle Coach application software system.

The activity selection module 310 may allow a user to select new activities (exercise, physical activity, etc.) and add the new activities to an existing activity plan. The activity selection module 310 may include records of potential new activities and may present these new activities to the user. Under certain operating conditions, the activity plan may have pre-selected activities. In other words, the users may not have to select new activities. In an embodiment of the invention, the Lifestyle coach device 205, after the activity has been selected, may automatically record the duration, intensity, and/or type of activity. In an embodiment of the invention, a user of the Lifestyle coach device may input and the Lifestyle coach device 205 may record the duration, intensity, and type of activity selected by the user. The activity selection module 310 may also allow a user to schedule the selected new activity.

Illustratively, the user may utilize buttons on the Lifestyle Coach device 205 to select an activity. After the activity is selected, the Lifestyle Coach client software 300 may request information from the user such as activity duration, activity intensity, and an activity method specific questions. The Lifestyle Coach client software on the Lifestyle Coach device may utilize the current time period as the default time period for the activity. However, the Lifestyle Coach client software may also allow the user to select a different time period for the selected activity. The activity selection module 310 may also allow the user to select another day and to view/edit the programmed activity methods for that day.

The activity suggestion module 320 may receive a user's completed activities at a given time of day and analyze the user's completed activities. After the user's activities have been completed, the activity suggestion module 320 may suggest additional activities for the user. Under certain operating conditions, the activity suggestion module 320 may utilize the user's history and personal characteristics in order to determined which additional activities to suggest. Illustratively, if a user's activity for a day or other timeframe is low, the activity suggestion module 320 may suggest an appropriate activity to help the user meet the user's goals.

In an embodiment of the invention, the Lifestyle Coach device 205 may include an accelerometer for tracking the user's movement. In an embodiment of the invention, the Lifestyle coach device 205 may include a pedometer for tracking the user's movement. The activity tracking module 330 may receive the accelerometer or pedometer input and the activity tracking module 330 may award the user with a number of points corresponding to the amount of exercise or movement that the user has completed. The activity tracking module 330 may store the awarded number of awarded points into a memory (or record) in the Lifestyle Coach device that is keeping a running tally of the user's total points. The memory (or record) may also keep a tally of the completed activities.

Illustratively, the activity suggestion module 320 on the Lifestyle Coach device may allow the user to enter an option where the Lifestyle Coach device 205 selects an activity for the moment. Upon receipt of the entry by the user, the activity suggestion module 320 checks the user's current activity plan, the actual point total, and the user's personal characteristics and based on this information, suggests an activity that the user can commit to or complete at that moment.

In addition, the activity suggestion module 320 may monitor a user's real time activity level. If the activity suggestion module 320 of the Lifestyle Coach device determines that the user's activity level is low, the Lifestyle Coach device may prompt the user to execute a particular activity. The activity suggestion module may take into consideration the defined database and/or personalized standards or thresholds for the user. For example, if the user has accumulated no activity points for a given time period threshold, i.e., ½ a day or six hours, then the activity suggestion module 320 of the Lifestyle Coach device 205 may request that the device prompts the user to get up from the seat and take a five minute walk.

In an embodiment of the invention, the activity tracking client module 330 of the Lifestyle Coach device 205 may receive data automatically from the pedometer or accelerometer. Illustratively, for non-walking activities, the user may enter points manually to the Lifestyle Coach device 205. Under other operating conditions, the user can connect or couple exercise equipment to the Lifestyle Coach device 205 in order to download the user's activity. The Lifestyle Coach device 205 may communicate with the exercise equipment via a USB connection, infrared communications protocol, Blue Tooth communications protocol, any wireless communication protocol, or wired communication protocol. Illustratively, the exercise equipment may send information to the Lifestyle Coach device 205 regarding how long the user conducted the activity and at what intensity the activity was conducted. Under certain operating conditions, the activity tracking client module 330 may include software that will translate information received from exercise equipment into activity data that can be utilized by the activity tracking client module 330.

The activity tracking client module 330 may accumulate the user's points. After accumulating the user's points, the activity tracking client module 330 may determine how many more points are needed according to the daily activity plan. After the Lifestyle Coach device 205 connects with the user's computer 210, the user computer 210 may receive data from the Lifestyle Coach device 205 and may transfer some data or all of the data to the Lifestyle Coach servers 220 via a global communication network (e.g., the Internet). Under certain operating conditions, the user of the Lifestyle Coach device 205 may view the device, via the activity tracking client module 330, to view or see the current daily activity points. The activity tracking client module 330 may also provide the user with the number of points the user must get in order to complete the daily activity plan. Illustratively, the Lifestyle Coach device 205 may include input mechanisms (e.g., buttons, touchpad, etc.) that allow a user to select that an activity has been completed. For example, the activity tracking client module 330 may present a list of planned daily activities to the user. The user may utilize the input mechanism to scroll and select the appropriate activity and then to select the activity as completed.

Under certain operating conditions, the Lifestyle Coach device 205 may upload information for daily activities from the Lifestyle Coach device 205 to a local computing device 210, e.g., a desktop, a laptop, a PDA, etc. The local computing device 210 may connect to the Lifestyle Coach online servers 220 through, for example, an Internet connection. The local computing device 210 may transfer the daily activity information to the Lifestyle Coach online servers 220. In an embodiment of the invention, the user can then log onto the local computing device (without using the Lifestyle Coach device, which can connect to the Lifestyle Coach online servers 220 in order to view detailed tracking data. Additionally, the user may be able to view information from the device directly on other local computing devices without having to connect to the Lifestyle Coach servers. In this embodiment of the invention, some data may be downloaded from the Lifestyle Coach servers to the local computing devices in order for the user to vie the data on the local computing device.

In an embodiment of the invention, an addressing and motivation client module 340 may record past and current barriers established by the user in the user's activity plan. Under certain operating conditions, the past and current barriers may have been pre-selected and not be unique to the user. Under certain operating conditions, the addressing and motivation module 340 may address a user's barrier or motivational issues, by providing a motivational tip or suggestion on how to reach the user's selected barrier. Under certain operating conditions, the addressing and motivation client module 340 may address a user's barrier or motivational issues by providing a list of motivational tips or suggestions. Illustratively, a table or storage location in the Lifestyle Coach device 205 may store a list of all barriers that the user has addressed in working with the Lifestyle Coach application software 300. The Lifestyle Coach device 205 may present a list of barrier topics and the user may select a barrier topic. After the user has selected a barrier topic, the Lifestyle Coach device 205 may present or show the user a first motivator tip. The addressing and motivation module 340 may also present other motivational tips for the barrier. The user may have the option of reviewing or not reviewing all of the motivational tips for the selected barrier.

In an embodiment of the invention, a reminder client module 350 causes a Lifestyle Coach Device 205 to provide the user with a reminder or identification of an event. Illustratively, the reminder module 350 may vibrate or beep in order to remind a user of a scheduled activity. Illustratively, a default setting may be established by the Lifestyle Coach device 205 to alert the user at a specific time before a scheduled activity. This may be any time established by the manufacturer of the Lifestyle Coach device 205. Under certain operating conditions, the reminder module 350 may allow a user to edit a reminder time. The reminder time may be 0 minutes before activity, or 5, 15, or 30 minutes before the activity. The user may allow the reminder to be a beep or a vibrate reminder.

In an embodiment of the invention, a caloric consumption client module 360 on the Lifestyle Coach device may store, retrieve, or generate nutritional information (e.g., caloric information) about various food and drinks. The caloric consumption module 360 may utilize a database stored on the Lifestyle Coach device 205. In an embodiment of the invention, a user can select from a list in a database in the Lifestyle Coach device 205 to register from what he or she has consumed. When the user selects a food or drink, the current time and current date may be utilized as the time and date of consumption. If the user edits the time and date, then the edited time and date may be utilized as the time and date of consumption. The Lifestyle Coach device 205 (and specifically the caloric consumption client module 360) may save this information and assess the user's caloric consumption. The user may also be able to mark specific food and drink as consumed. When the user marks the food or drink as consumed, the caloric consumption module 360 may update the user's caloric consumption. Under certain operating conditions, the caloric consumption module 360 may utilized the food/beverage database to allow a user to determine what food or beverage to consume. Illustratively, the user may utilize input buttons on the Lifestyle Coach device 205 to search the food/drink database for specific food or drink names and the caloric consumption module 360 searches the database for this information. For example, the user may input certain characteristics for a desired food. The Lifestyle Coach device 205 may search the food/drink database and provide a list of food/drink that matches the user's desired food or drink type. The user may select a food/drink from the list. The caloric consumption client module 360 in Lifestyle Coach device 205 may display key nutritional information for the selected food/drink. The caloric consumption client module 360 of the Lifestyle Coach device 205 may also provide a user to view a consumption of calories during a time period, such as a day or a week. Illustratively, the user may select a view consumption option in the caloric consumption client module 360. In response to the user inputting the view consumption option of the caloric consumption client module 460, the caloric consumption client module 460 may cause the Lifestyle Coach device 205 to display a number of calories consumed during the time period.

The Lifestyle Coach server may include an Lifestyle Coach software application installed thereon. The Lifestyle Coach software application interacts with data from the Lifestyle coach device through the user's computer via the global communication network (e.g., the Internet). The Lifestyle Coach server software application is an online behavior modification, lifestyle change support application that complements the Lifestyle Coach device. The Lifestyle Coach online software application is an interactive application that assists the user in order to decrease the user's developing Type II diabetes or curtailing the user's progression of the illness. The Lifestyle Coach online software application tracks the user's activity points and progress, both in the past and current, while attempting to motivate the user to reach his or her established goals. The Lifestyle Coach Online (or server) software interacts with the Lifestyle Coach client software modules. Although certain functions may be described as occurring in the client software or the server (online software), the software modules may be located on the Lifestyle Coach device 205, the user's computer 210, and the Lifestyle server(s) 220.

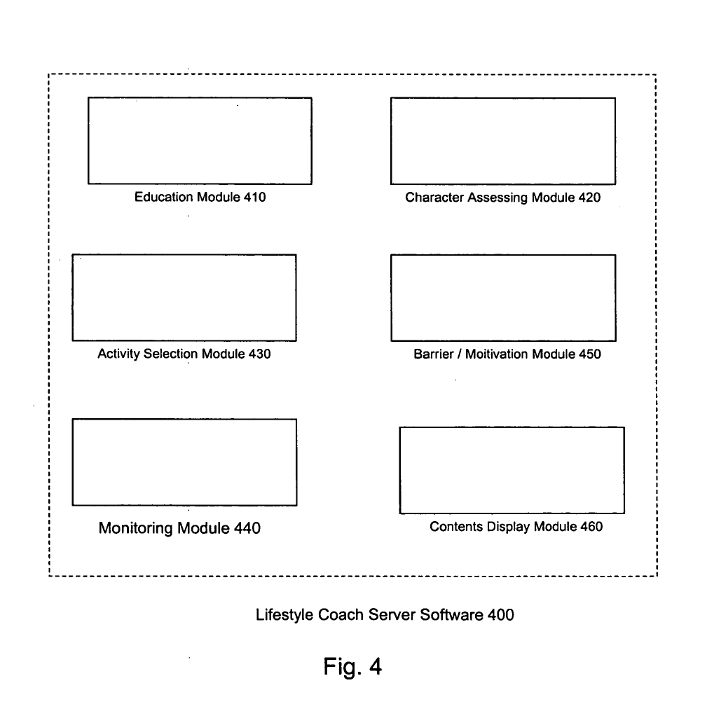

FIG. 4 illustrates Lifestyle Coach online software according to an embodiment of the present invention. In an embodiment of the invention, the Lifestyle coach online software application may include an educational module 410, a characteristics assessing module 420, an activity selection module 430, a monitoring module 440, a barrier/motivational module 450, a contents display module 460, and additional modules, which are described below. A number of these software modules are described in detail later in this patent application.

The educational module 410 of the Lifestyle coach online software application may provide a user with information about healthy living. Under other operating conditions, the education module 410 also educates the user about type II diabetes. The information presented by the education module 410 may be presented in any internet-ready format, e.g., text and video.

In an embodiment of the invention, a user may bulk load user information into the Lifestyle Coach servers 220. For example, the user may create an excel file or a comma delimited text file that includes new user information or updated user information. Under certain operating conditions, the user may create a user data file and the Lifestyle Coach application software on the Lifestyle Coach server 220 may automatically create or generate a user account. An administrator may also update certain sections of the Lifestyle Coach application software on the Lifestyle Coach server 220. Illustratively, the administrator may create a content file in either Excel (or a comma delimited text file) and may upload this to the Lifestyle Coach server. The administrator may also create a replacement content file which replaces an existing file. Similarly, the administrator may create a survey question file (either in Excel or a comma delimited text file) and upload this to the Lifestyle Coach server 220. The administrator may also create a replacement survey question file. The administrator may also create a bulk user characteristic file (in either Excel or a comma delimited text file) and may upload this user characteristic file to the Lifestyle Coach server. The administrator may also create a replacement user characteristic file. The administrator may also load organization information into the Lifestyle Coach server. This information may relate to an organizational structure, particular policies of the organization and/or particular rules governing the contents to display to particular users. The administrator may also update calendar date and/or calendar periods in the Lifestyle Coach server 220.

The Lifestyle Coach application software may include a special contents display module 460. The Lifestyle Coach application software may show particular contents, either lectures or surveys, to a user based on certain rules. Illustratively, the contents may be shown in the normal weekly flow of the user. The contents may be shown after the user has reviewed his or her weekly results, but before he or she sees the barrier or motivator comments. The special contents display module 460 of the Lifestyle Coach application software may check to see if any of the rules defined for specific content have been matched. Rules governing the display of contents may relate to particular characteristics of the user, particular application usage of particular users, and/or particular history of user actions. If the user matches more than one content rule, then the content rule with the higher priority may determine what is shown. Additionally, the administrator may load a list of the names of users and/or identify users directly who should receive the contents.

Illustratively, the special contents display module 460 may display contents based on rules such as the following. Illustratively, one of the content display rules may be the number of weeks that the user has been working in the particular phase. This may not include the weeks that have been paused or not counted. Another content rule may be the number of weeks the user has been below the activity point goal in the last number of weeks. Another content rule may be the number of weeks that the user has met the activity point goal in the last number of weeks. Another content rule may be the number of weeks that the user has been above the goal (in term of activity points) in the last number of weeks. An additional content rule may also be determined based on the number of weeks that the user has the application paused in the last number of calendar weeks. Content may be also be prioritized by the administrator. The content may also be prioritized according to specific user characteristics. The special contents display module may allow an organization to load rules in the Lifestyle Coach application software. The Lifestyle Coach application software can change the display of the content for each of a plurality of organizations. Illustratively, the contents display module of the Lifestyle Coach application software may alter appearance of user interface screens and the function of the Lifestyle Coach application to match an organization's approach to adopt the healthy behaviors and habits.

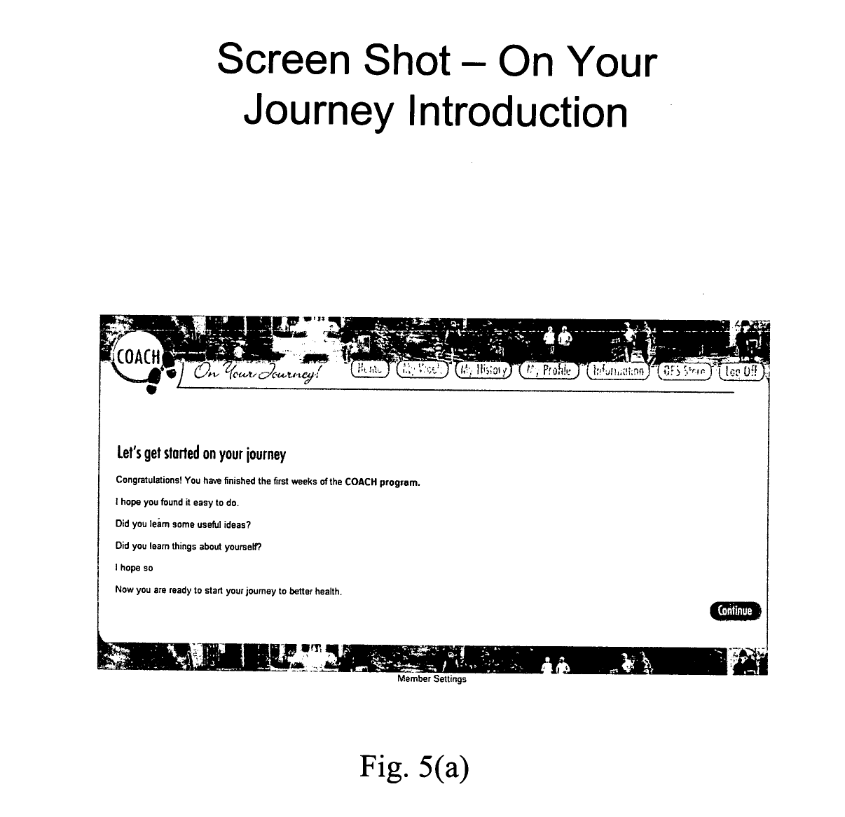

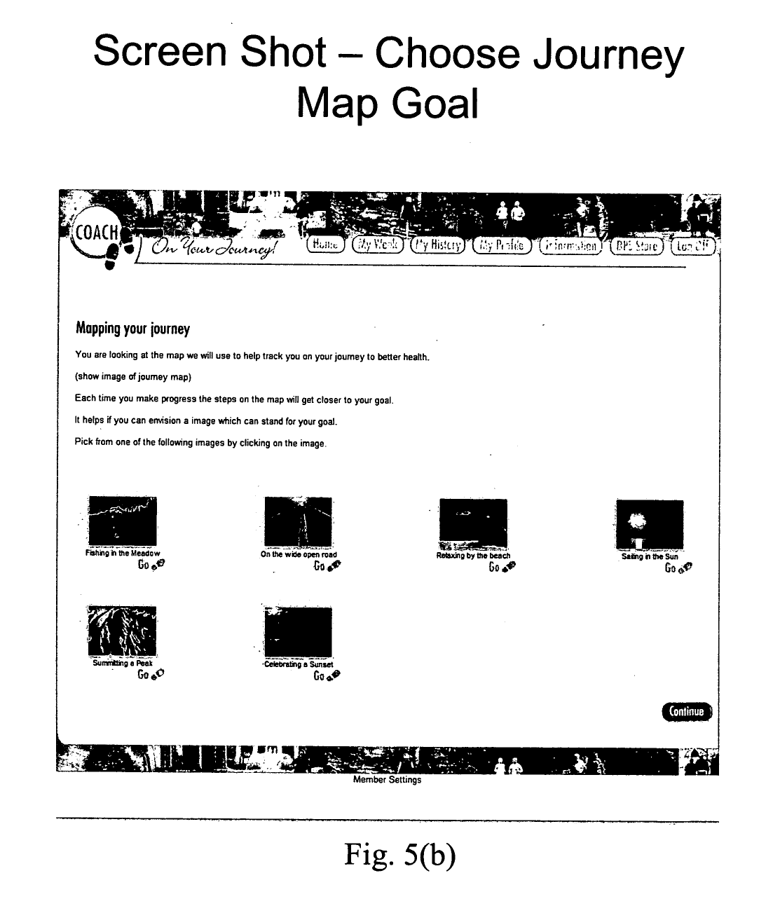

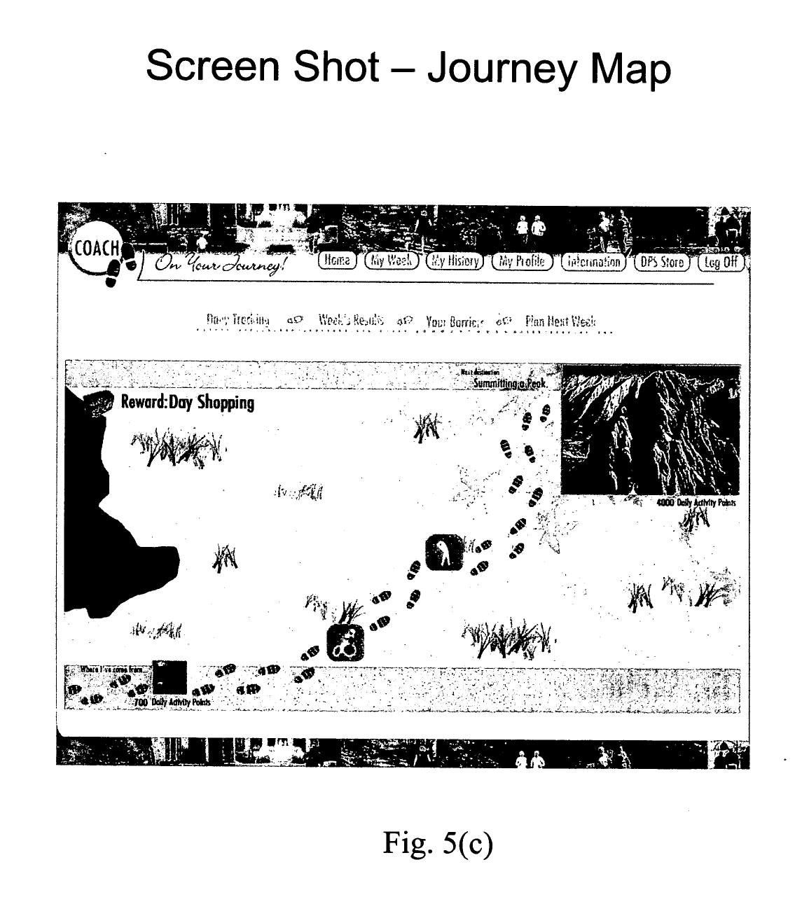

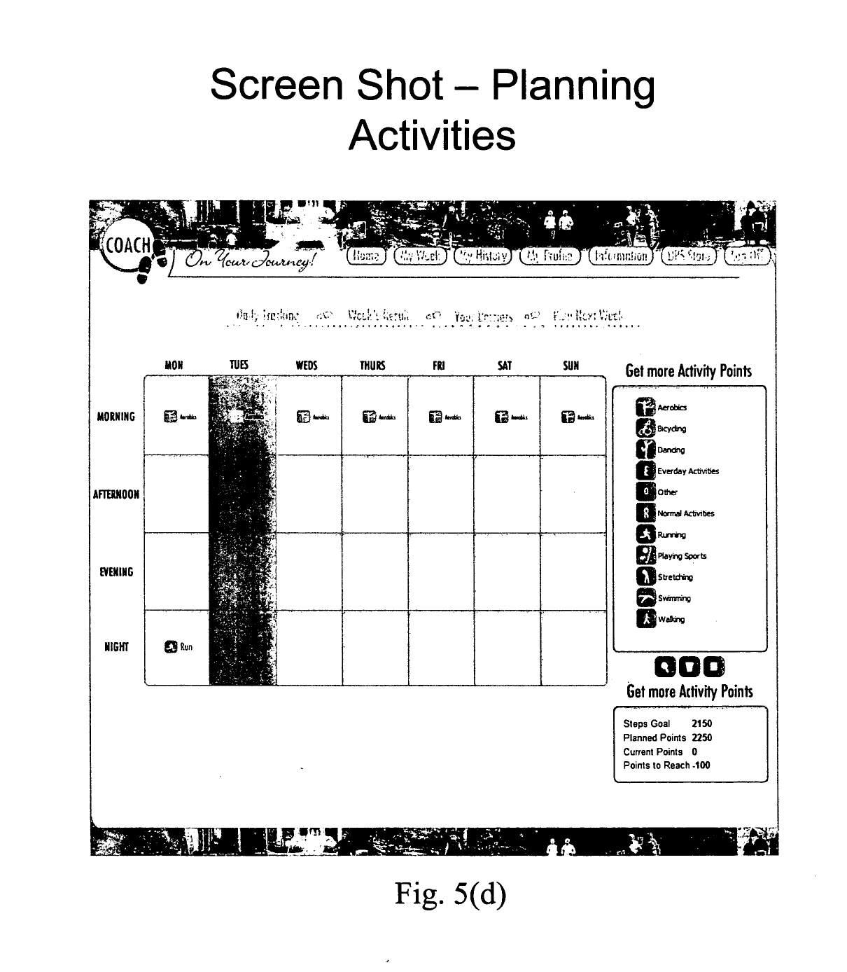

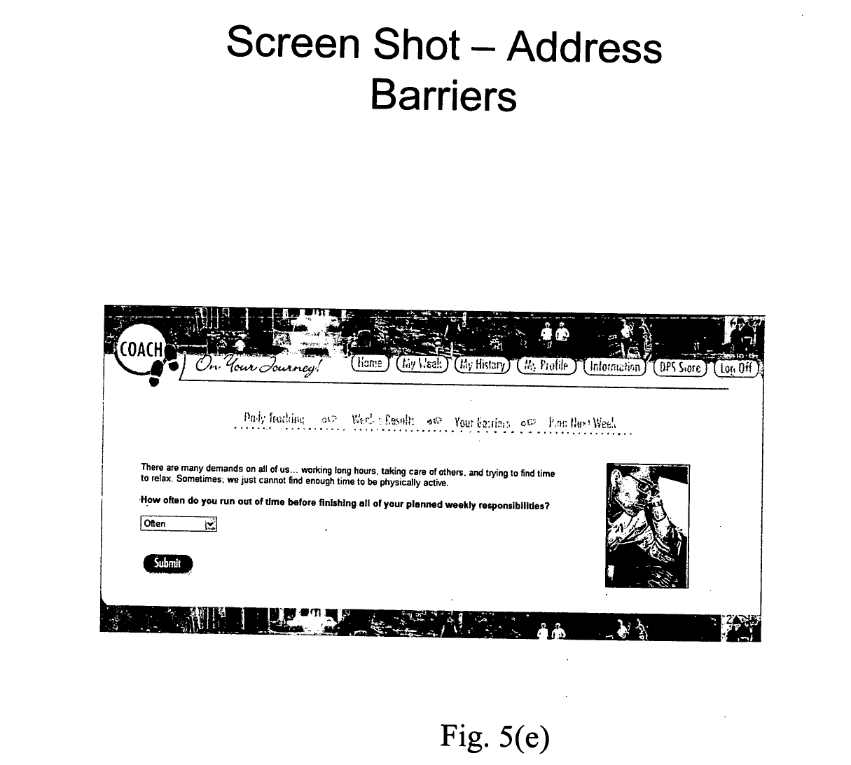

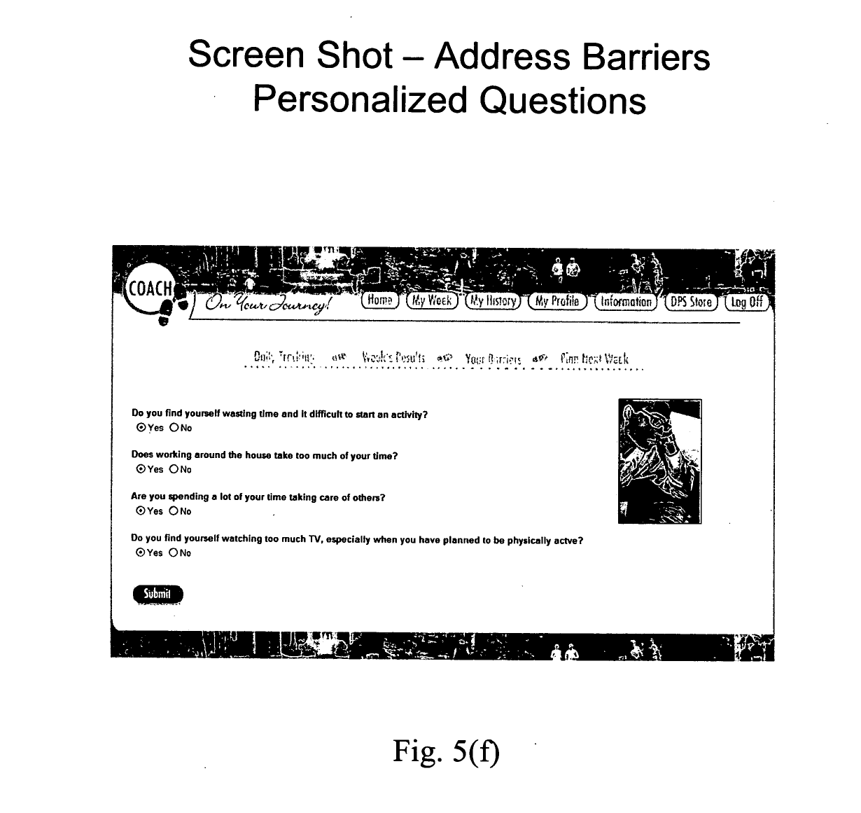

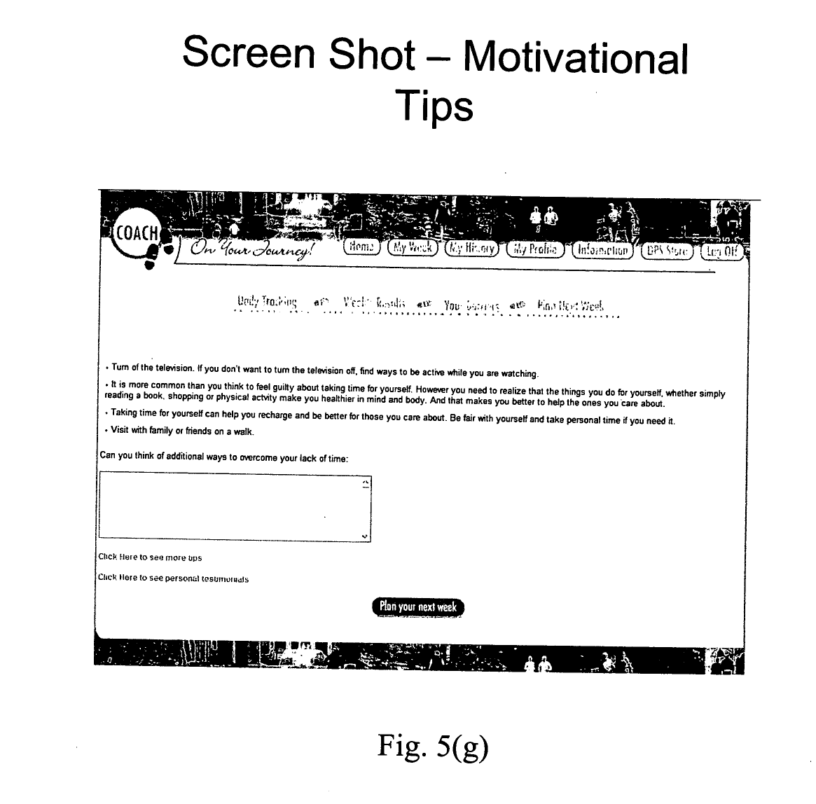

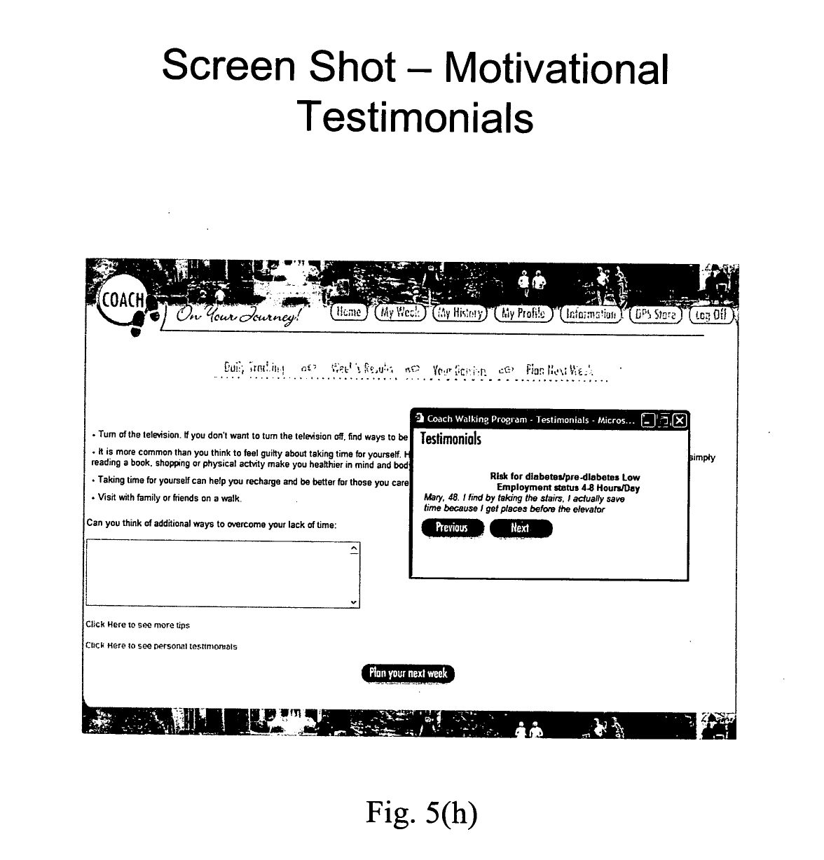

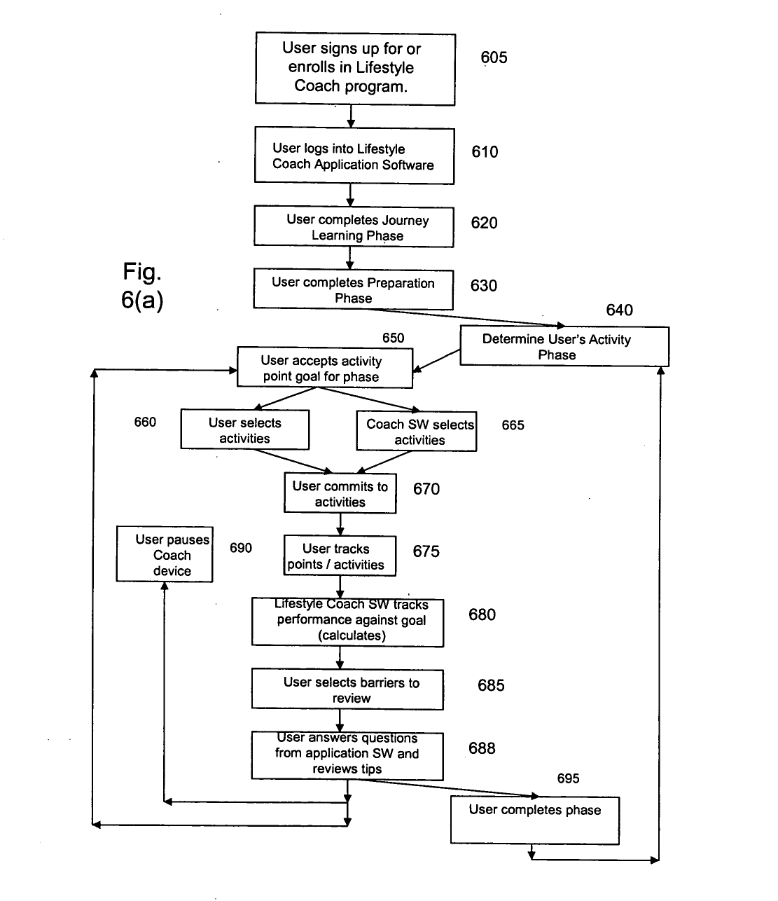

FIG. 5(a) illustrates a screen shot of the journey introduction home page according to an embodiment of the invention. FIG. 5(b) illustrates a screen shot of the choose journey map goal page according to an embodiment of the invention. FIG. 5(c) illustrates a screen shot of a journey map according to an embodiment of the invention. FIG. 5(d) illustrates a screen shot of an activity planning grid for planning activities according to an embodiment of the invention. FIG. 5(e) illustrates a screen shot of an address barrier page according to an embodiment of the present invention. FIG. 5(f) illustrates a screen shot of an address barriers personalized questions screen according to an embodiment of the present invention. FIG. 5(g) illustrates a screen shot of a motivation tip page according to an embodiment of the present invention. FIG. 5(h) illustrates a screen shot of a motivational testimonial page according to an embodiment of the present invention.

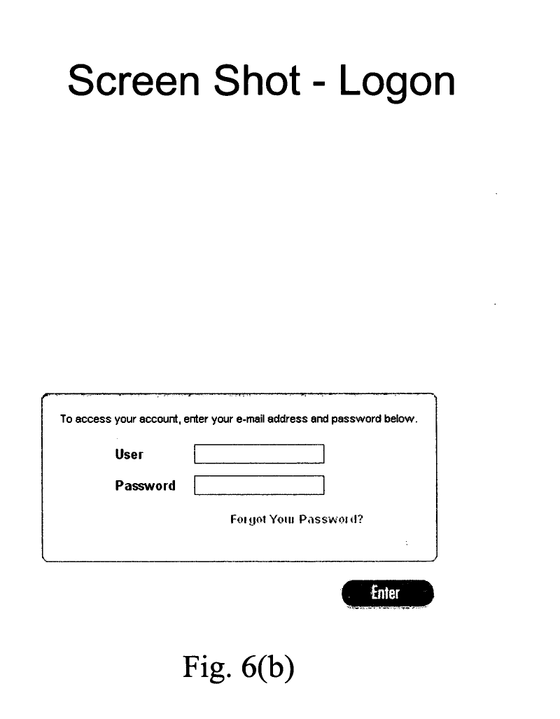

FIG. 6(a) illustrates an application process for a user of the Lifestyle Coach application software according to an embodiment of the invention. In an embodiment of the invention, the user signs up 605 for the Lifestyle Coach application software. Under certain operating conditions, the user may access the Lifestyle Coach application software through the Internet utilizing the user's computer. Under other operating conditions, the Lifestyle Coach application software may be accessed by utilizing the Lifestyle Coach device. In embodiments of the invention, the user may login 610 on the Lifestyle Coach application with a username and password. FIG. 6(b) illustrates a sample logon screen.

Under other operating conditions, the user may complete 620 the Journey Learning stage of the Lifestyle Coach application software. Illustratively, the user may review a presentation about the Lifestyle Coach device and learn how the Lifestyle Coach device works. The user may also review a lecture about diabetes. The lecture may include information about the risks, symptoms, and effects of diabetes. The user may also review a lecture about healthy living and learn about the benefits of healthy living and the ease of living healthier. The Lifestyle coach application software may then present the user with a series of questions regarding the user and the user may fill out the survey. After the user inputs answers to the series of questions, the Lifestyle Coach application software may create a user's unique profile. In the profile, the Lifestyle Coach application software may include a readiness-to-change index.

Under other operating conditions, the user may complete 630 the Journey Preparation stage of the Lifestyle Coach application software. Illustratively, the user may learn about tracking the user's activities. The user may also learn about wearing a pedometer. In an embodiment of the invention, the Lifestyle Coach application software may request that the user answer questions about his personal barrier and motivators to becoming healthy. After receiving the answers regarding personal barriers and motivators, the Lifestyle Coach application software may update the user's unique profile. In the Journey Preparation stage, the Lifestyle Coach application software may request information about a user's living and work environment. After receiving this information as input, the Lifestyle Coach application software may update the user's unique profile.

After the user has completed the Journey Learning stage and the Journey Preparation stage, the Lifestyle Coach application software may determine 640 a user's initial activity level. Under certain operating conditions, the Lifestyle Coach application software may also determine a user's baseline activity progression plan. Under certain operating conditions, the Lifestyle Coach application software may suggest an activity points goal for the next week. The user may accept 650 the activity points for the next week. Additionally, the Lifestyle Coach application software may determine a user's initial diet and nutrition level. Under certain operating conditions, the Lifestyle Coach application software may also determine a user's baseline diet and nutrition progression plan. Under certain operating conditions, the Lifestyle Coach application software may suggest a diet and nutrition goal for the next week. The user may accept 650 the diet and nutrition goal for the next week.

Under certain operating conditions, if the user is classified as non-active (i.e., greater than 3,000 activity points), the Lifestyle Coach application software may suggest 665 certain physical activities. Under other operating conditions, if the user is classified in one of the active stages, the Lifestyle Coach application software may suggest other physical activities. Under other operating conditions, the user may also select 660 physical activities in order to meet the user's activity point goal.

After the activities have been selected in the Lifestyle Coach application software, the user may schedule or commit 670 to activities for the following week. Illustratively, the Lifestyle Coach application software may present the user with a calendar and the user may identify which activity is going to performed during which time period.

After the user's activities for the week (or selected time period) have been calendared or committed to, the user may log off. Later, the user may login to the Lifestyle Coach application software to report or track 675 daily activity information. Illustratively, this may include daily step information and/or may include any activities completed since the last time the user logged in.

After the selected time period, e.g., a week or a month, the Lifestyle Coach application software may calculate 680 the user's success against the user's activity plan.

In an embodiment of the invention, the Lifestyle Coach application software may allow the user to select a thematic barrier 685 to review. The Lifestyle Coach application software may then present 688 the user with a number of motivational interview style questions. In response to the questions, the Lifestyle Coach application software may provide personalized tips and testimonials for the user.

The Lifestyle Coach application software continues the process of setting a goal and/or suggesting the activity through calculating the user's success against the plan until the phase activity goal is reached. After this point, the user may pause 690 the Lifestyle Coach application software for a certain period. In an embodiment of the invention, the user may move to the next activity level phase 695 in the Lifestyle Coach application software.

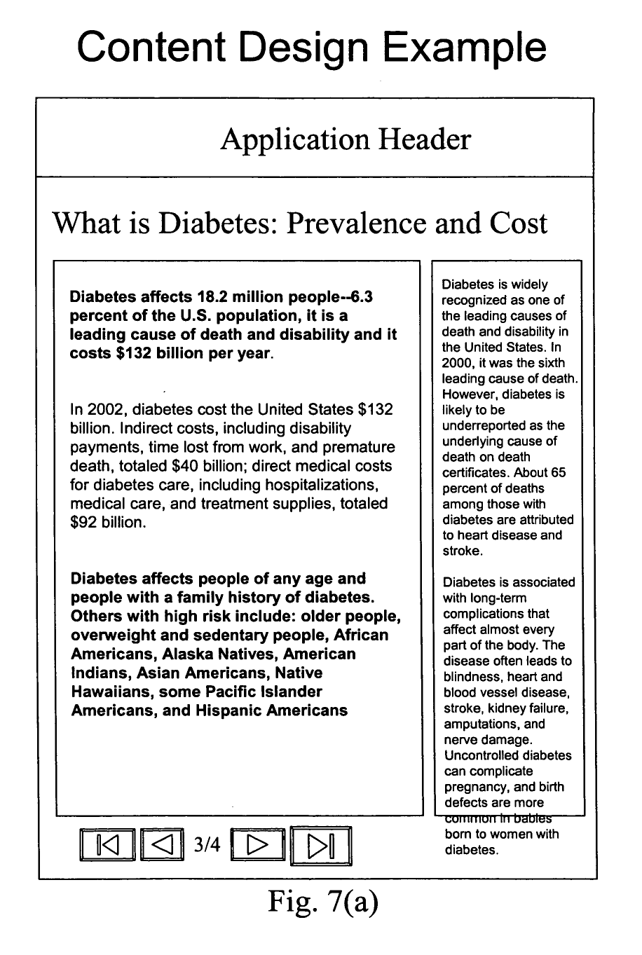

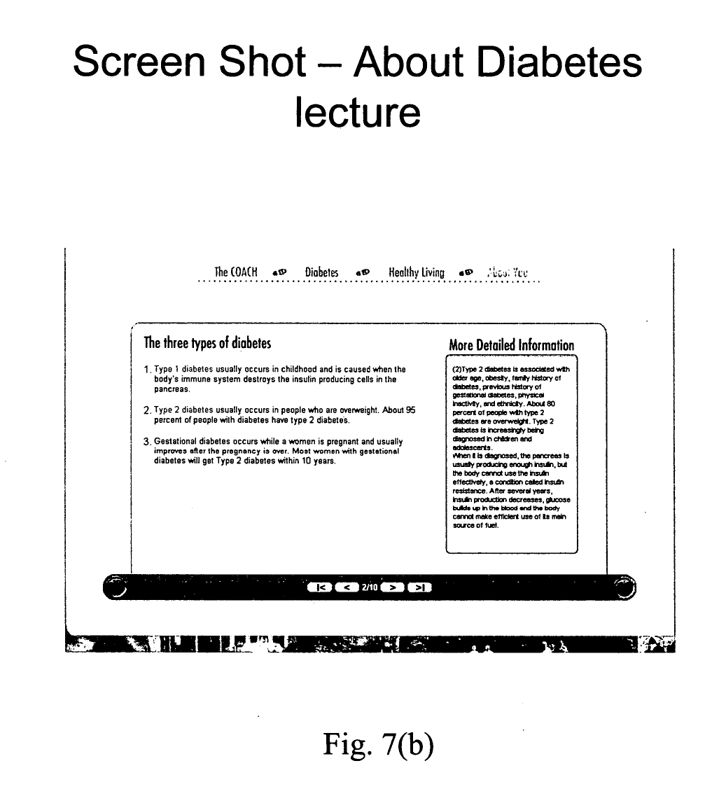

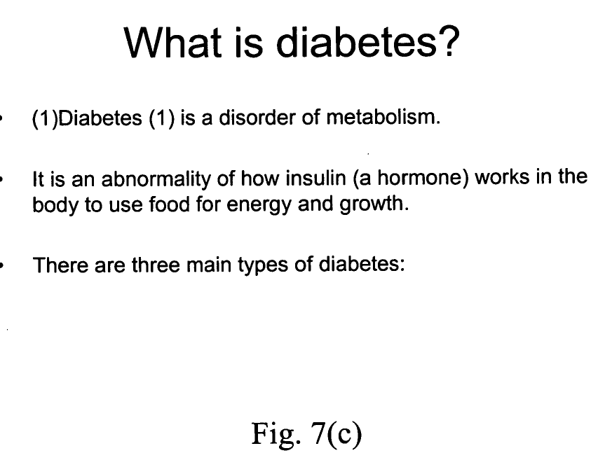

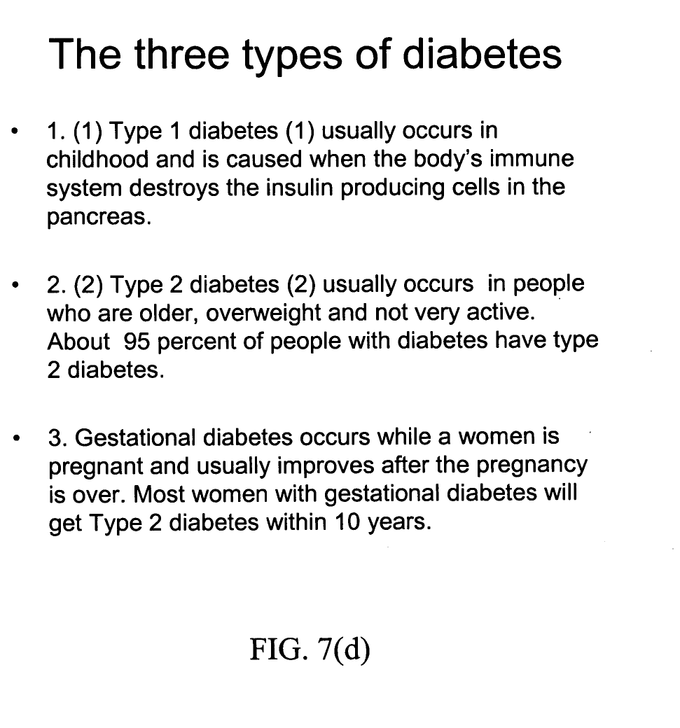

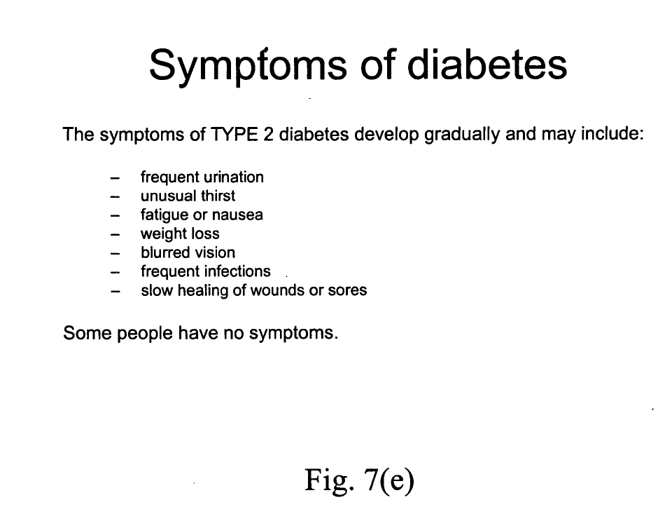

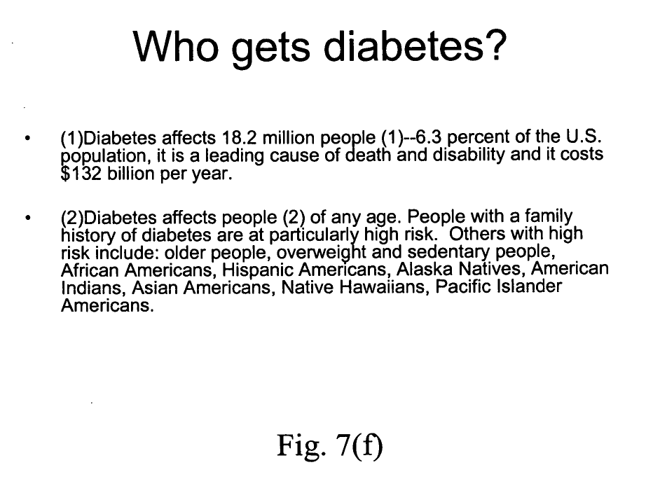

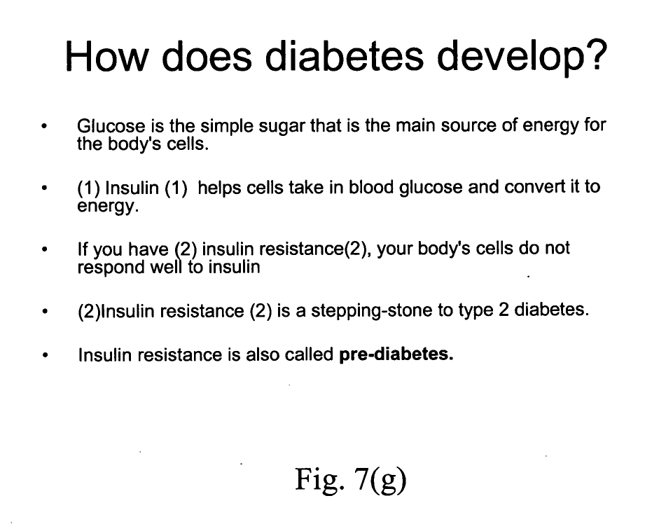

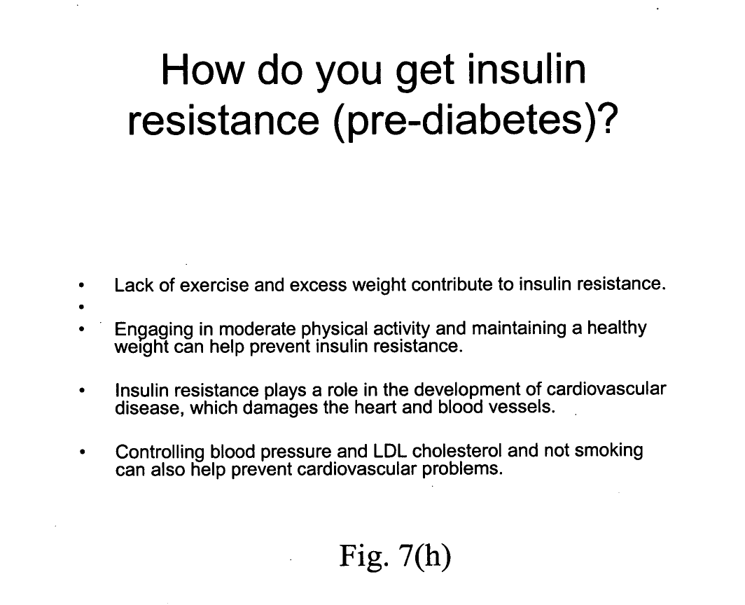

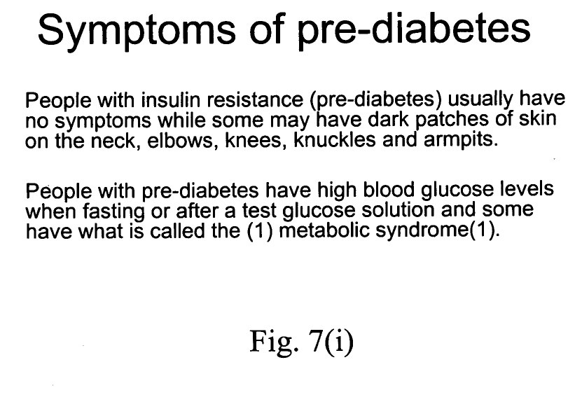

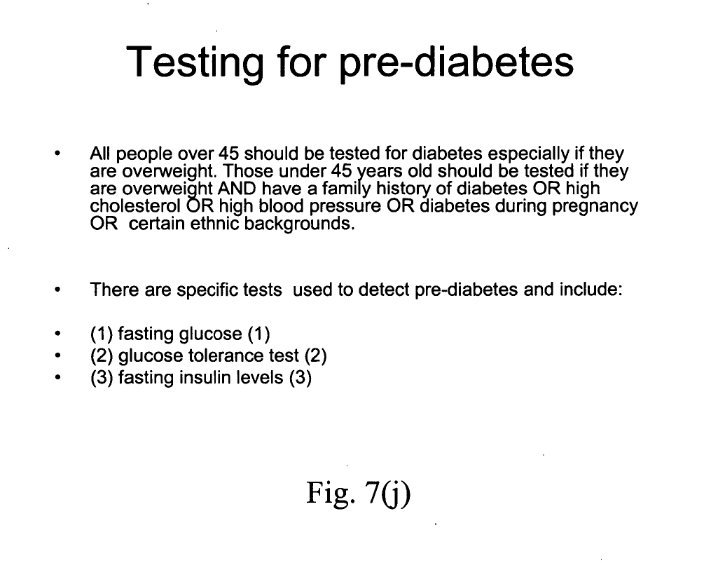

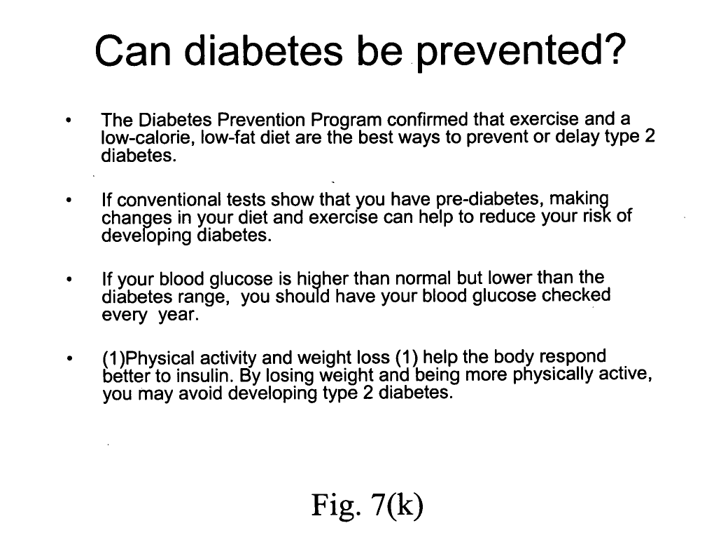

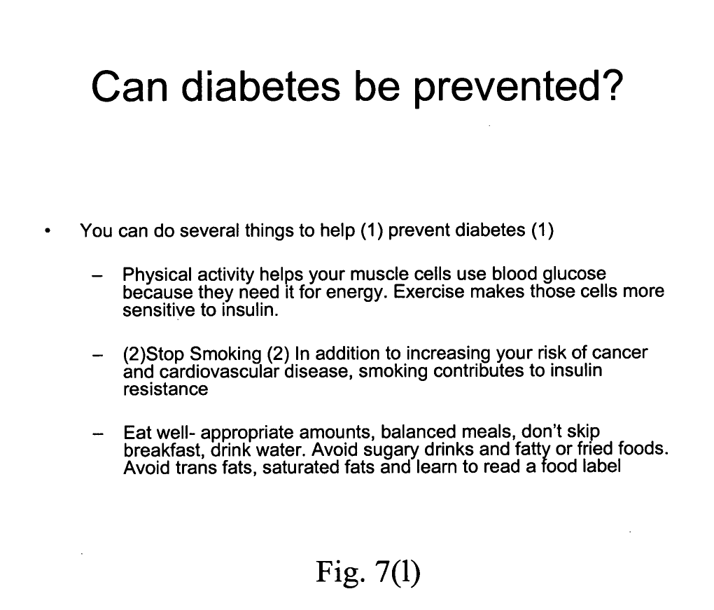

The Lifestyle Coach application software can use any internet ready educational approach (e.g., text video) with any specific content to provide relevant information to the user. An illustrative example of the Learning Phase and the Journey Phase education is presented below. FIG. 7(a) illustrates the lecture or presentation regarding diabetes according to an embodiment of the invention. FIG. 7(b) illustrates a sample screen shot presenting how the information may look on a computer screen. FIGS. 7(c)-7(l) illustrate content screens of the diabetes lecture or presentation according to an embodiment of the invention. The diabetes lecture or presentation may take any form with any content and FIGS. 7(c)-7(l) represent only one method of presenting information regarding diabetes which could. Illustratively, FIG. 7(c) defines diabetes and how diabetes impacts the body. FIG. 7(d) defines the three types of diabetes, Type 1 diabetes, Type 2 diabetes, and Gestational diabetes. FIG. 7(e) discloses the symptoms of Type-2 diabetes. Illustratively, FIG. 7(f) illustrates who gets diabetes and who is at risk of getting diabetes. FIG. 7(g) discloses how diabetes develops. FIG. 7(h) discloses how an individual develops insulin resistance and has a higher risk of developing diabetes. FIG. 7(i) discloses physical symptoms of pre-diabetes. FIG. 7(j) illustrates who should be tested for diabetes. FIG. 7(k) illustrates how diabetes can be prevented. FIG. 7(l) illustrates additional steps on how to prevent diabetes.

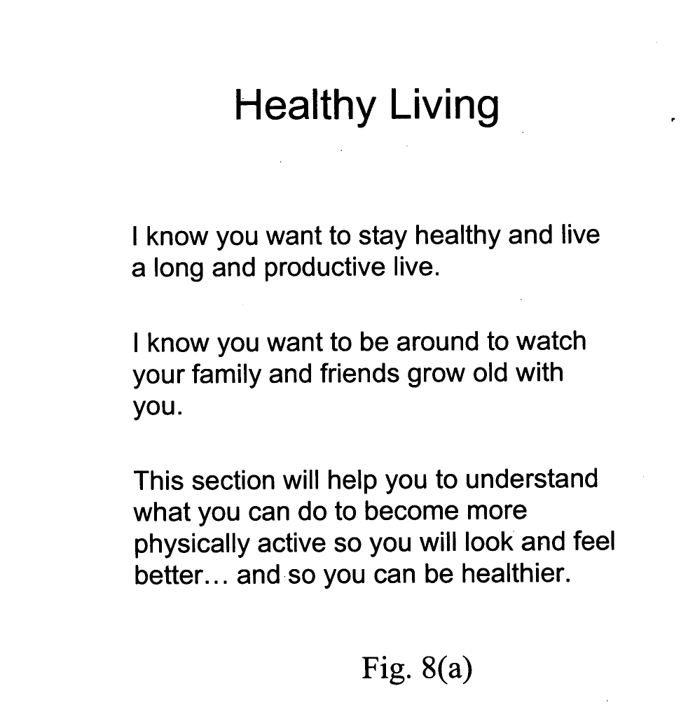

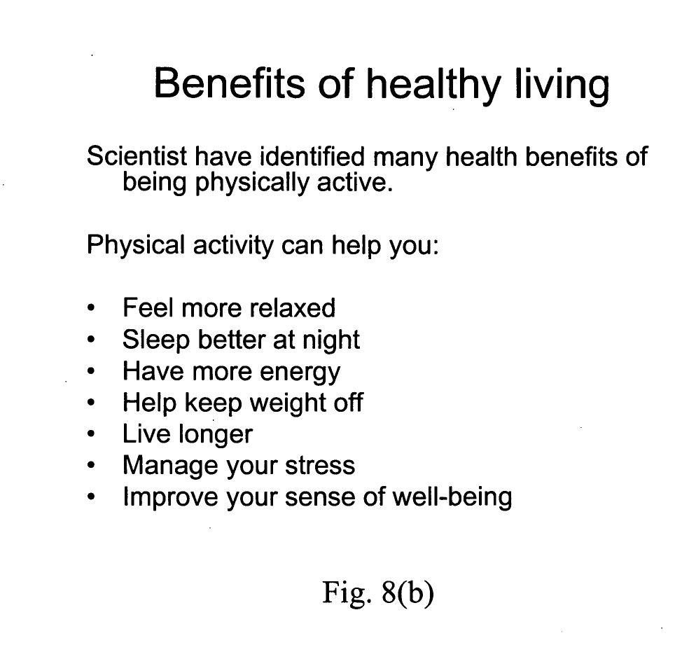

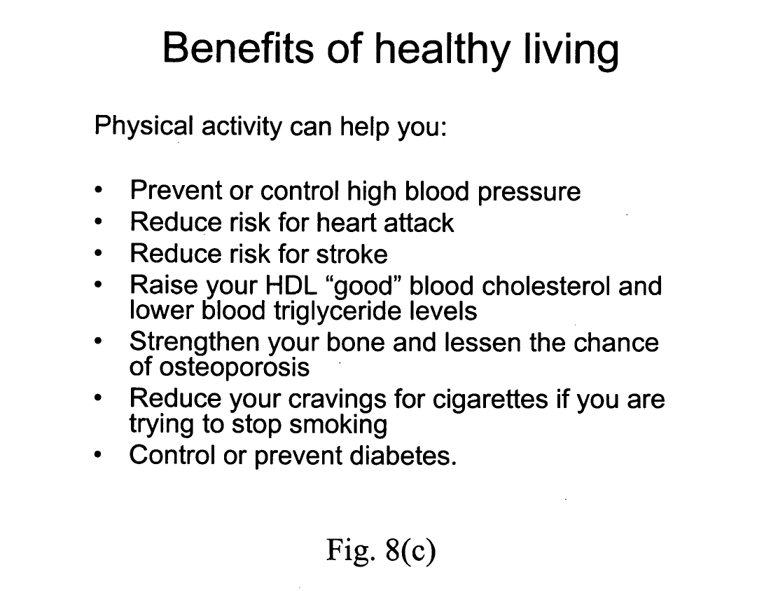

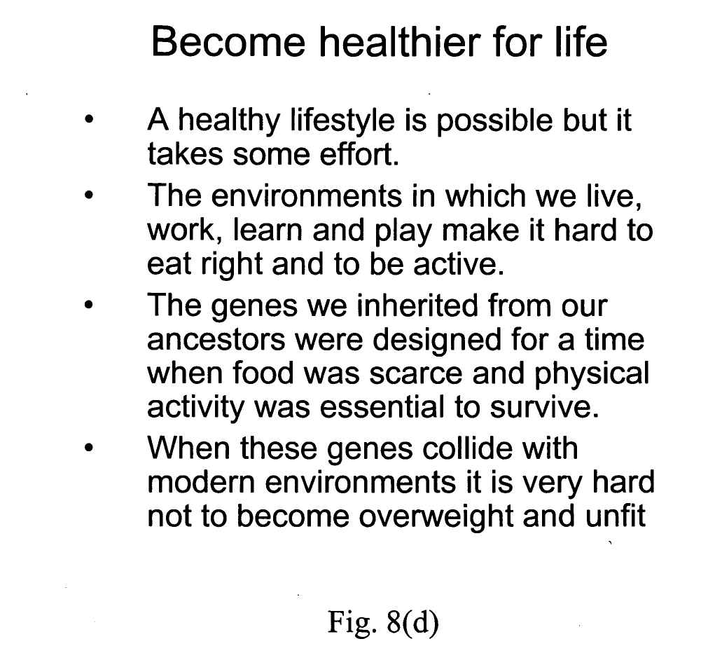

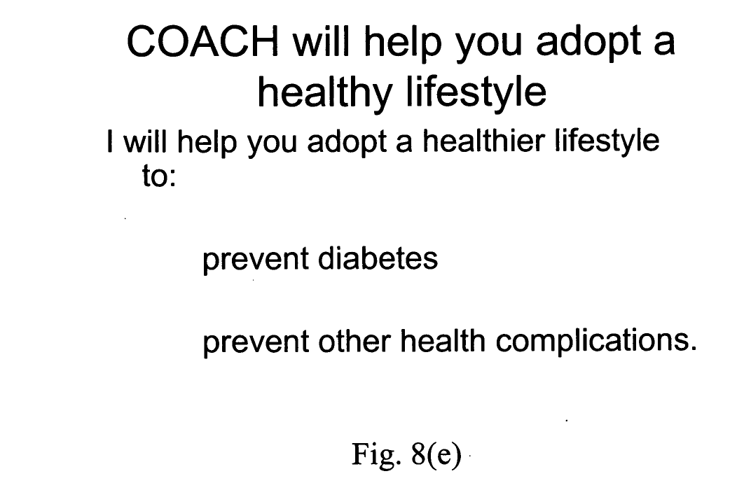

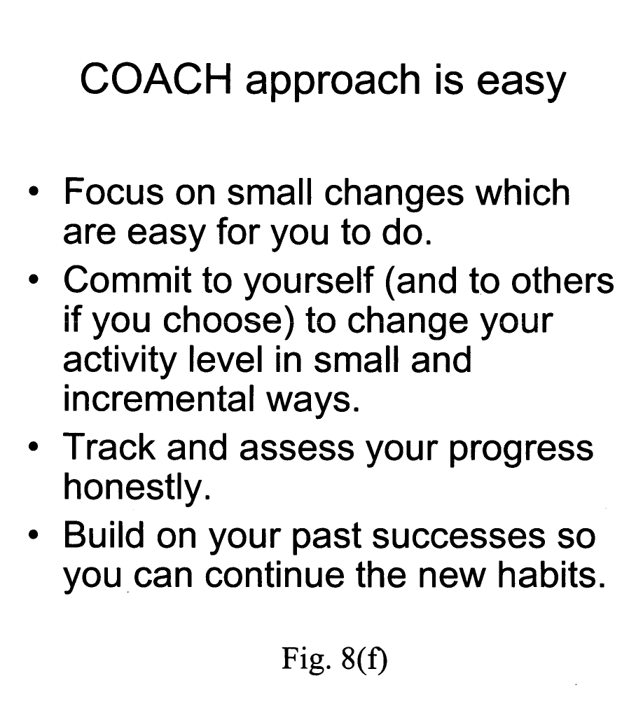

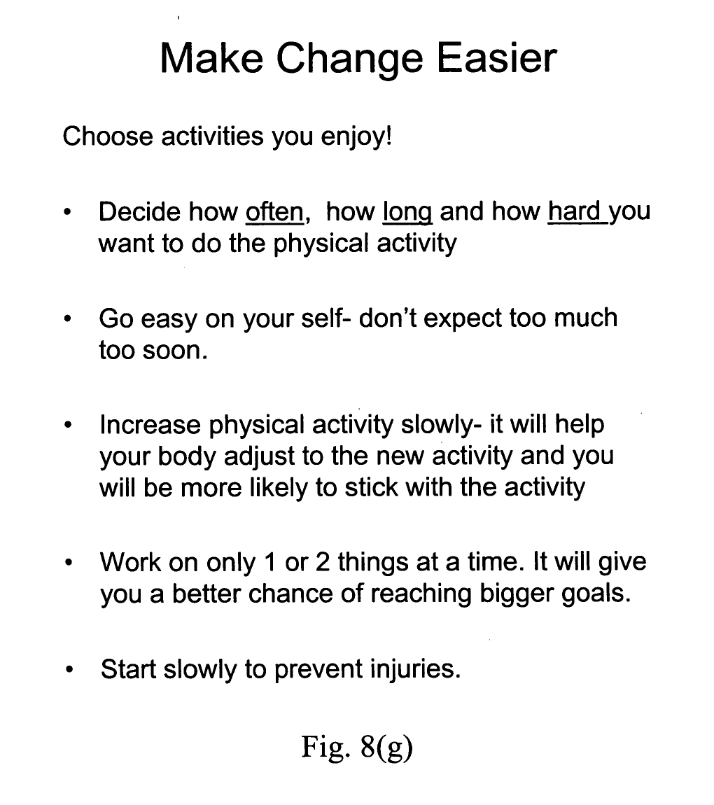

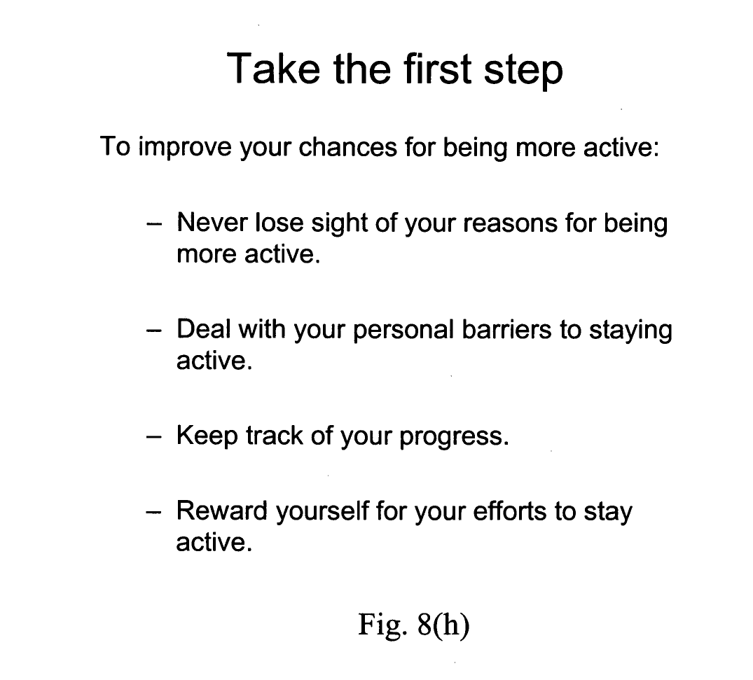

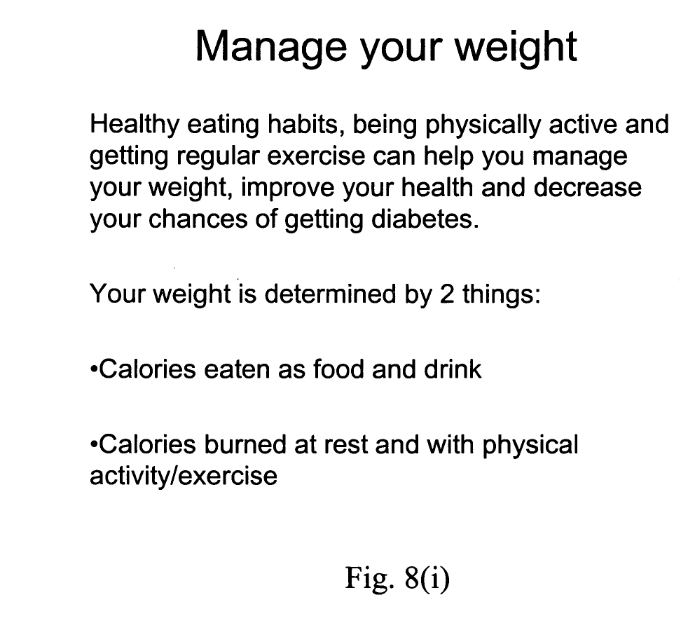

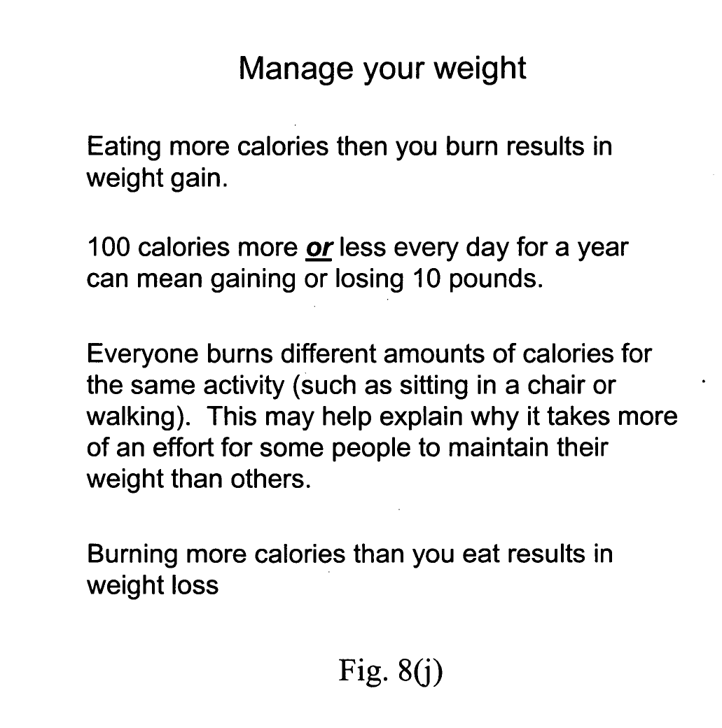

FIGS. 8(a)-8(g) illustrate sample content screens of the healthy living lecture or presentation each user views during the Learning phase of the Lifestyle Coach application software. FIG. 8(a) provides an introduction to the healthy living topic. FIG. 8(b) describes the benefits of healthy living. FIG. 8(c) provides additional benefits of healthy living and specifically how physical activity can help an individual. FIG. 8(d) discloses how an individual can become healthier for life. FIG. 8(e) discloses how the Lifestyle Coach device allows you to adopt a healthy lifestyle. FIG. 8(f) discloses how the Lifestyle Coach approach (via the Lifestyle Coach application software) is easy and beneficial. FIG. 8(g) illustrates how to make changes in your life easier. FIG. 8(h) discloses the benefits of taking the first step of becoming more active. FIG. 8(i) discloses the benefit of managing your weight by eating healthy. FIG. 8(j) illustrates the benefit of managing you weight and burning calories.

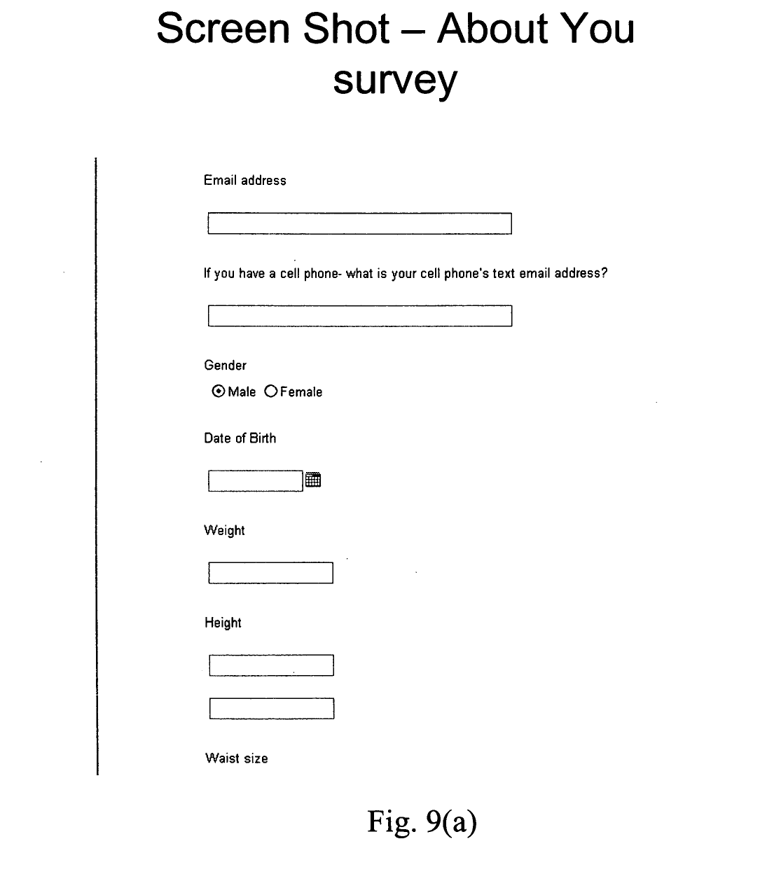

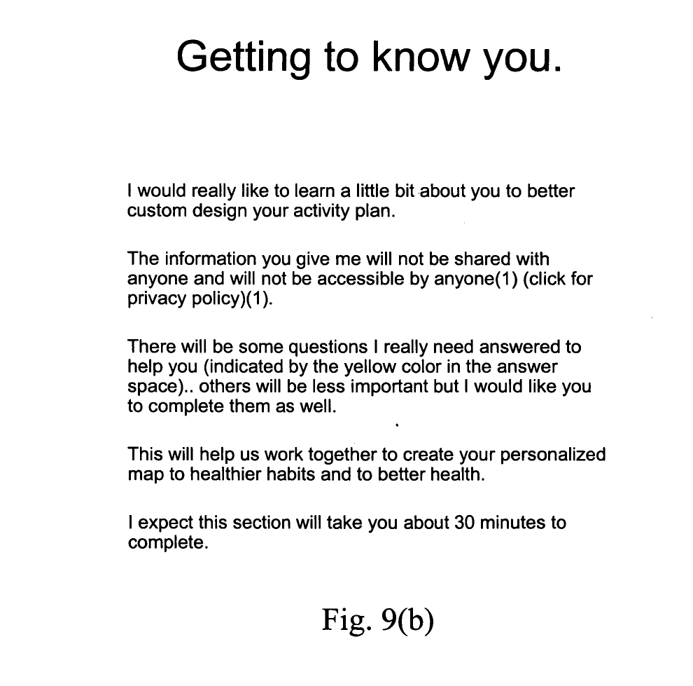

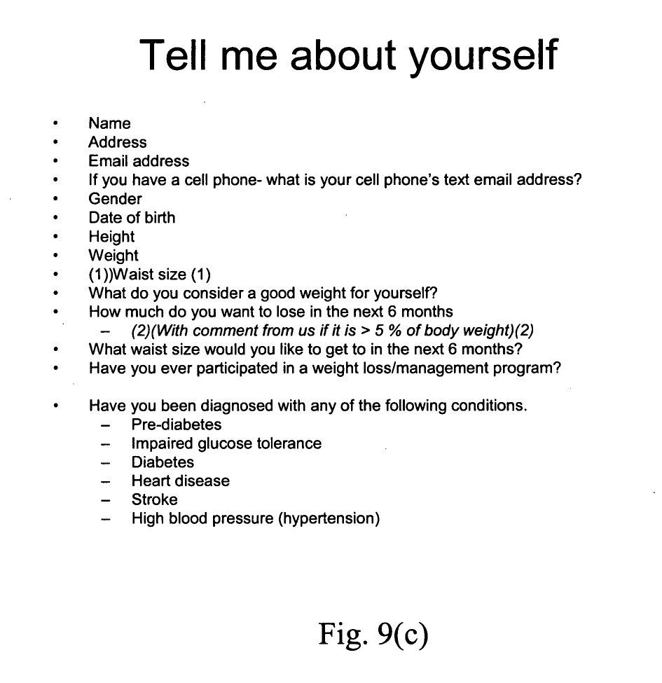

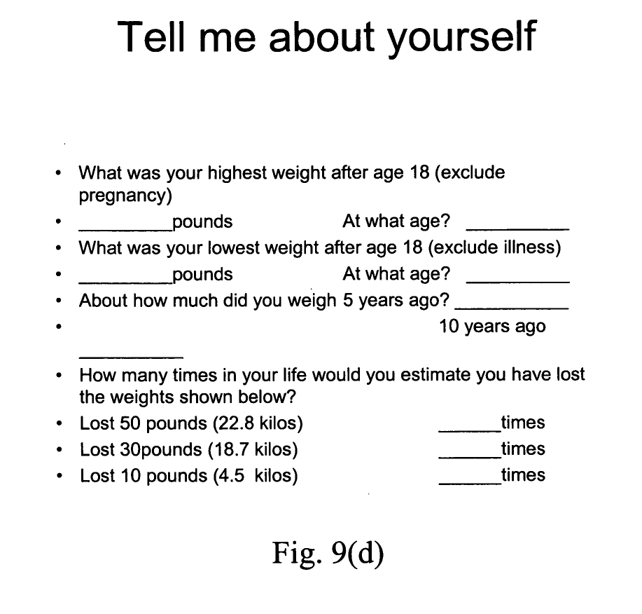

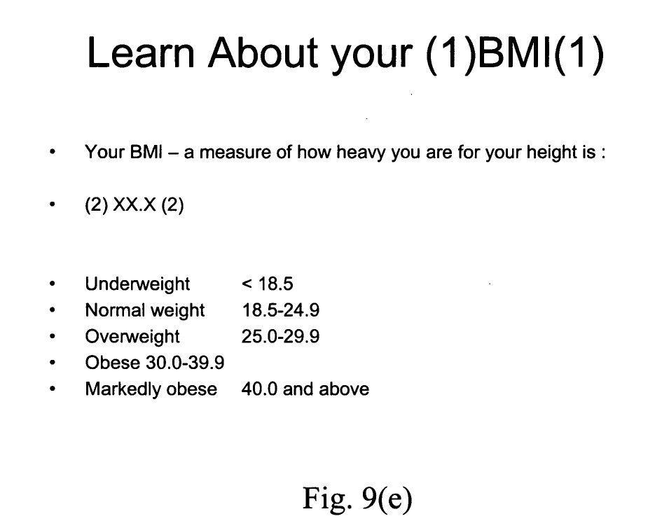

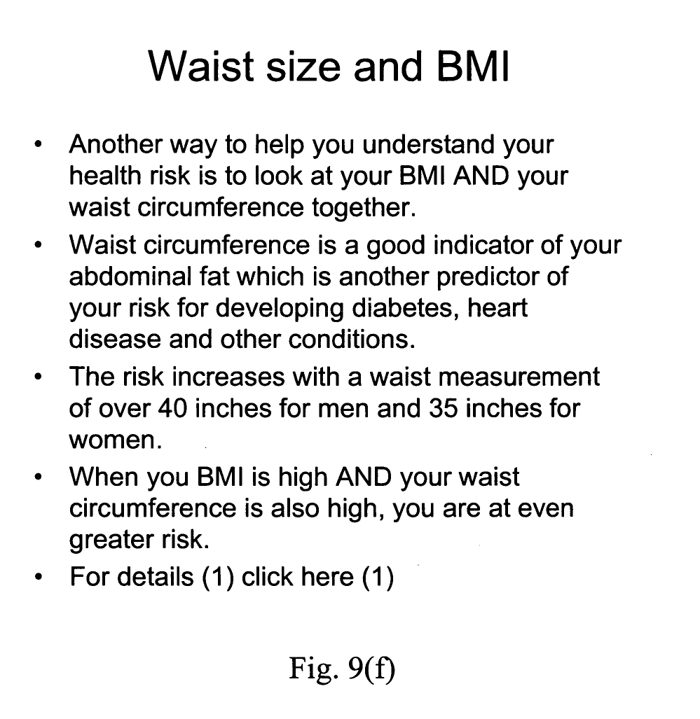

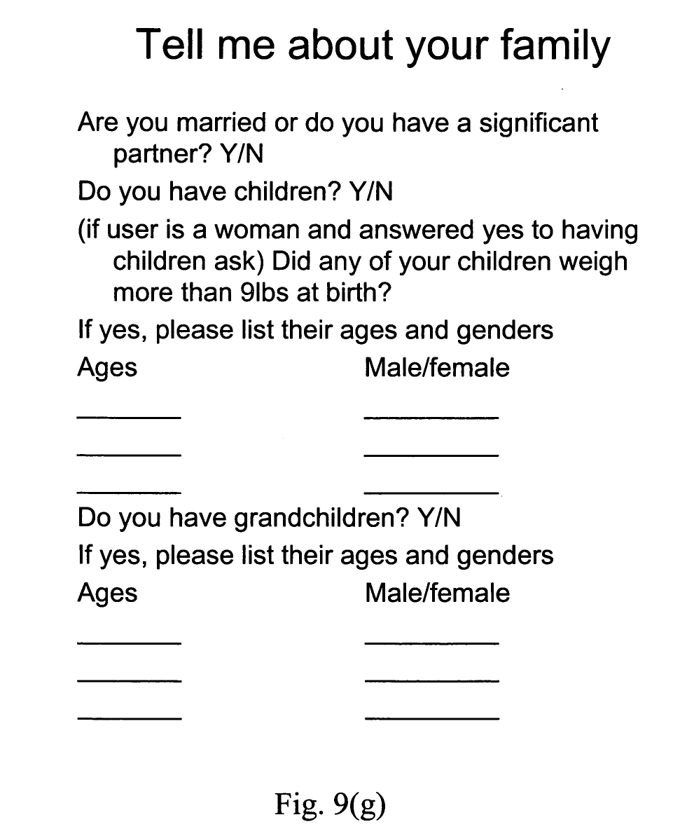

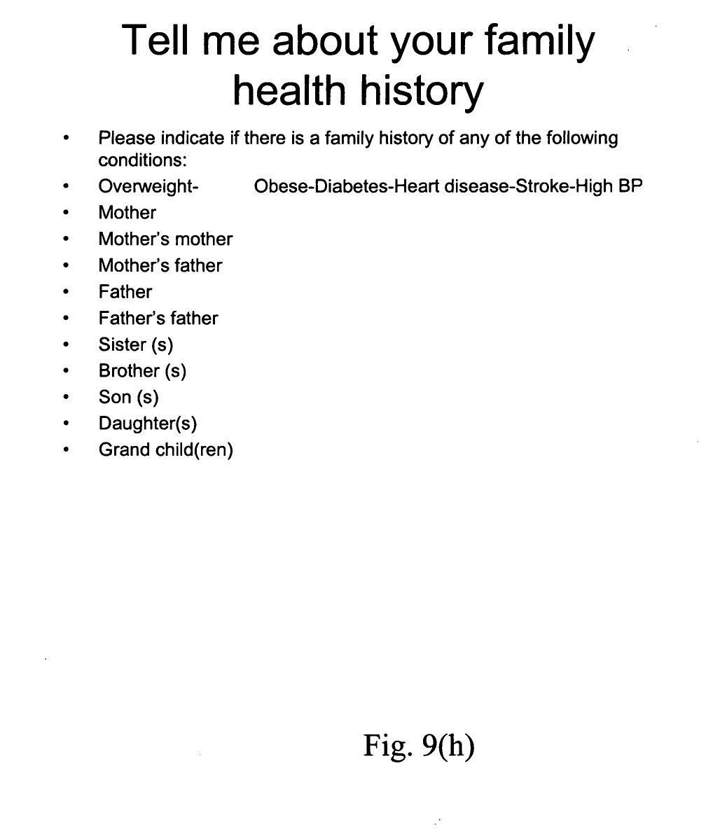

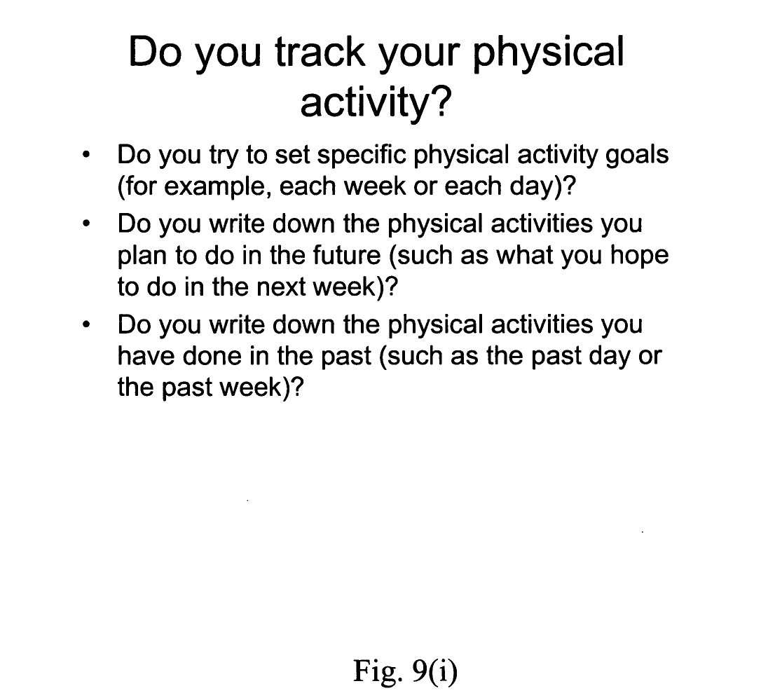

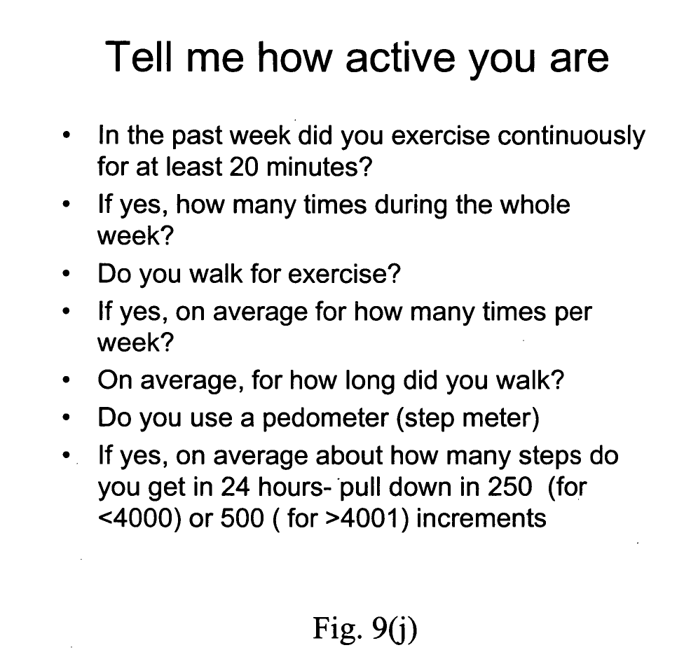

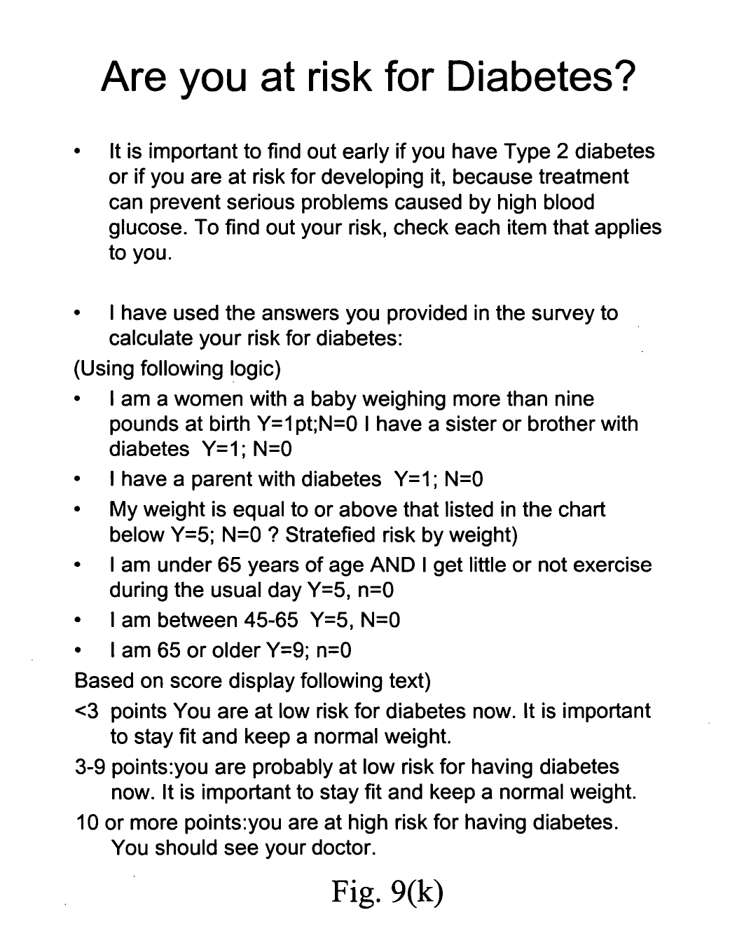

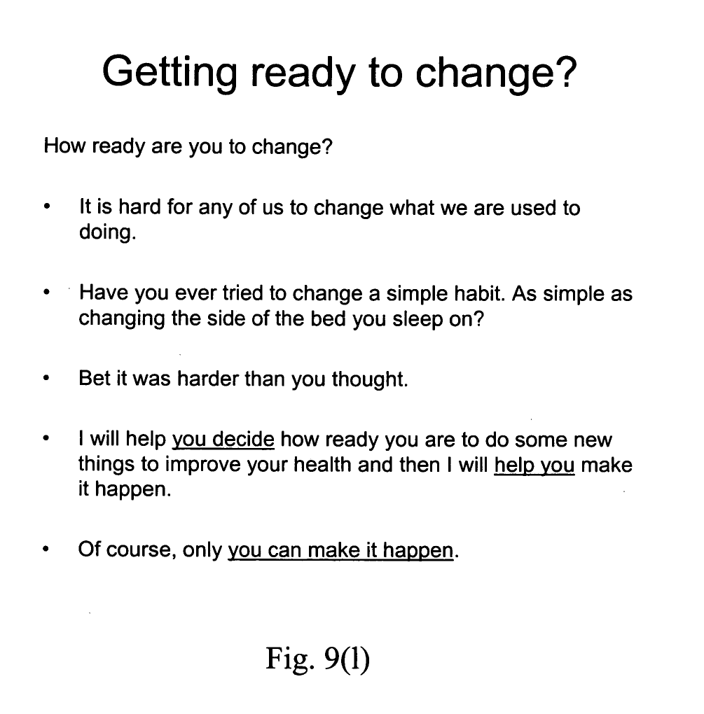

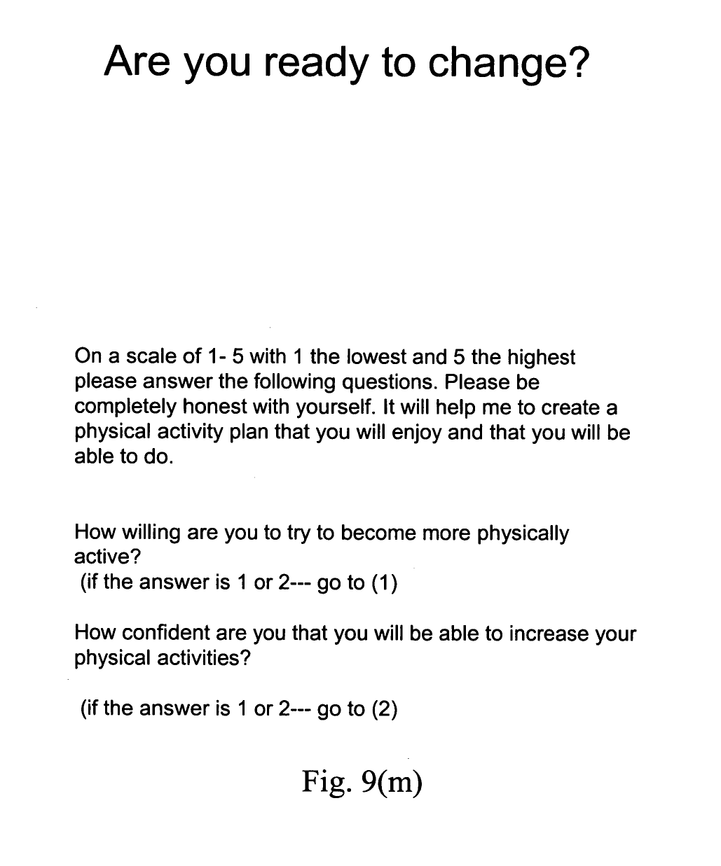

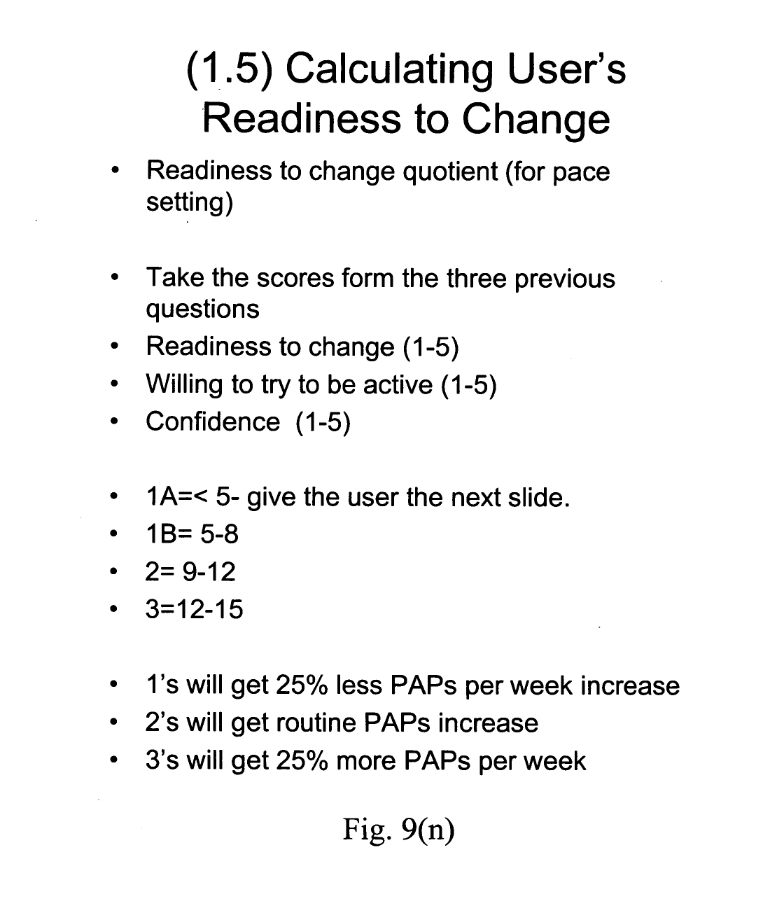

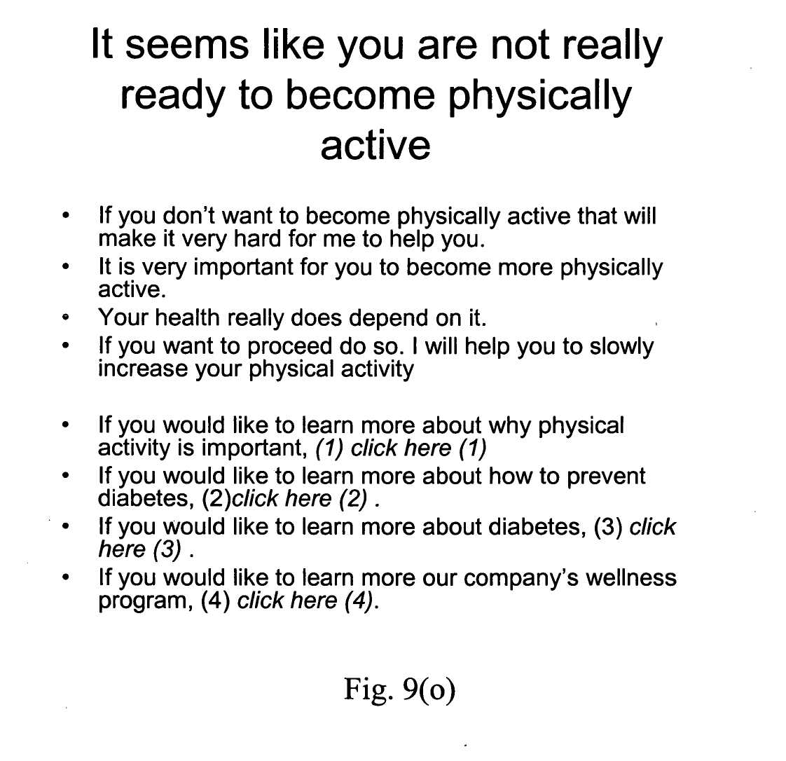

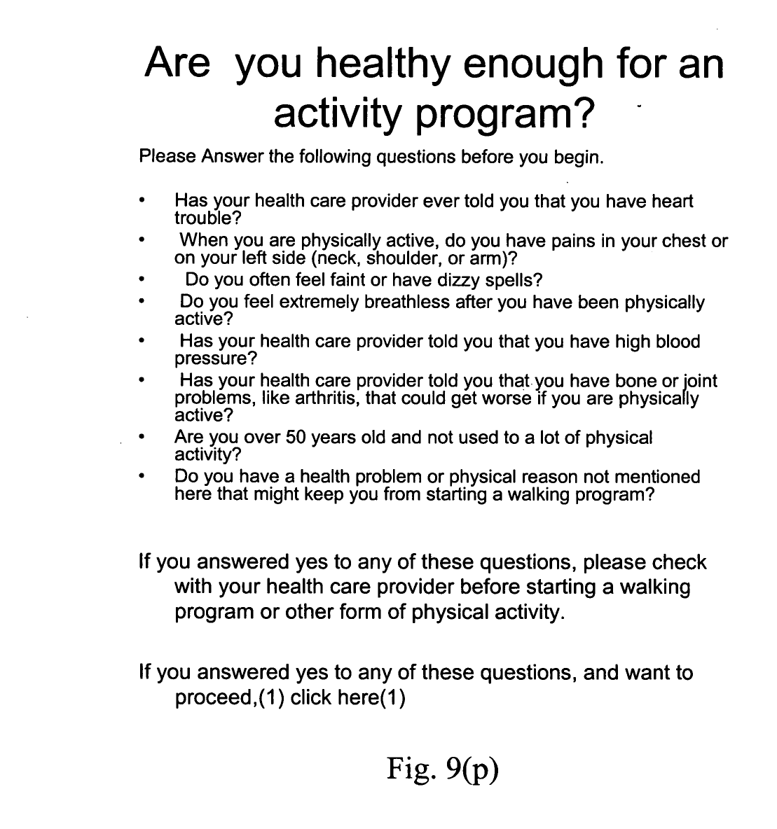

The Lifestyle Coach application software may collect any user specific information that is entered into the Lifestyle Coach application software, an application that shares data with the Lifestyle Coach application software, data stored in cookies of an Internet browser that is accessing the Lifestyle Coach application software. Under certain operating conditions, if the data is entered into an internet application, the Lifestyle Coach application software may communicate with the internet application to have the data transferred. FIG. 9(a) illustrates a screen shot of the About You survey which is part of the Learning process of the Lifestyle Coach application software. Illustratively, FIG. 9(a) requests a user's email address, a cell phone text email address, gender of the user, date of birth, weight, height, and/or waist size. FIGS. 9(b)-9(m) illustrate content screens of the About You survey according to an embodiment of the invention. FIG. 9(b) illustrates an introduction to the About You survey. FIG. 9(c) illustrates questions the Lifestyle Coach application software asks each user. Illustratively, the Lifestyle Coach application software may request a name, an address, an email address, a cell phone text email address, a user gender, a date of birth, a weight, and a waist size. Further, the Lifestyle coach application software may inquire about a weight that the user desires to achieve and/or how much the user may want to lose in the next six months. Illustratively, if the user wants to lose more than 5% of the user's body weight in the next six months, the Lifestyle coach application software may provide a message or comment as to the difficulty or achieving this goal along with the ramifications on a user's health. The Lifestyle Coach application software may also inquire a waist size that the user wants to active in the next six months. In addition, the Lifestyle Coach application software may inquire as to whether the user has participated in a weight loss/management program in the past. Further, the Lifestyle coach application software may inquire as to whether or not the user has been diagnosed with any medical conditions. Illustratively, this may include a pre-diabetes diagnosis, an impaired glucose tolerance diagnosis, a diabetes diagnosis, a heart disease diagnosis, a stroke diagnosis, or a high blood pressure diagnosis.

FIG. 9(d) illustrates questions that the Lifestyle Coach application software may ask the user in regard to weight. Illustratively, the Lifestyle Coach application software may ask a user his or her highest weight after age 18, the lowest weight after age 18, how much the user weighed 5 years ago, and how much the user weighed 10 years ago. Under certain operating conditions, the Lifestyle Coach application software may ask the user to exclude any pregnancies or illnesses that occurred in the last time period. The Lifestyle Coach application software may also inquire as to how many times the user has lost certain amounts of weight. For example, the Lifestyle Coach application software may ask the user how many times the user has lost 10 pounds, 30 pounds, or 50 pounds. FIG. 9(e) illustrates a measure of how heavy a user is compared to the user's height according to an embodiment of the invention. In the embodiment of the invention illustrated in FIG. 9(e), the score is called a Body Mass Index (BMI) score and the BMI score is a mathematical calculation that yields a two digit number that defines how heavy the user is for the user's height. For example, the BMI score may be a score having a format of XX.X. The Lifestyle Coach application software may classify the BMI scores into a number of categories, such as: (1) underweight—BMI less than 18.5; (2) normal weight 18.5-24.9; (3) overweight −25.0-29.9; (4) obese −30.0-39.9; and markedly obese −40.0 and above.

FIG. 9(f) discloses a correlation between BMI and waist size. FIG. 9(f) discloses that waist circumference is a good indicator of abdominal fat, which itself is a predictor of risk of developing conditions such as diabetes, heart disease, and other conditions. Illustratively, the risk of developing these conditions increases when the waist measurement is over 40 inches for men and over 35 inches for women. The Coach Lifestyle application software also notes the risk of developing these conditions becomes significantly higher when the BMI is high and the waist circumference is over the waist measurement threshold.

FIG. 9(g) illustrates questions about a user's family that the Lifestyle Coach application software may request. Under certain operating conditions, the Lifestyle Coach application software inquires as to whether the user is married or has a significant partner, whether the user has children, and if the user is a woman, if any of the children weighed more than 9 pounds at birth. The Lifestyle Coach application software may also ask the user the gender and age of the children as well as age and gender of any grandchildren the user may have.

FIG. 9(h) illustrates questions about a user's family medical history about which the Lifestyle Coach application software requests information. For example, the Lifestyle Coach application software may request information about family members and whether any of the family members have medical conditions, such as being obese, having diabetes, having heart disease, having a stroke, or having high blood pressure. The Lifestyle Coach application software may ask for this information for the mother, the mother's mother, the mother's father, the father, the father's father, any sisters, any brothers, any sons, any daughters, or any grown children. FIG. 9(i) illustrates questions about a user's physical activity on which the Lifestyle Coach application software requests information. Illustratively, the Lifestyle Coach application software may ask if the user sets weekly or daily physical activity goals. Further, the Lifestyle Coach application software may ask if the user writes down the physical activities that the user plans in the future, e.g., the activities the user plans to engage in within the next week. Further Lifestyle Coach application software may ask if the user writes down any physical activities that the user has done in the past, e.g., as in the last day or the last week.

FIG. 9(j) discloses examples of questions about a user's activity level about which the Lifestyle Coach application software requests information. The Lifestyle Coach application software may require information about physical activity that the user normally or frequently engages in. For example, the Lifestyle Coach application software may ask the user if the user continuously exercised for at least twenty minutes in the last week. The Lifestyle Coach application software, if the user has exercised continuously for at least 20 minutes, may ask the user how many times the user exercised in the last week. The Lifestyle Coach application software may also request information on lower impact forms of exercising, such as walking. The Lifestyle Coach application software may ask the user if the user walks, how many times the user walks in a week, and whether or not the user utilizes a pedometer or step meter when walking. If the user utilizes a pedometer, the Lifestyle Coach application software may ask the user the number of steps the user completes in a time period, such as a day. Under certain operating conditions, the user may be asked to input the number of steps in increments of 250 or, alternatively, 500 steps.

FIG. 9(k) illustrates an example of a risk management calculator according to an embodiment of the invention. The risk management calculator receives input from the user and determines if the user has a high risk for developing diabetes. The risk management calculator in the Lifestyle Coach application software may present the user with a number of factors and may assign point values to each of the factors. Depending upon the user's score, the risk management calculator may classify the user as having a specific risk factor into either 1) having a low risk for diabetes; 2) having a medium risk of diabetes; and 3) having a high risk for diabetes. Illustratively, the risk management calculator may ask the user if the user is a woman with a baby who weighed more than nine pounds at birth. If the user answers in the affirmative, the risk management calculator may assign the user one point. The risk management calculator may ask the user if the user has a sister or brother with diabetes. If the user has a sister or brother with diabetes, the user may be assigned a point. The risk management calculator may ask the user if the user has a parent with diabetes and the user may be assigned a point if the user's parent had diabetes. The risk calculator in the Lifestyle Coach application software may include a weight chart listing weight along with heights and genders of user. The risk calculator may ask the user if the user is equal to or above the weight listed in the chart. If the user has a weight listed in the chart above, the user may be assigned a large number of points, e.g., 5 points, because being over the weight listed in the chart is a significant factor in whether or not a user may develop diabetes. Further, the risk calculator may ask the user is the user is under 65 years of age and gets little or no exercise during the day. If the user meets these conditions, the user may be assigned a large number of points, e.g., 5 points. In addition, the risk calculator may ask the user if the user is between the ages of 45 and 65 years old. If the user is between these ages, the user may be assigned a large number of points by the risk calculator, e.g., 5 points. Further, the risk calculator may ask if the user is older than 65 years old and if the user is older than 65 years old, the risk calculator may assign the user an extremely large number of points, e.g., 9 points. After the risk calculator adds up all of the user's points, the risk calculator may classify the user into a specific category. As illustrated in 9(j), the risk calculator may have three classifications, i.e.: (1) less than three points—low risk for developing Type II diabetes; (2) between three to nine points—medium risk for developing Type II diabetes; and (3) over ten points—high risk for developing Type II diabetes.

FIG. 9(k) discloses an example of the readiness to change for a user. FIG. 9(l) illustrates questions a change indicator module in the Lifestyle Coach application software ask to determine a likeliness to change rating for the user. Under certain operating conditions, the change indicator module may ask a user a number of questions to identify whether the user is willing and ready to change. For example, the user may be asked to rate whether or not the user has a readiness to change. In addition, the change indicator module may ask the user to rate whether or not the user is willing to become more physically active. Further, the user change indicator module may ask the user to rate whether or not the user can increase your physical activities. After the user has provided the ratings, the change indicator module may determine a readiness to change quotient, as is illustrated in FIG. 9(m). Depending on the overall readiness to change quotient, the Lifestyle Coach application software determines the PAPs per week increase as compared to a normal user. Illustratively, if an individual has a low score, e.g., less than 5 for the readiness to change quotient, then the Lifestyle Coach application software may display a web page or chart, as illustrated in FIG. 9(n), challenging the user to be physically active and receptive to changing the user's lifestyle. As illustrated in FIG. 9(o), if the user has a score between 5-8, the user may have a 25% reduction in PAPs per week increase during the utilization of the Lifestyle Coach application software. If the user has a readiness to change quotient score of between 9-12, the user may get routine PAP increases weekly and if the user has readiness to change quotient of between 12-15, the user may be assigned 25% greater PAP increases weekly.

FIG. 9(p) discloses the characteristics of individuals who need appropriate authorization before becoming involved in the Lifestyle Coach program. Illustratively, certain users may not be able to enter into strenuous physical activity immediately without first checking with a medical professional. For example, the Lifestyle Coach application software may inquire as to whether the user has had heart trouble, feels faint or has dizzy spells, has high blood pressure, has arthritis, or is over 50 years old and is not used to a lot of physical activity. The Lifestyle Coach application software may not prohibit the users from enrolling in the program. Instead, the Lifestyle Coach application software may request that the user checks with user's doctor or a loved one before embarking on the program.

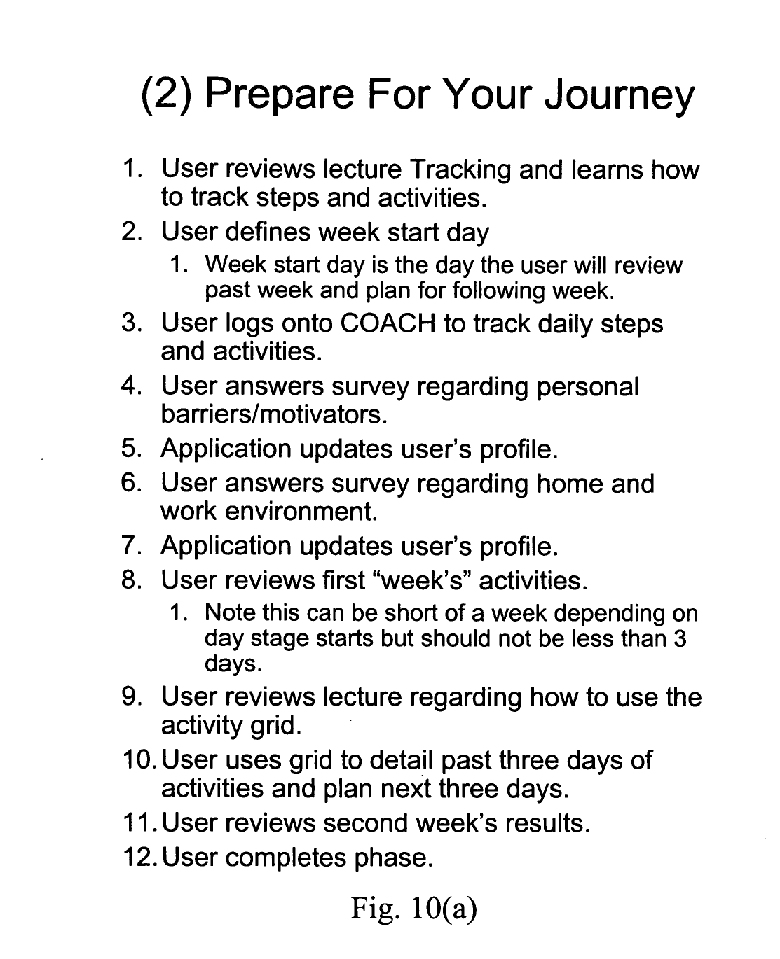

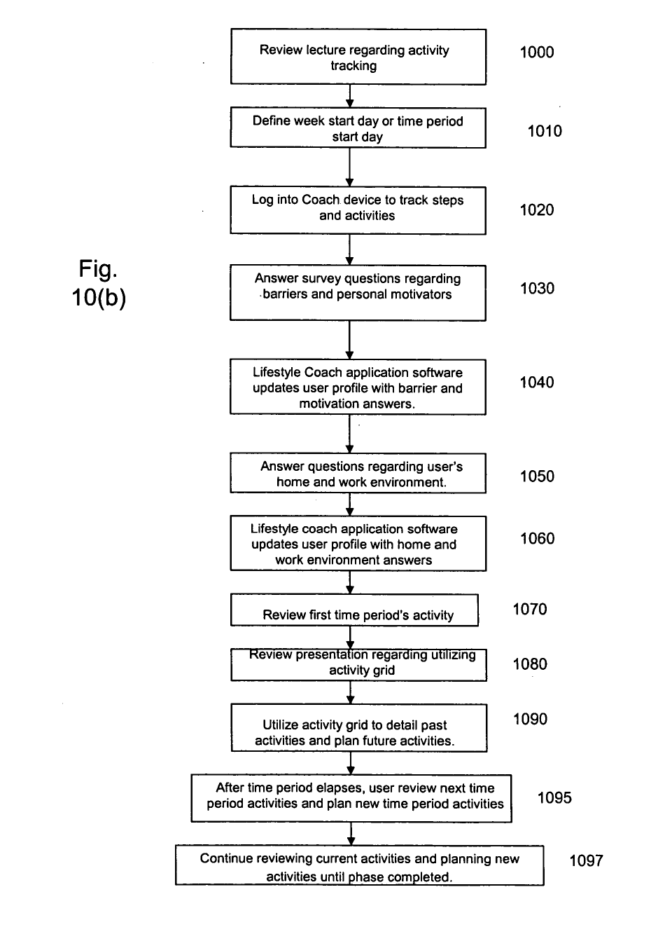

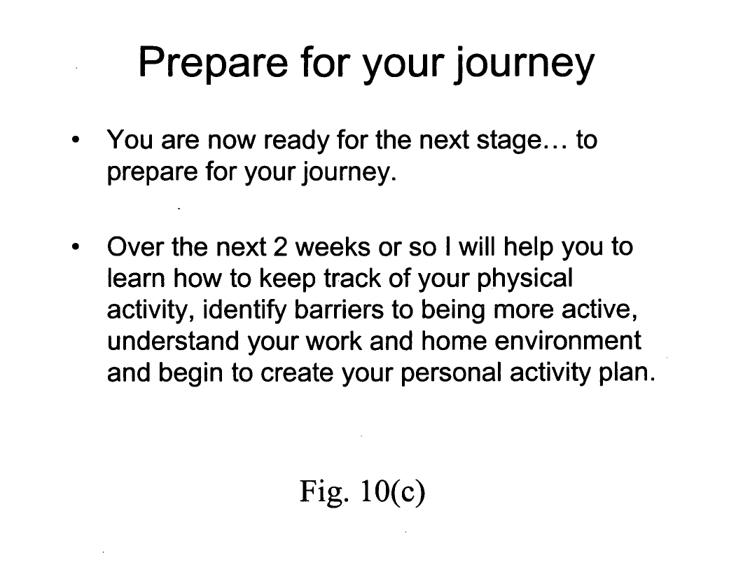

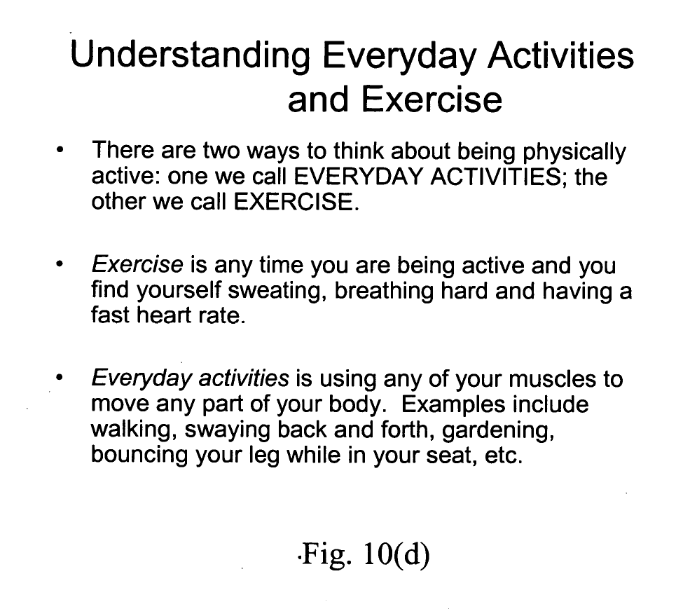

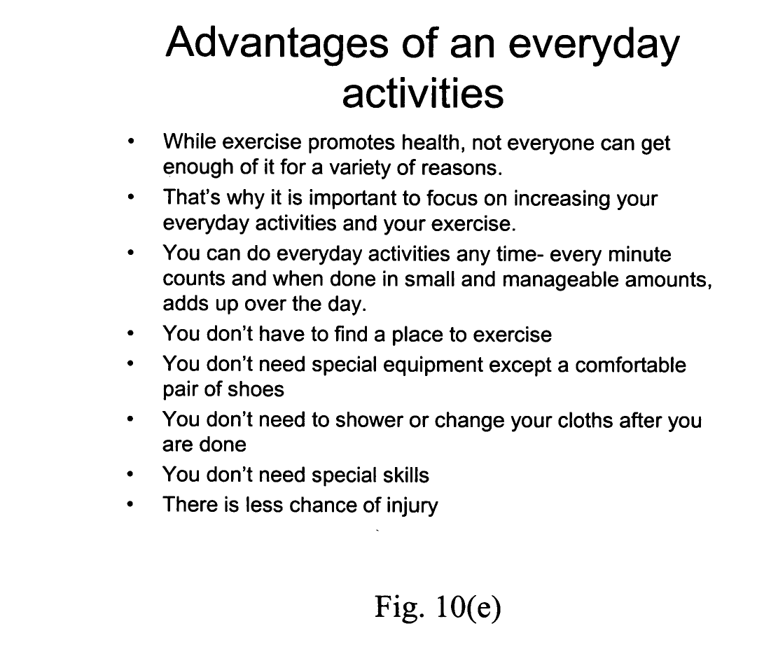

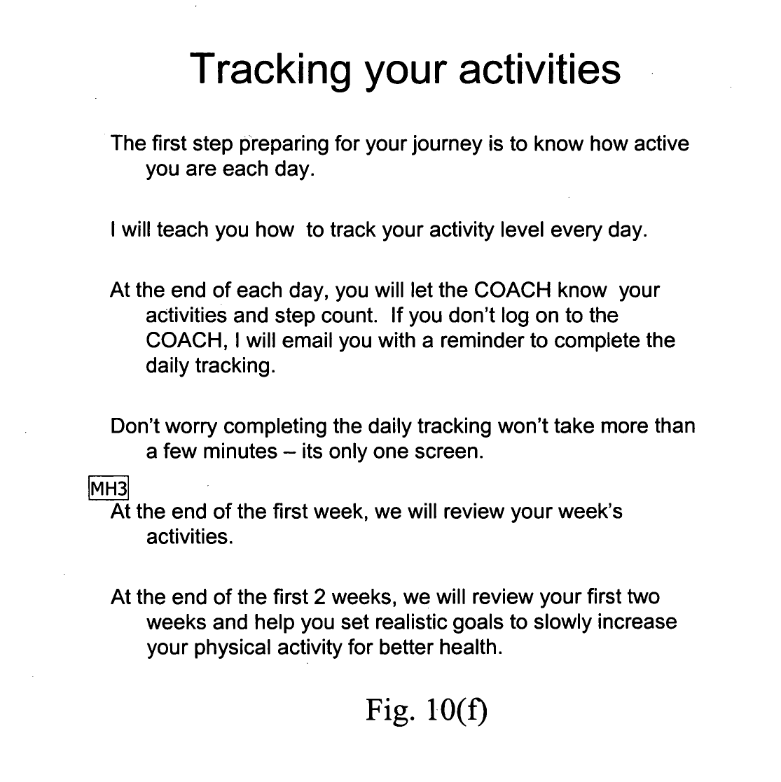

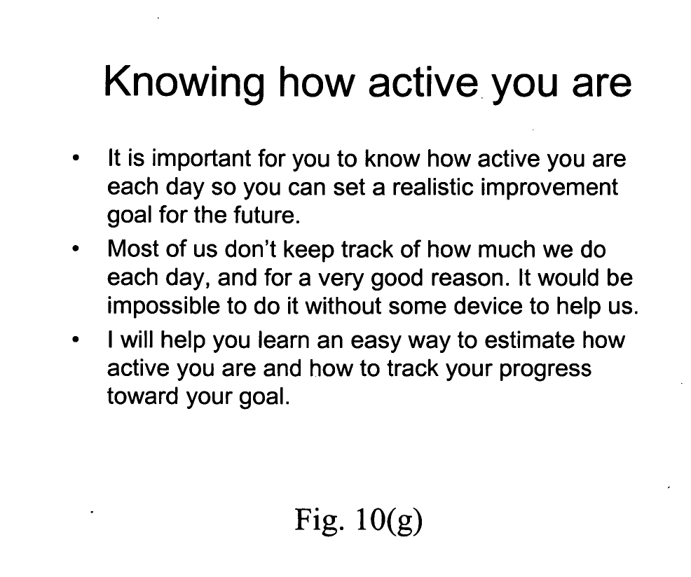

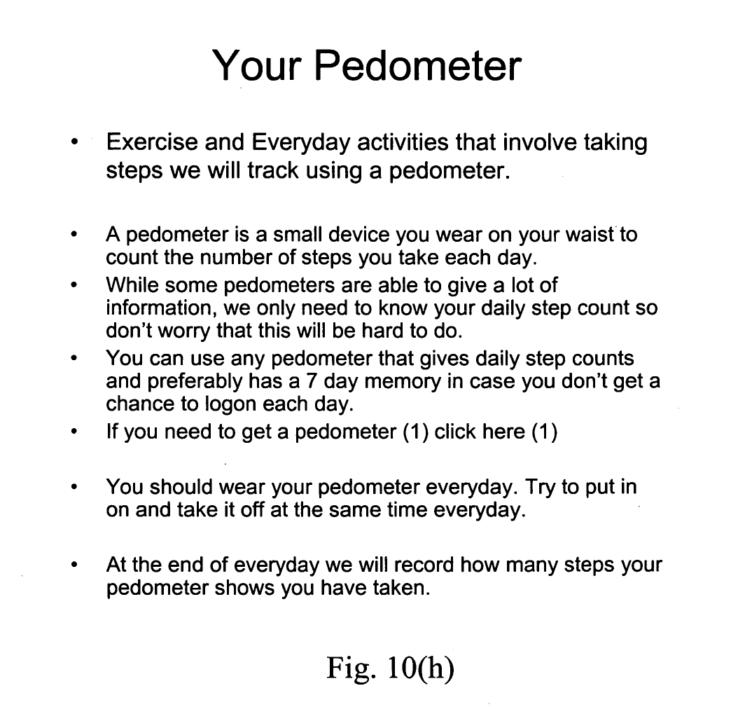

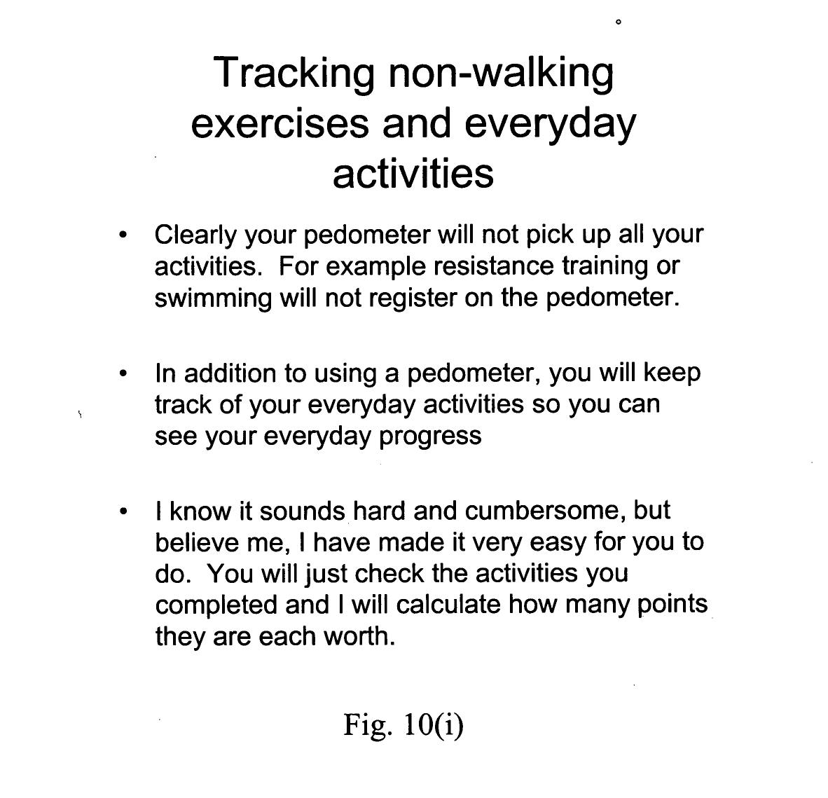

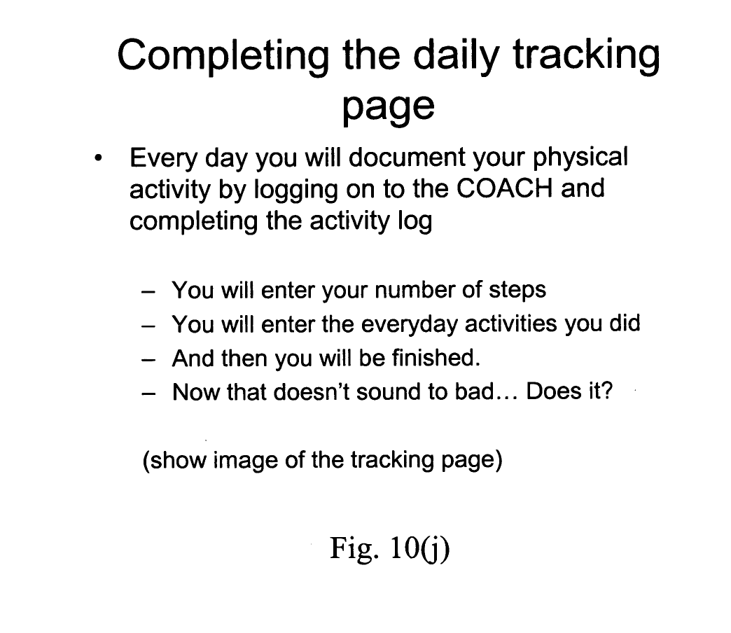

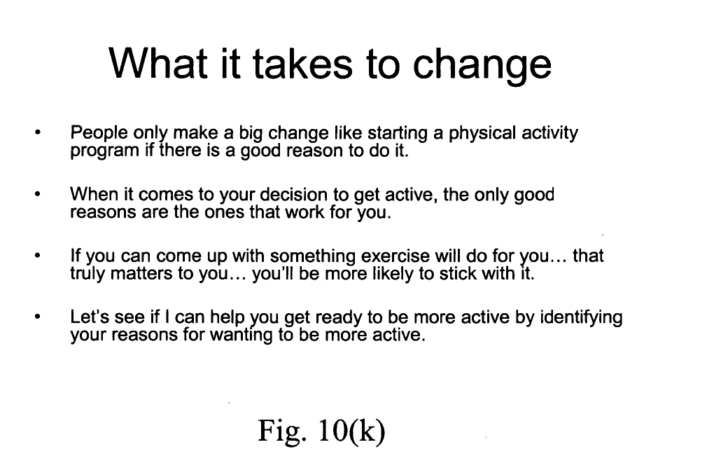

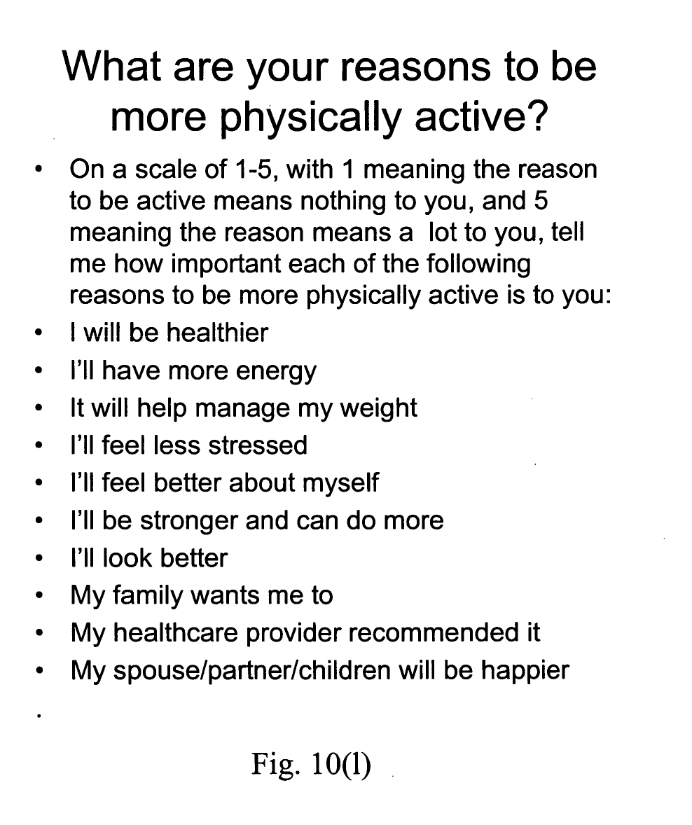

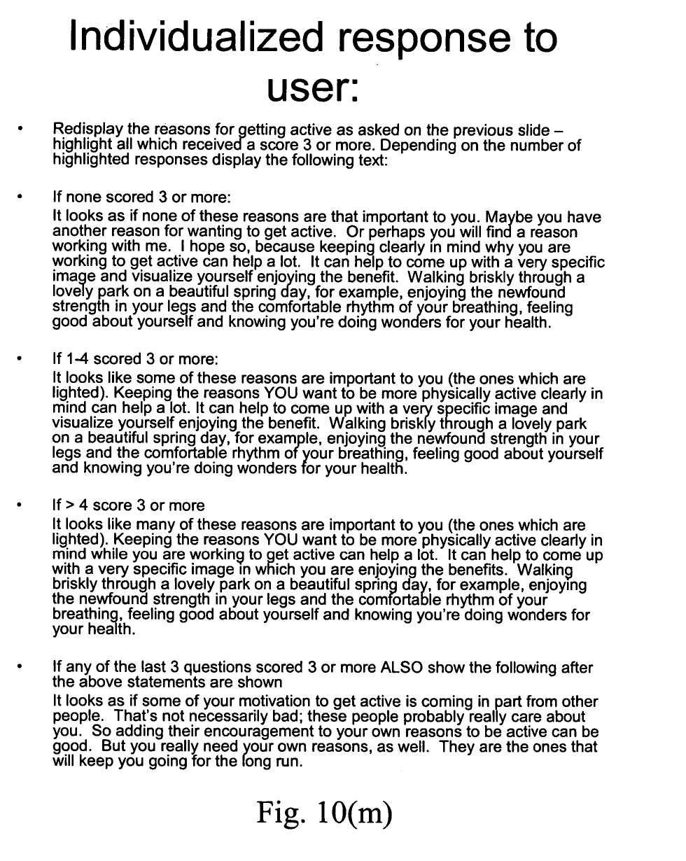

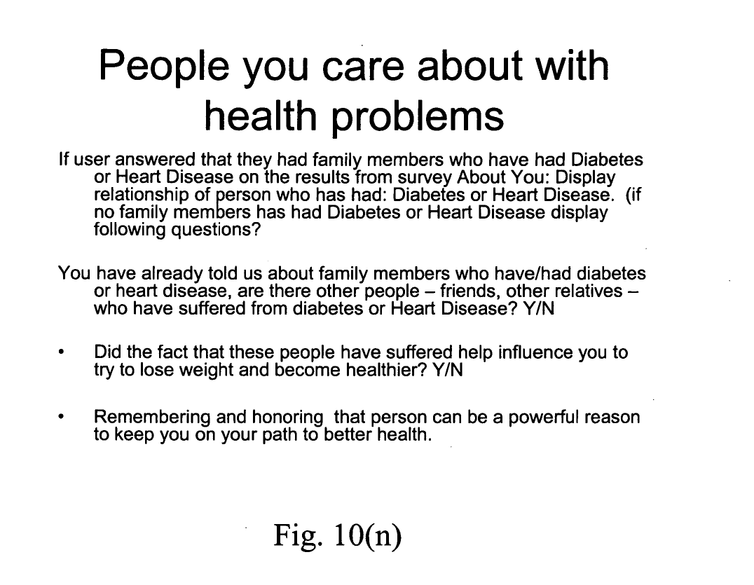

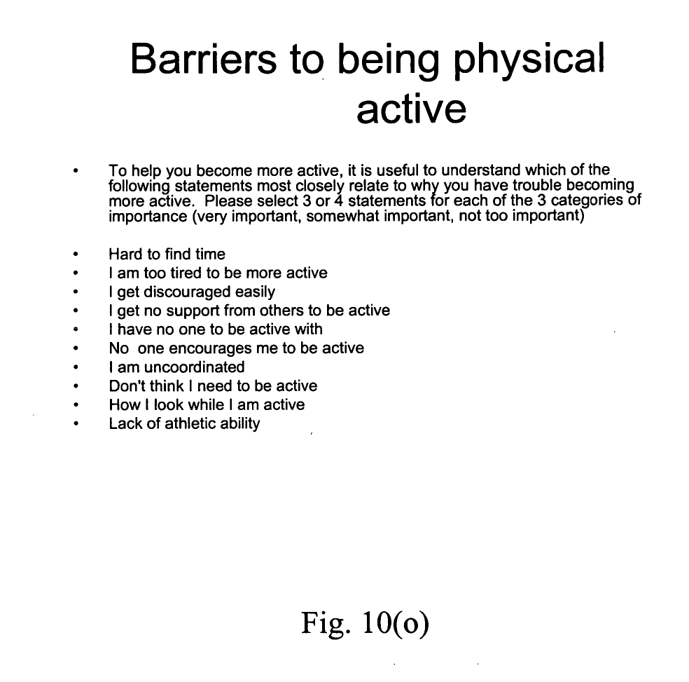

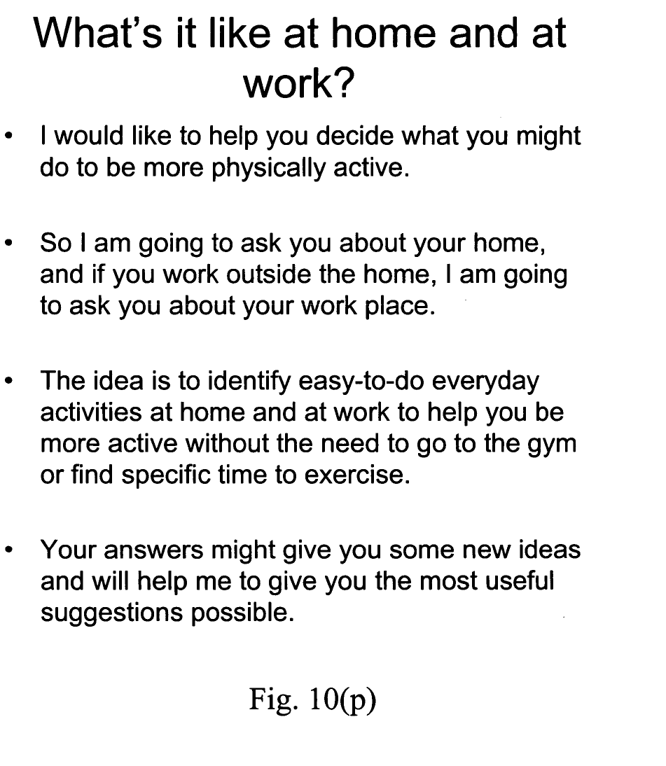

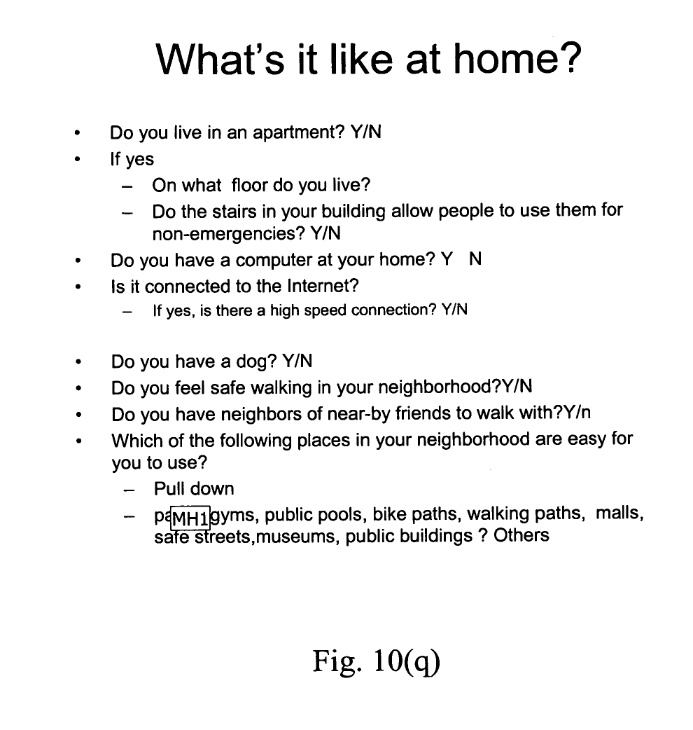

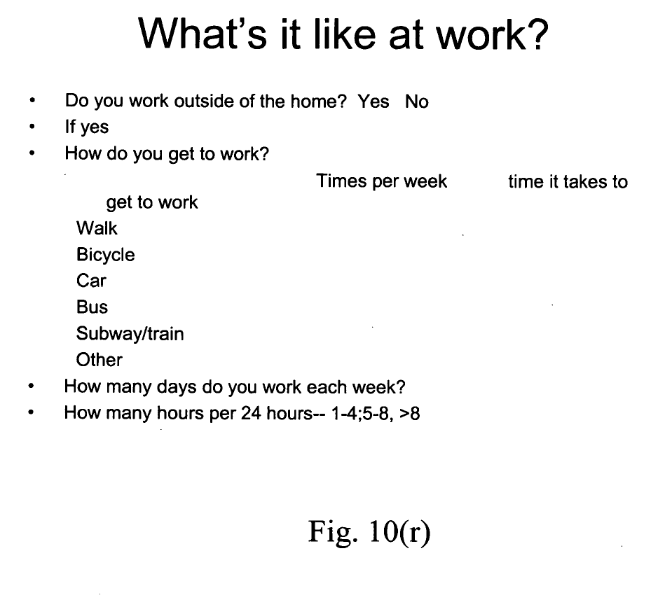

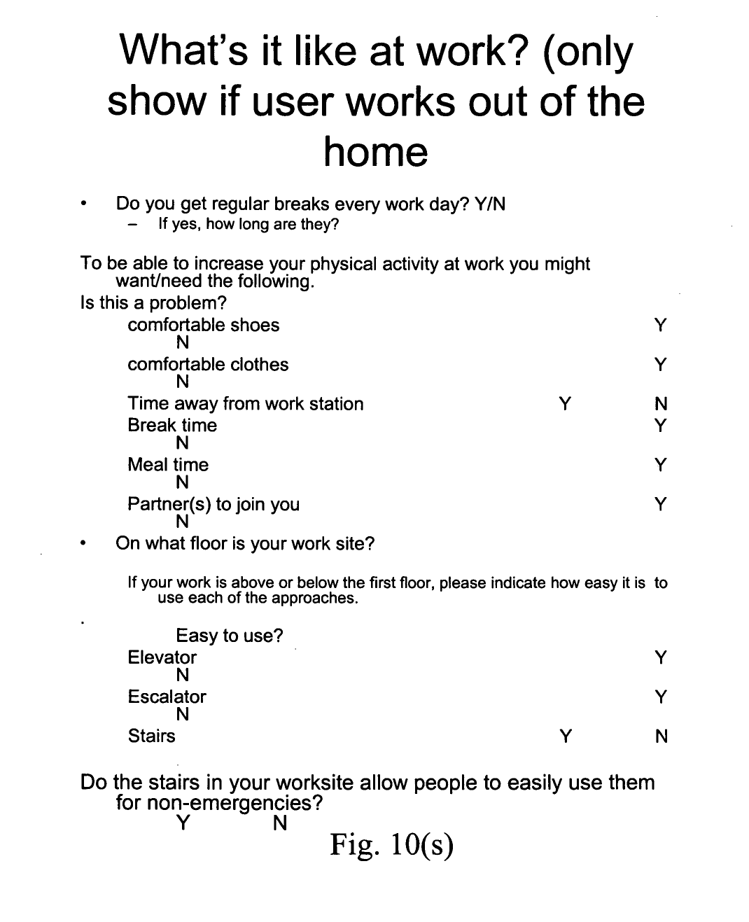

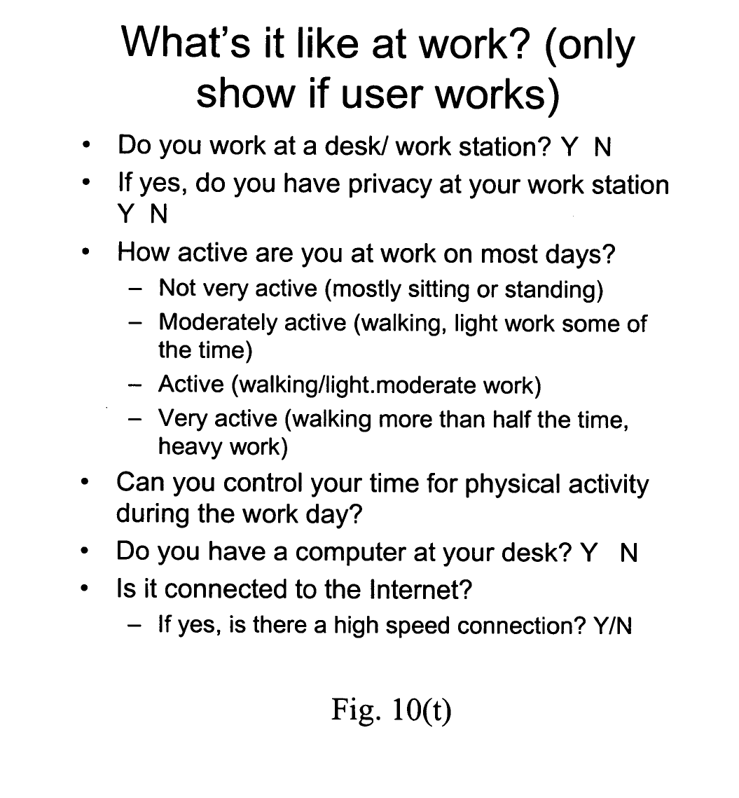

FIG. 10(a) illustrates an input screen for the Journey Preparation stage. FIG. 10(b) illustrates a flowchart identifying the Journey. In an embodiment of the invention, the user may review 1000 a lecture on activity tracking which details how to track steps and activities. After the user review the activity tracking lecture, the user may define 1010 a week or time period start day. This may be the day that the user reviews the past week (or time period of data) and plans for the next week (or time period).

In an embodiment of the invention, the user may log into 1020 enable the Coach device in order to track steps. The user may also track activities. The user may then answer 1030 survey questions regarding personal barriers and personal motivators. After the Lifestyle Coach application software receives the answers from the user, the Lifestyle Coach application software may update 1040 the user's profile stored in the application.

The Lifestyle Coach application software may present 1050 a survey regarding questions about the user's home and work environment. The user may provide answers to the home and work environment survey and with the answers, the Lifestyle Coach application software may update 1060 the stored user's profile in the Lifestyle Coach application software.

The user may then exit the Lifestyle Coach application software. Illustratively, the user may disable the connection from the Lifestyle Coach device or turn off the Lifestyle Coach device. After a number of days (or other specified time period), the user may review 1070 the first time period's (e.g., week's) activities. For example, the review period can be one week or the review period can be a shorter period of time. Under certain operating conditions, the review period should be at least three days.

The user may review 1080 a lecture or presentation on utilization of an activity grid within the Lifestyle Coach application software. The user may then utilize 1090 the activity grid to detail the past time period's activities and to plan the next time period's activities. Illustratively, a user utilizing the activity grid may detail the past three day's of activities and plan the next three days of activities. After the next time period has lapsed, the user can review 1095 the next time period's activities and plan a new time period's activities. The reviewing of the next time period's activities and planning the new time period's activities continues until the user has completed 1097 the phase the user entered into.

FIG. 10(c) illustrates a content page disclosing the journey preparation phase for the Lifestyle Coach application software. FIG. 10(d) illustrates a content pages describing everyday activities and exercise. FIG. 10(e) illustrates a content page describing the advantages of everyday activities as compared to a sedentary lifestyle. FIG. 10(f) illustrates a content page introducing the user to tracking of the user's activities. FIG. 10(g) illustrates a content page in the Lifestyle Coach application software describing benefits of knowing how active a user is. FIG. 10(h) illustrates a content page describing how a pedometer can be utilized. A link may be placed on this page in order for a user to purchase a pedometer. FIG. 10(i) illustrates a content page describing how a user can track non-walking activities and everyday activities. FIG. 10(j) illustrates a content page disclosing how a daily or weekly tracking page can be utilized. For example, the user may enter the number of steps into the tracking page. The user may also enter the everyday activities that the user has performed. Illustratively, the user may enter a number of different responses of items into the tracking page. Under certain operating conditions, the user may select to not track activities for a certain day. A text box may be included in the Lifestyle Coach application software in order to identify why the user did not engage in tracking for that timeframe, e.g., day. The user may enter steps from a pedometer into the tracking page. Under certain operating conditions, the tracking page may display a number of activities a user has scheduled or committed to for that time period (e.g., day). The user can then select the scheduled/committed items that the user has completed. In addition, under certain operating conditions, the user may add other activities that have been completed, but were not committed to. For example, a drop down list may be presented to the user and the user may select the activity designation, the time of the day, any particular details of the activity, the duration of the activity, and the intensity of the activity. In an embodiment of the invention, the Lifestyle Coach application software may be able to add the new activity as a scheduled or committed activity for one of the future time periods.

FIG. 10(k) illustrates a content screen identifying what it takes for a user to change which is part of the barrier/motivation survey of the Lifestyle Coach application software. FIG. 10(l) illustrates a content screen of the barrier motivational survey a user is asked to complete in an embodiment of the invention. For the Barrier/Motivational survey, the user may be asked to rate (on a scale of 1 to x) how important each motivation is to the user as to why the user enrolled in the Lifestyle Coach application software. For example, the user may rate each motivational factor on a scale from 1 to 5. Illustratively, the user may be asked to rate the following motivational factors: 1) User wants to be healthier; 2) User wants to have more energy; 3) User wants to manage weight better; 4) User wants to feel less stressed; 5) User wants to feel better about his or her self; 6) User wants to be stronger and engage in more physical activity; 7) User wants to look better; 8) User's family wants the user to be more physically active; 9) User's healthcare provider has recommended to the user to be more physically active; and 10) the user's spouse/partner/or children would be happier if the user was more physically active. FIG. 10(m) illustrates a content screen for a list of individual responses that can be provided to the user. The barrier/motivational survey module of Lifestyle Coach application software may highlight all of the reasons that are above a certain threshold score and present these motivational factors to the user. Under certain operating conditions, if none of the motivational factors scored above the certain threshold, then the barrier/motivational survey module may ask the user to identify other motivational factors which will encourage the user to meet the user's activity goals. Under certain operating conditions, if a low number or a medium number of motivational factor were above the certain operating threshold, e.g. 1-4 motivational factors (low) or greater than four, the barrier/motivational module may stored these motivational factors as important to the user. If the user ranks any of the last three motivational factors (factors 8-10 listed above), the barrier motivational module may provide information to the user indicating that while motivation coming from other people is important, it is also important to have an individual's own motivational factors in order to be successful.

FIG. 10(n) illustrates a content page describing how motivational factors can be influenced because of health problems of other individuals who are close to the user. The barrier/motivational survey module may also request that a user provide information as to whether the fact that other people have suffered from dehabilitating conditions has motivated you. FIG. 10(o) illustrates a content page listing a number of barriers to becoming physically active. The motivational/barrier survey of the Lifestyle Coach application software requests that a user select a number of reasons why the user may not be able to become physically more active. Illustratively, the user's barriers to becoming more physically active may be 1) it is hard to find the time; 2) the user is too tired to become more active; 3) the user gets discourage too easily; 4) the user gets no support from others to be active; 5) the user has no one to be active with; 6) the user has no one to encourage the user to be more active; 7) the user is uncoordinated; 8) the user does not believe that the user has to be active; 9) the user does not like the way the user looks when the user is active; 10) the user lacks in athletic ability; 11) the user has not seen any effect from past exercise efforts; 12) the user if afraid of being hurt or sore after engaging in strenuous physical activity; 13) the user does not find being physically active is fun; 14) the user is not interested in being more active; 15) the user can not think of ways to reward himself for being more active; 16) the user does not have any time at work to be active; 17) the user does not have the right equipment to be active; 18) the user lacks knowledge about being active; 19) the user does not like to sweat or perspire; 20) the user does not have the right clothing; or 21) the weather where the user lives is normally too bad/threatening to become active.

FIG. 10(p) illustrates a content page for the home/work environment survey according to an embodiment of the invention. This page provides an introduction to the home/work environment survey. Under certain operating conditions, the Lifestyle Coach application software includes an environment survey module that presents the user with information, receives answers from the user in regard to the user's environment, and utilizes this information to assist the user in changing the user's lifestyle. FIG. 10(q) illustrates a content page that requests information about a user's home environment. For example, the environment survey module may request information as to whether the user lives in an apartment (and if so, does the apartment have an elevator or stairs, plus does the user utilize the stairs). The environment survey module may also ask the user if the user has a computer and if the computer is connected to the Internet. Further, the environment survey module may also ask if there is a high speed connection to the Internet. In addition, the environment survey module may ask if the user has a dog, if the user feels safe walking in the neighborhood in which they live, and if the neighbor has near-by friends with which the user can walk. Under certain operating conditions, the environment survey module may present a pull down menu and ask the user if certain exercise venues are present in the neighborhood and are easily accessible. For example, the exercise venues may include parks, gyms, public pools, bike paths, walking paths, malls, safe streets, museums, or public buildings with large walking areas.

FIGS. 10(r, s, t) illustrate a content screen of a work survey according to an embodiment of the present invention. The environment survey module may ask if the user works outside the home and if the answer is yes, the environment survey module may ask how the user gets to work. The environment survey module may ask if the user what type of transportation the user takes to work, how many times the user takes each mode of transportation per week, along with the time it takes to go to work utilizing each of the selected modes of transportation. For example, the environment survey module may ask if the user walks to work, takes a bicycle, a car, a bus, a subway, or a train. The environment survey module may also ask a user how many days a week the user works along with how many hours a day the user works.

The work portion of the environment survey module may ask the user if the user gets regular breaks each day and the duration of the breaks. Further, the environment survey module may ask the user if the user can wear comfortable shoes at work and/or wear comfortable clothing. In addition, the environment survey module may ask the user to disclose the time away from the user's workstation and whether it includes break time, meal time, and whether or not partners join you for the time away from the work station. The environment survey module of the Lifestyle Coach application software may ask the user if the user works on the first floor or a floor above the first floor. If the user works on another floor besides the first floor, the environment survey module may ask the user if the user utilizes the elevator, the escalator, or the stairs. The environment survey module may ask the user if the stairs at the work site are available for people to use them in non-emergency situations, e.g., like in climbing the stairs for five minutes during an employees break session. The environment survey module may also ask if the user works at a desk/work station and whether or not the workstation has privacy. The environment survey module may also ask the user if the user is active at work. Under certain operating conditions, the environment survey module may present the user with options as to whether the user is not very active, moderately active, active, or very active. The environment survey module may also ask the user if the user can control his or her time in order for the user to engage in physical activity during the work day. In addition, the environment survey module may ask the user if the user has a computer at the user's workstation and whether or not the computer is connected to the Internet through a high speed connection.

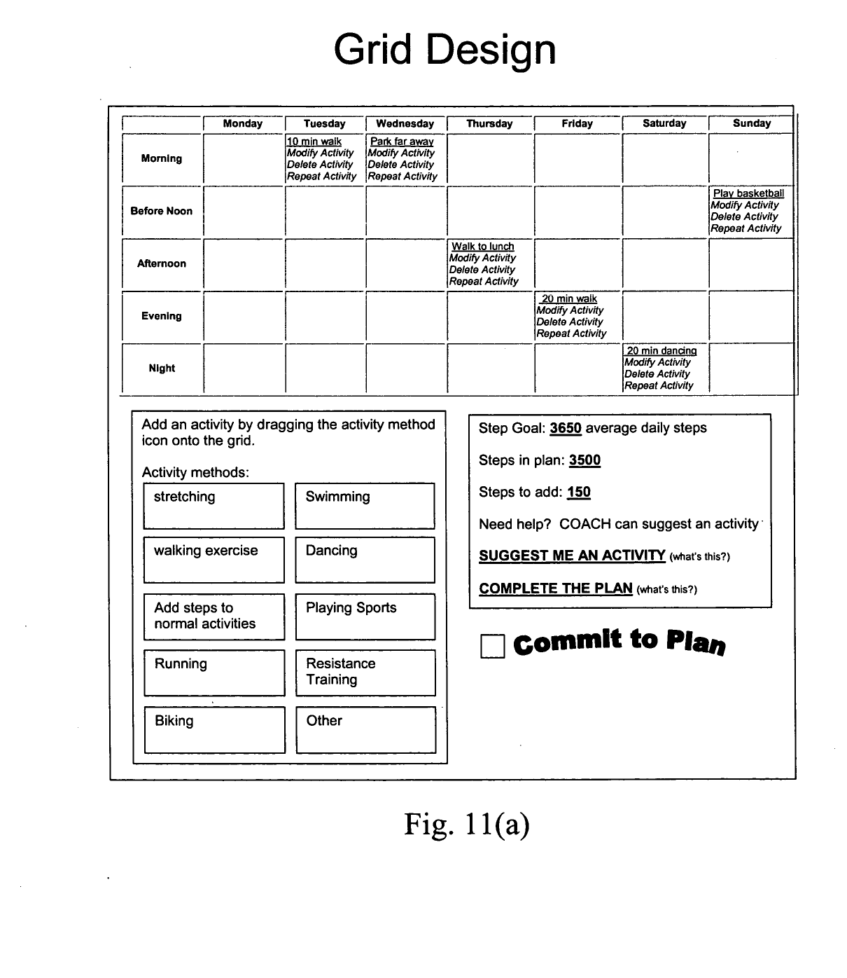

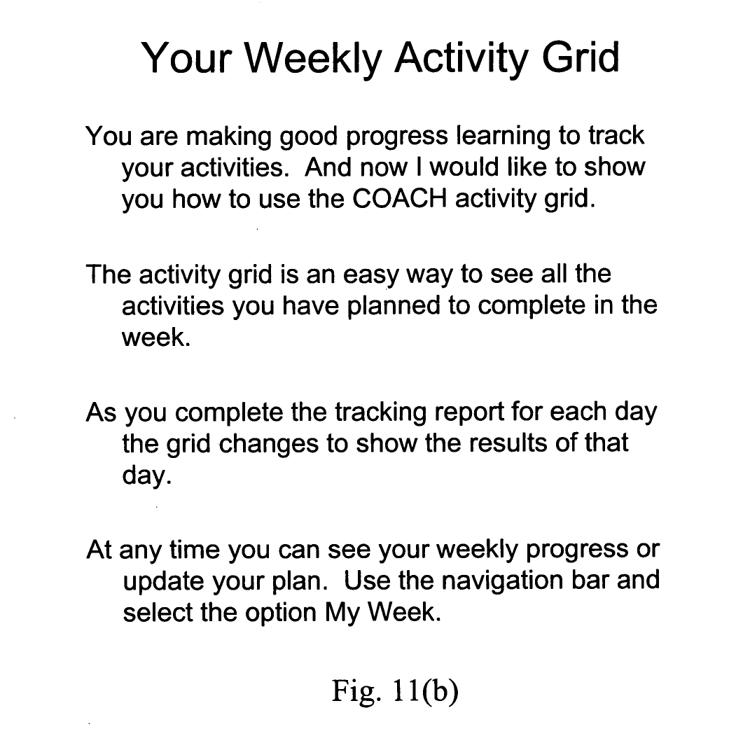

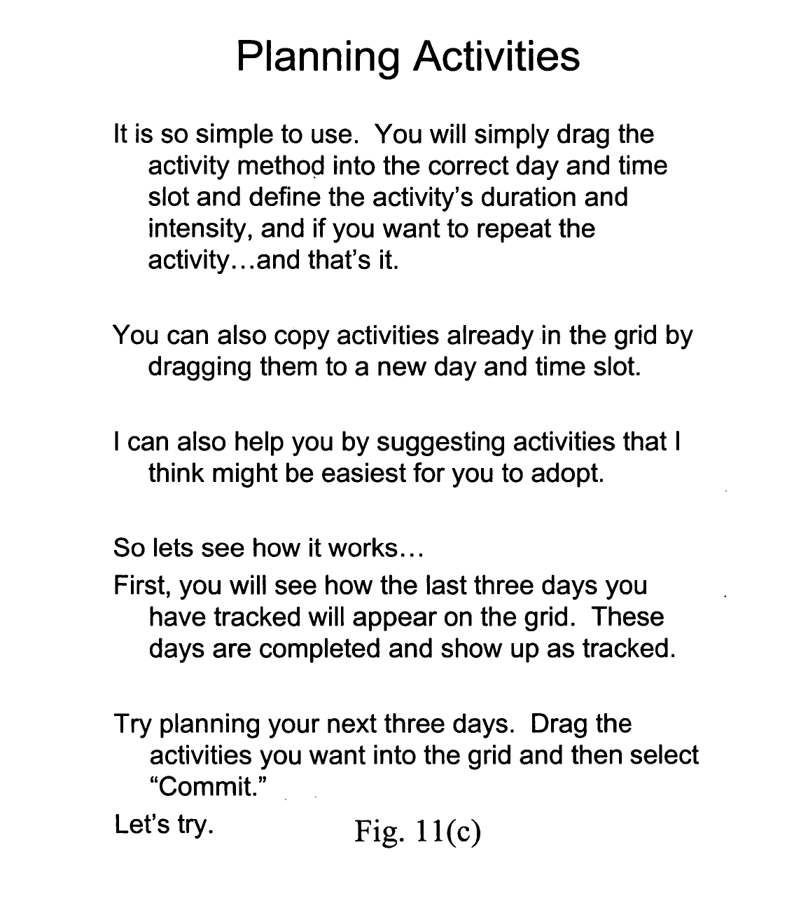

FIG. 11(a) illustrates a sample activity grid according to an embodiment of the invention. The activity grid may include text or a link to help support regarding how to use the activity grid to track or plan activities. Under certain operating conditions, the Lifestyle Coach application software may fill the activity grid with activities that the user has defined as completed in the tracking pages for the previous time period (e.g., three days or one week). The activity grid may also be utilized to show currently planned activities for the current week. The activity grid may also display future planned activities for a week in the future.

Under certain operating conditions, the user may update or correct tracked activities on the activity grid. An activity grid module of the Lifestyle Coach application software may receive the input activities, determine the points associated with the input activities, determine the points corresponding to the input steps, and present this information to the user to illustrate to the user what a completed tracked day or a completed tracked week looks like in the activity grid.

FIG. 11(b) illustrates a content page describing how the activity grid may be utilized by a user. FIG. 11(c) illustrates a content page describing the operation of planning activities on the activity grid. In an embodiment of the invention, the user can drag an activity from the activity method options and drop an activity method into the correct day, time period or time slot, and then define the activity's duration and intensity. The activity grid module may also allow you to identify that activity as something that is to be repeated every day or every number of days. The activity grid module may also allow you to copy activities (and associated information) from the activity grid and drag them to a new day and time slot. The activity grid module may also allow you to move activities from one day to another and even change time slots.

A user profile module of the Lifestyle Coach application software may create user profiles and allow for modification of the user profiles. Initially, the user profile module may present initial intake questions to the user and receive answers from the user. The user profile module may utilize baseline time period maps to create the initial user profile. In the initial user profile, the answers may be utilized by the user profile module to set specific characteristics. Under certain operating conditions, a number of specific characteristics may be set for the user. These characteristics are used to personalize the user's experience with the Lifestyle Coach application software.

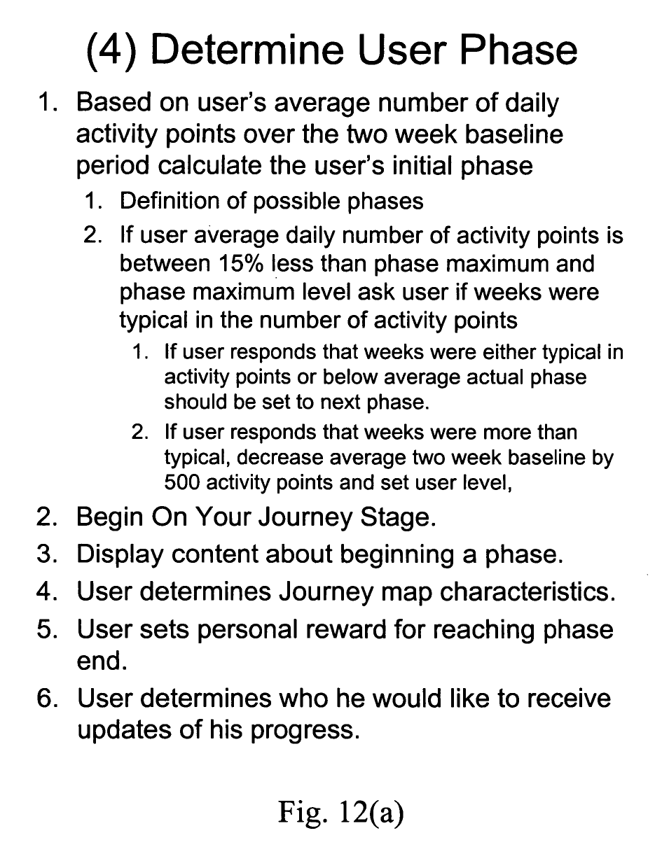

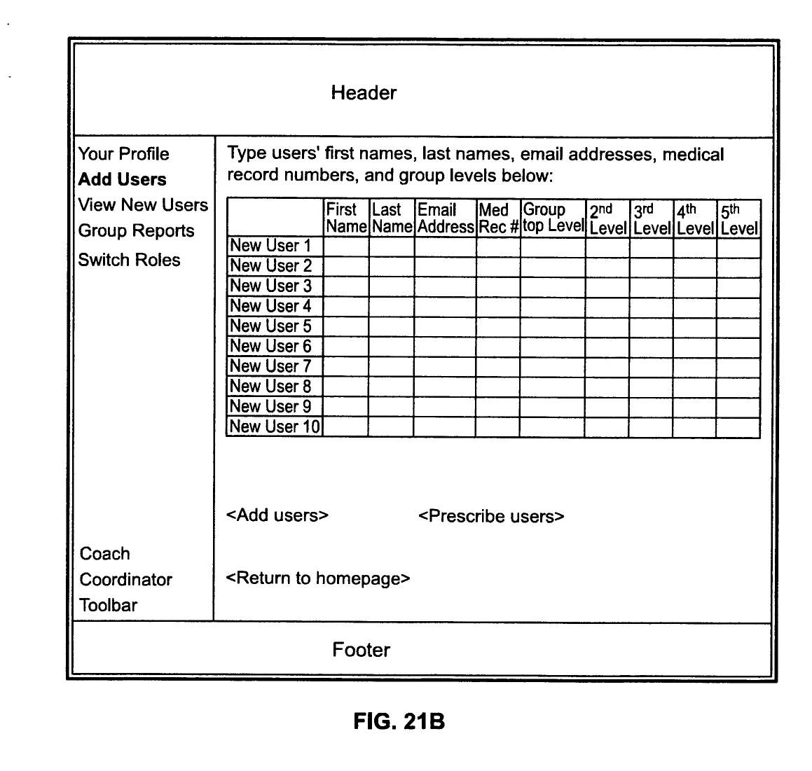

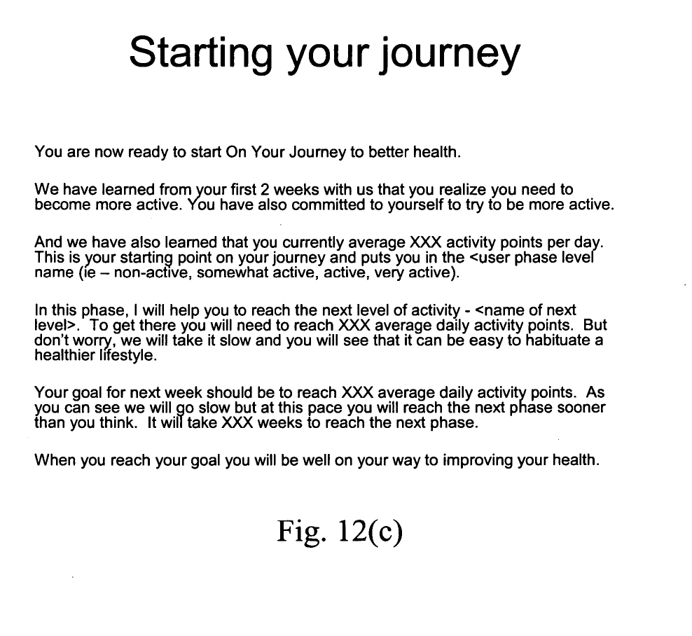

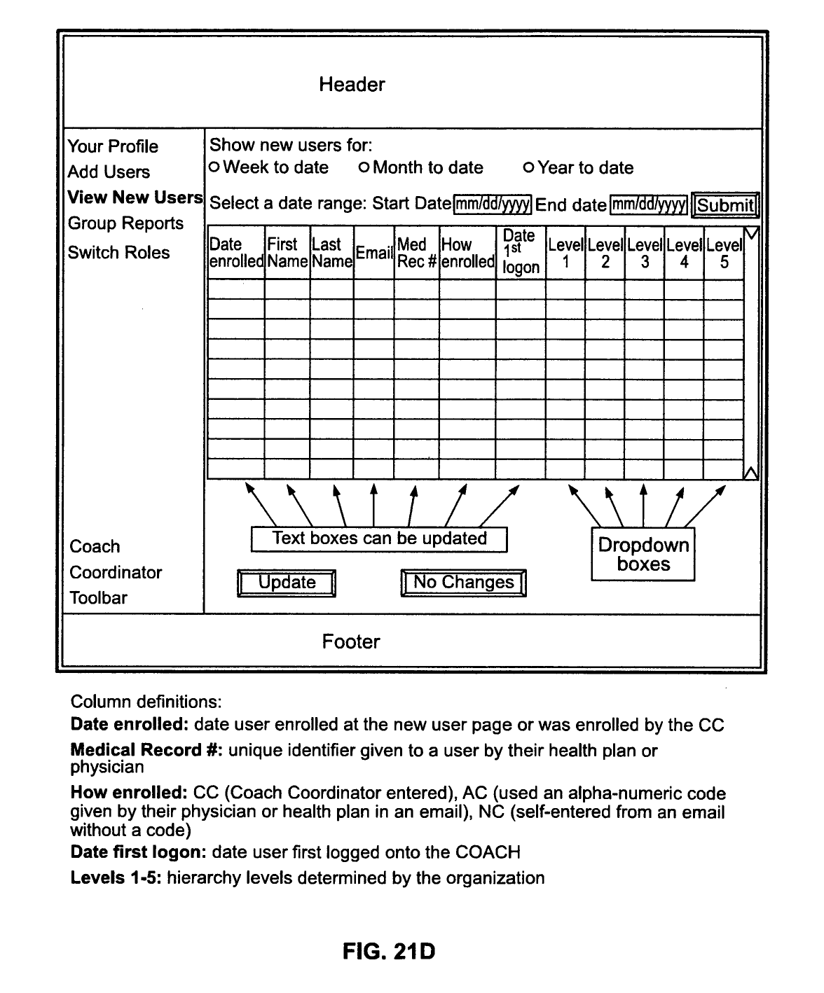

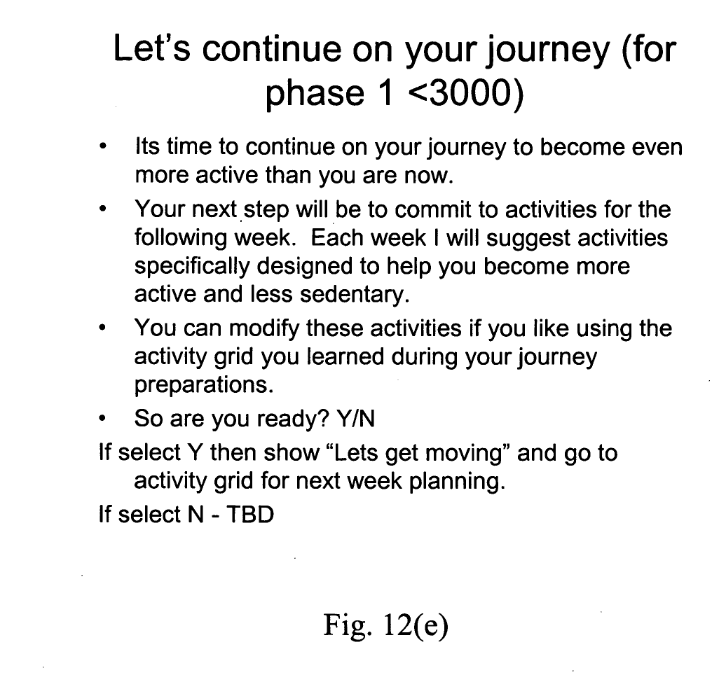

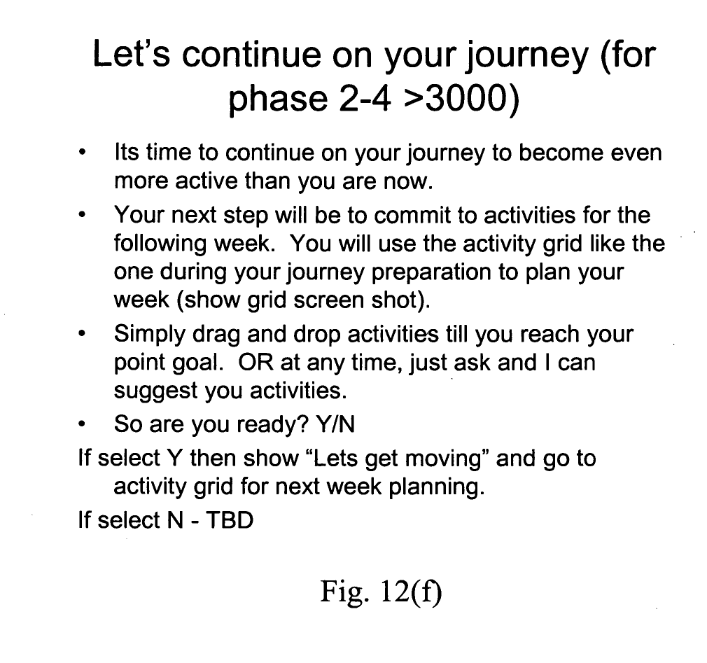

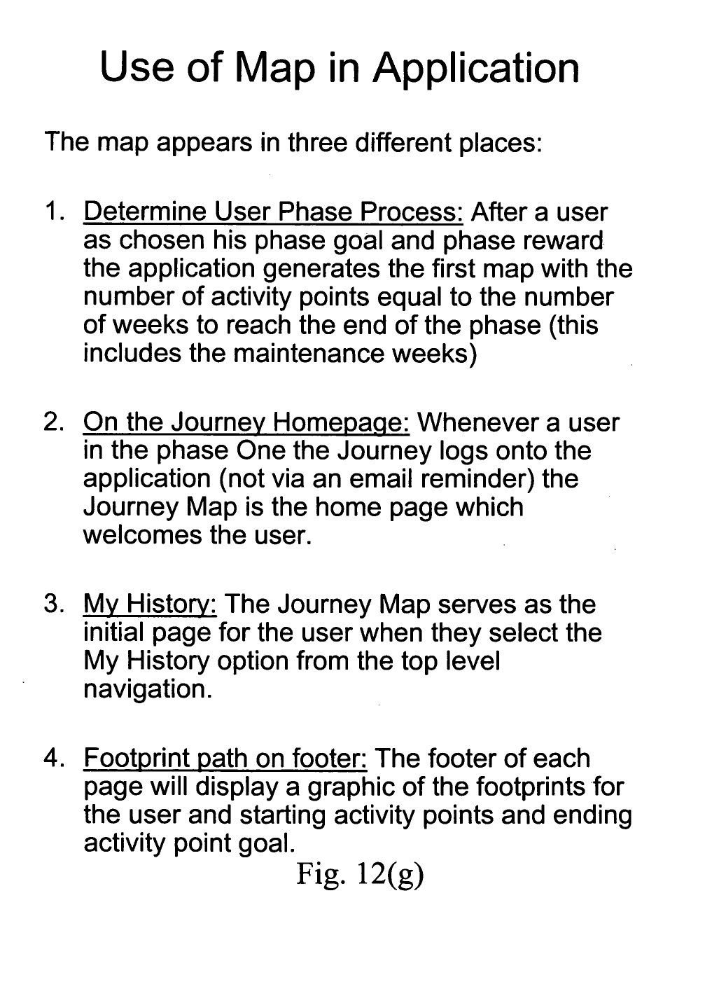

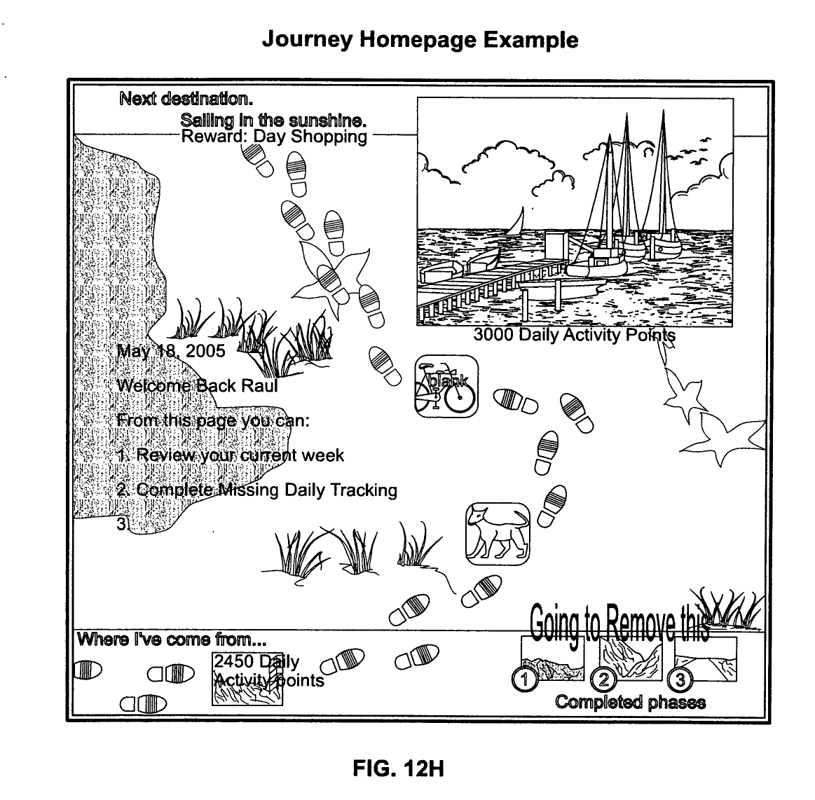

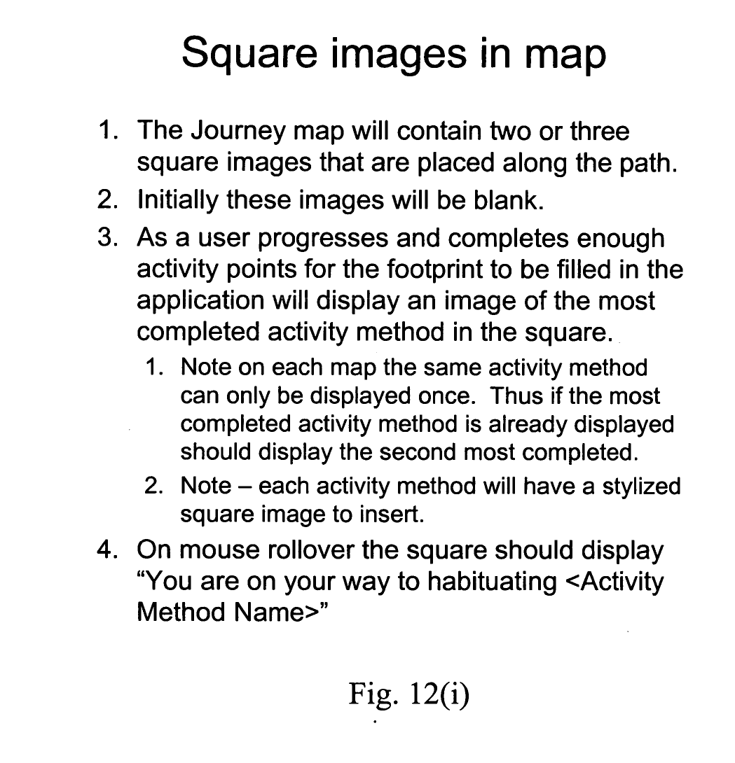

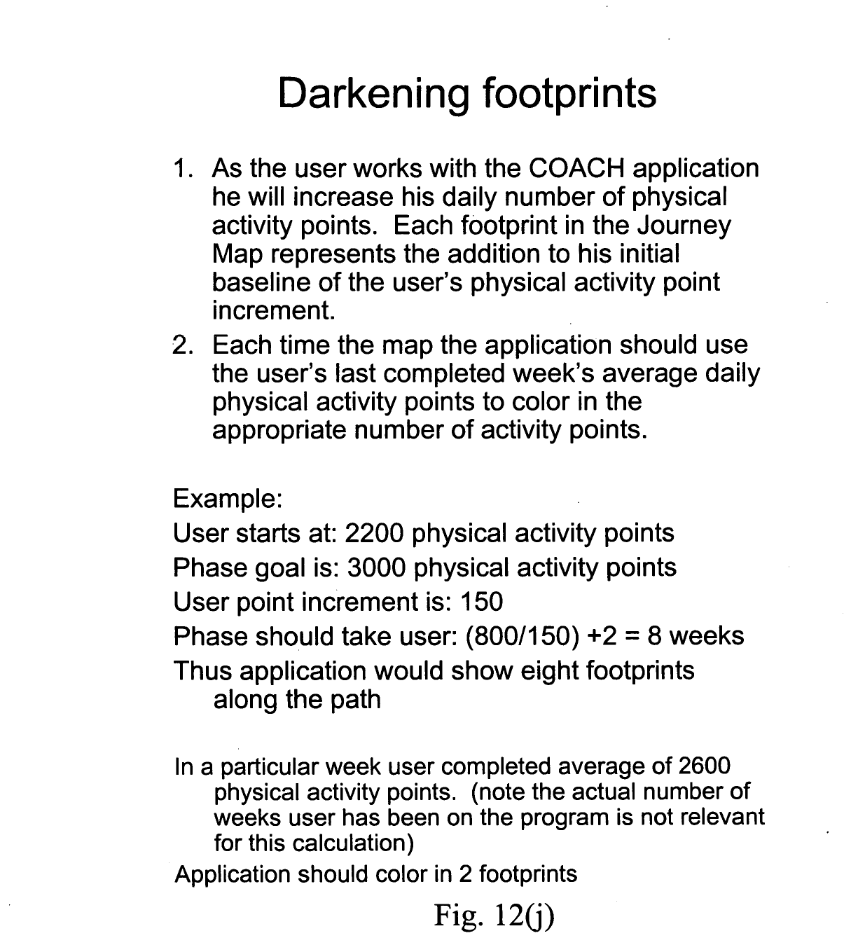

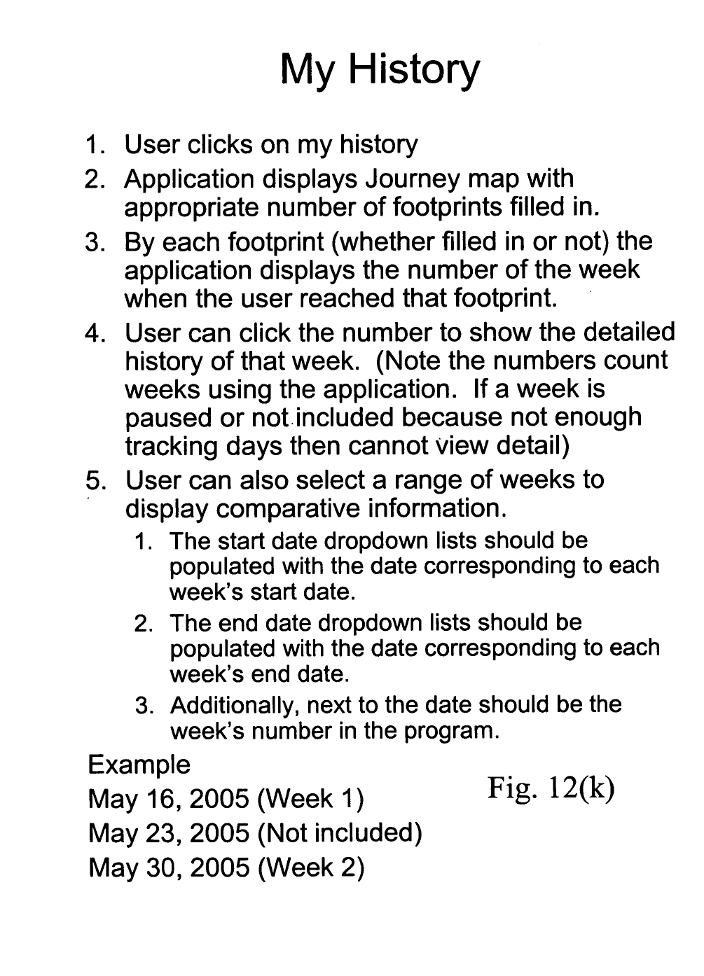

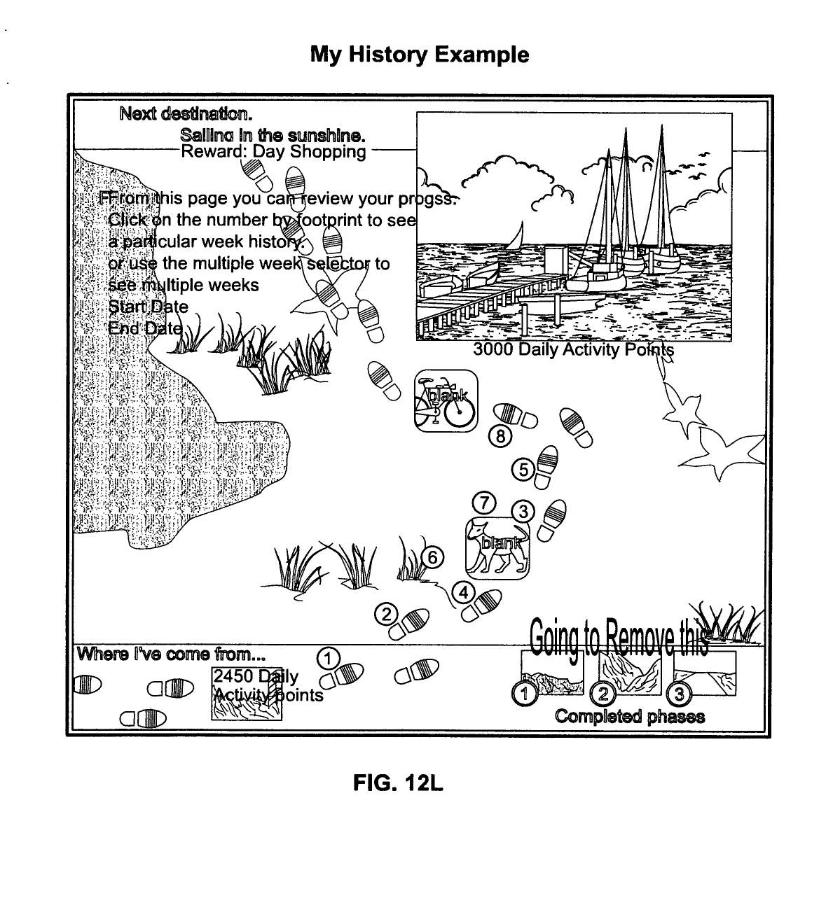

While certain sections of this patent application may highlight physical activity as a behavior that has goals set and is monitored for a user, the discussion above and below applies to all behaviors which are Lifestyle Coach Behavior Modification System may be designed to modify. Illustratively, other behaviors may include planning proper nutrition or healthy eating, quitting smoking, monitoring medical treatment or adherence to medical regimen, monitoring blood glucose, monitoring blood pressure, and monitoring other physiological parameters. tA user phase calculation module in the Lifestyle Coach application software may determine the user's baseline level of the particular behavior. The user phase calculation module may determine the user's initial average performance on the targeted behavior (e.g., the number of daily activity points) over a baseline period. Illustratively if the behavior is physical activity the Lifestyle Coach application software may calculate the user's initial average number of daily activity points over a baseline period. Illustratively, the baseline period may be two weeks. The average number of activity points for the baseline period may determine the user's initial phase. FIG. 12(a) illustrates a content page of the Lifestyle Coach application software describing the operation of the user phase calculation module and additional steps taken by a user in embarking on the Lifestyle Coach journey. The Lifestyle Coach application software may provide the user with a definition of a number of possible phases regarding physical activity that the user may achieve. For example, the number of phases regarding physical activity could be four phases, e.g., non-active, slightly active, more active, and extremely active. With physical activity as an answer, the user phase calculation module, after determining the user's average number of daily activity points, may determine if the average number of activity points is 15% less than the identified phase maximum or 15% greater than the identified phase minimum. If the user phase calculation module determines that the user's points are close to the top or the bottom of the selected phase, the user phase calculation module may ask the user if the activity points achieved in the baseline time period was typical in the number of activity points for the user. Illustratively, if the user inputs that the average activity points for the baseline were typical in activity points or that the average activity points were below average, then the user phase calculation module may be set to the next phase. If the user inputs that the average activity points were more than what is typical for the user, then the user phase calculation module decreases the average activity points for the baseline period and determines the user activity phase based on the newly calculated average activity points. Under certain operating conditions, the user phase calculation module may disregard days in the baseline period marked by the user as not being tracked when calculating the average daily number of activity points. Under certain operating conditions, the user phase calculation module may need at least two weeks of daily activity points in order to calculate the average activity points.

As is illustrated in FIG. 12(a), the user may then enter a journey beginning stage. The Lifestyle Coach application software may display information about beginning the selected or identified phase. The Lifestyle Coach application software may then determine the journey map characteristics based on input from the user. The user may input personal rewards for reaching a phase end. The user may determine who the user would like to receive updates of the user's progress.

FIG. 12(b) illustrates a content page disclosing information regarding the starting of a journey for a user. FIG. 12(c) illustrates a content page for an initial journey starting page of the Lifestyle Coach application software. The Lifestyle Coach application software may present the user with the calculated average activity points and the selected user phase level. The Lifestyle Coach application software may also present the user with the next phase level and how many activity points the user may have to increase in order to reach the next activity level. Under certain operating conditions, the Lifestyle Coach application software may provide an activity point goal for a next time period, e.g., like a week or ten days. The Lifestyle Coach application software may then provide the user with a number of time periods, e.g., weeks, that it may take the user to active the next phase level. The Lifestyle Coach application software may set goals for the user to move weekly from one phase to the another. The Lifestyle Coach application software is configured so that the user has reasonable, but challenging goals, in order to make the next phase of the Lifestyle Coach application software.

FIG. 12(d) illustrates a journey map of the Lifestyle Coach application software according to an embodiment of the invention. The journey map represents a visual exposition of the user's plan and progress for a phase within the Lifestyle Coach application software. The journey map shows the user staring at a particular phase beginning and the path that the user may take to achieve the user's phase goal. FIG. 12(e) illustrates a content page of text displayed for the journey mapping portion of the Lifestyle Coach application software. The journey map is utilized in each phase to present a visual representation of the user's progress through the phase. Illustratively, as the user increases his or her activity points, footprints (or other icons representing movement) may represent that the user is getting closer to the activity level goal. Illustratively, the footprint (or a pair of footprints) may represent one week that the user has reached an activity point level and thus is on his or her way to reach their goal. Under certain operating conditions, the user may select an image which represents the goal of completing a phase. In FIG. 12(d), the user selected the image of a sailing vessel. The journey map module of the Lifestyle Coach application software may include a database of images that the user may select. The user may also import an image onto the user's journey map.

FIG. 12(e) illustrates a content page of the Lifestyle Coach application software which presents information that is displayed to a user that is in the lowest or initial user phase. This content page details what the user should expect and asks if the user is ready to embark on the journey. FIG. 12(f) illustrates a content page of the Lifestyle Coach application software that is displayed to a user who is in any of the other phase levels besides the initial phase level of the Lifestyle Coach system. The content page of FIG. 12(f) identifies that the activity grid may be utilized and may provide a visual representation of how the activity grid is utilized.

FIG. 12(g) describes the location of the when the journey map is presented within the Lifestyle Coach application software. The journey map may be first presented after the user has selected a phase goal and chosen a phase reward. Under certain operating conditions, the Lifestyle Coach application software may generate the first map with a number of activity points which is equal to the number of weeks that it would take the user to reach the end of the selected phase. The Lifestyle Coach application software may also be presented to the user when the user logs into the Lifestyle Coach application software. This may occur when the user is in the phase On the Journey. Under certain operating conditions, the journey map may be displayed in only 65% transparency behind the homepage text and options. FIG. 12(h) illustrates a sample journey homepage according to an embodiment of the invention. The journey map may also be a link for a user when the user selects the My History option from a top level navigation bar in the Lifestyle Coach application software.

FIG. 12(h) describes a process for generating the journey map according to an embodiment of the present invention. After the user has been assigned to a specific phase, the journey map module in the Lifestyle Coach application software may display images that represent phase end for the particular phase. After being presented with the images, the user may select one of the images as the phase goal. During this time period, the user may select a phase completion reward. The journey map module of the Lifestyle Coach application software may pull up a base map for the selected user phase. The Lifestyle Coach application software may include a database housing maps for the different user phases. For example, the database may include four maps or eight maps. The journey map module may determine or calculate the expected number of weeks that it may take a user to complete the selected user phase based on the calculated user phase, the calculated user activity point increment, and the current user baseline. Under certain operating conditions, the calculated or expected number of weeks may include a two week maintenance period, which may be defined as a couple of weeks that the journey map module pads the calculated time with. The maintenance period may also be a time period which the journey map module adds to the calculated number of weeks. This maintenance period is a time period in which the Lifestyle Coach application software requires the user to maintain the average activity level goal for. Illustratively, the maintenance period may be two weeks. After the journey map module calculates the expected number of weeks until completion, the journey map module of the Lifestyle Coach application software displays the created journey map with the user specific phase end image, the selected phase reward, and the activity points goal. Under certain operating conditions, the journey map may have a starting point of the user's average number of daily physical activity points.

Under certain operating conditions, one or more squares along the journey path may be blank. Once the user completes an activity, an image of the activity may be placed in the square to signify completion of the activity. FIG. 12(i) illustrates a content page describing the utilization of images in journey square according to an embodiment of the invention. Under certain operating conditions, the journey map may include two or three journey squares that are placed along the path of the journey map. Initially, the journey squares may be blank. Under certain operating conditions, if the user is progressing through the journey and completes above a threshold activity points level, an image of the most recently completed activity method may be displayed at the next journey square. If there are a number of journey squares, there may be a number of threshold activity point levels at which an image is to be displayed. Each activity or activity method in the Lifestyle Coach application software may include a stylized square image to insert. Alternatively, in an embodiment of the invention, as each activity is being completed, an image of the activity method may be displayed in one of the journey squares. Using this alternative, the image placed in this journey square may be the image of the activity method last completed after the threshold activity point level was reached. Under certain operating conditions, the image of an activity method may only be used once in each journey map, so once a user reaches a second threshold in activity points and if the activity being performed is the same activity whose image is displayed in the first journey square, the image of the second most completed activity may be displayed. Another feature of the Lifestyle Coach application software is that on mouse rollover of the journey square and if an image is being displayed in the square, a text message may be displayed identifying that the activity has been completed and that the user is progressing to completing the activity phase.

FIG. 12(j) illustrates a content page explaining darkening of footprints on a journey map in the Lifestyle Coach application software according to an embodiment of the invention. The content page notes that as a user works with the Lifestyle Coach application software, the user may increase his or her daily activity points. The footprint on the journey map may represent the addition to the initial baseline of the user's physical activity point increment. Under certain operating conditions, the journey map module of the Lifestyle Coach application software should use the user's last completed average daily physical activity points to color in the appropriate number of activity points on the journey map. For example, using physical activity as an example, a user may start at 2200 average physical activity points for a time period (e.g., a week). The phase goal for the user's selected phase may be 3000 physical activity pints. The increment in increasing average activity points that the Lifestyle Coach application software has assigned the user is 150 points per time period. In order to advance through the selected phase, the Lifestyle Coach application software has calculated that the selected phase should take the user is 6 weeks (800/150) or if a maintenance period is included 8 weeks (800/150+2). Based on this information, the journey map module may display either six footprints or eight footprints on the path in the user's journey map. Under certain operating conditions, a user may complete an average of 2600 physical activity points. Because the physical activity points are 400 above the last average activity points (2200), the journey map module of the Lifestyle Coach application software may color (or darken in two footprints).

FIG. 12(k) illustrates operation of a history module of the Lifestyle Coach application software according to an embodiment of the present invention. Under certain operating conditions, a user may select a history option (e.g., named my history). The journey module of the Lifestyle Coach application software may display the journey map with an appropriate number of footprints filled in or blackened. Under certain operating conditions, the journey map module may display the number of the time period, e.g., week, when the user reached or achieved that footprint. Under certain operating conditions, the user may select the display of the number to show a detailed history of the time period (e.g., week or 10 days). Under certain operating conditions, the user may also select a range of time periods to display comparative information. Illustratively, a start date dropdown list may be presented to list all of the available weeks that can be displayed. An end date dropdown list may be presented to list all of the end dates of the time periods stored in the journey map module of the Lifestyle Coach application software. Under some operating conditions, the time period's number in the program may be presented to the user. FIG. 12(l) is an illustrative my history page of the Lifestyle Coach application software.

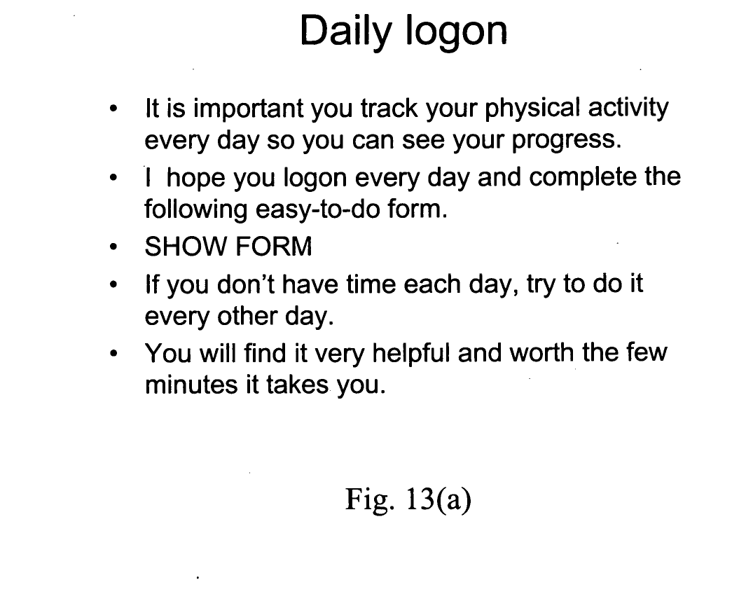

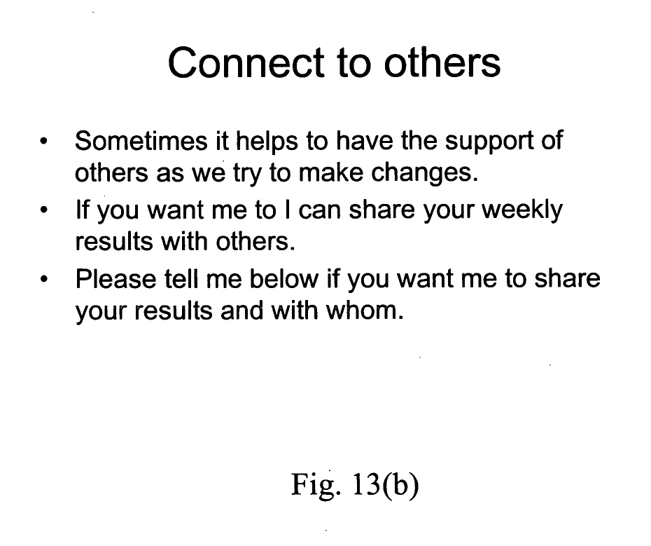

FIG. 13(a) illustrates a content page highlighting the daily logon activities for the activity tracking of the Lifestyle Coach application software according to an embodiment of the invention. FIG. 13(b) illustrates a content page highlighting the benefits of connecting to others during your Lifestyle Coach journey. Illustratively, during an initial phase content review, the user can define a number of individuals who are to receive weekly email updates from the Lifestyle Coach application software. The email may be sent to the identified user after the weekly or time period review session. In an embodiment of the invention, the user can also input a number of users who may be invited to participated in utilizing the Lifestyle coach application software.

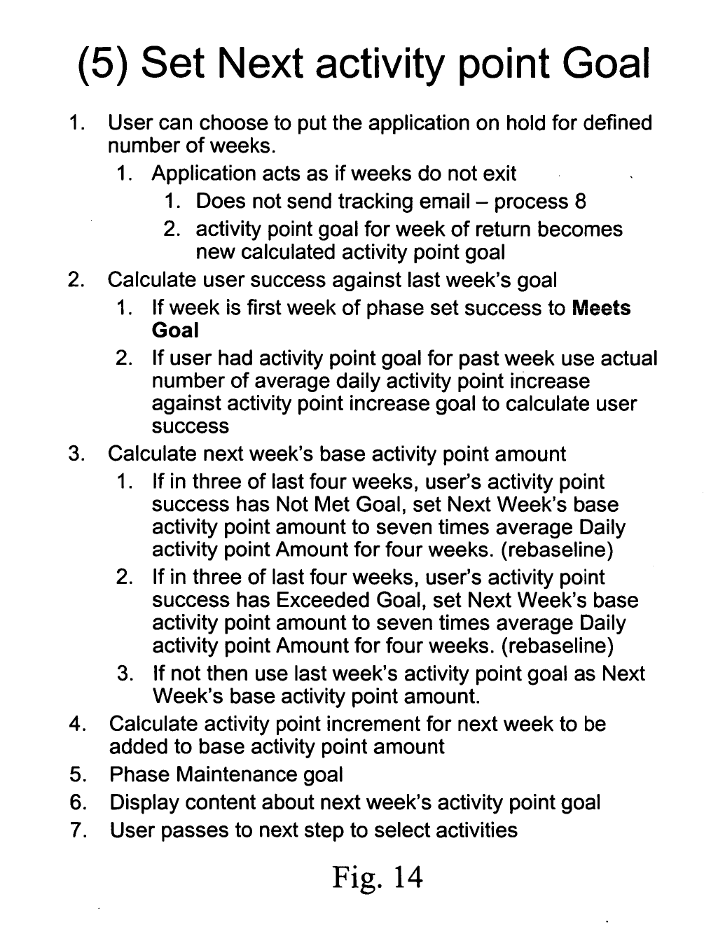

FIG. 14 illustrates how, using physical activity as an example behavior, a user can select a next activity point goal according to an embodiment of the present invention. Under certain operating conditions, the user may choose to place the Lifestyle Coach application software on hold for a defined number of weeks. If the user places the Lifestyle Coach application on hold, the different modules of the Lifestyle Coach application software may act as if the week does not exist. For example, the Lifestyle application software may not send a tracking email to people the users have selected. The activity point goal for the week that the user returns to the program may become the new calculated activity point goal. In addition, the Lifestyle application software may send out messages or transmit an email to people that the user has defined as potential new users of the Lifestyle application software indicating that the user has been successful in utilizing to the Lifestyle Coach application software to achieve his or her goals. In an embodiment of the invention, the message or email may be sent out to other potential users as defined by the Lifestyle Coach application software.

The Lifestyle Coach application software may calculate the user's success against the last time period's (week's) goal. Illustratively, if the time period is the first time period, e.g., the first week, the Lifestyle Coach application software may set that the user has met the goal. If the time period is not the first time period, then if the user had activity point goal for the past week, then the Lifestyle Coach application software may use the actual increase number of average daily activity point and compare this to the activity point increase goal to calculate whether the user's success. The Lifestyle Coach application software may calculate the next week's base activity point amount. The activity goal calculation module may calculate the next week's goal based on a number of factors. Illustratively, if in three of the last four weeks, the user's did not achieve the activity point goal, then the activity goal calculation module may set the next time period's base activity point amount to a multiple of the average daily activity point amount, where the average daily activity point amount was calculated for a selected number of time periods. For example, the activity goal calculation module may set the next time period's base activity point amount to seven times the average daily point amount for four weeks. This may be referred to as re-baselining the user's activity point levels.

Under other operating conditions with physical activity as the tracked behavior, if in three of the last four weeks, the user's activity point total has exceeded the activity point goal, the next time period's goal may be set to a selected number of the average daily activity point amount for a previous time period. The selected number may be seven and the number of previous time periods may be four weeks. Illustratively, if the above conditions are not met, then the activity goal calculation module may be use the last time period's activity point goal as the next time period's base activity point amount. After this, the activity goal calculation module may calculate the activity point increment for the next time period that is to be added to the base activity point amount.

Next, the user and the Lifestyle Coach application software may implement a phase maintenance goal. The Lifestyle Coach application software may display text content or information about the next time period's activity point goal. The Lifestyle Coach application software may then move to the next step of selecting activities.

In an embodiment of the invention where the time period is a week and activity points are calculated or input daily, the activity goal calculation module may calculate the weekly expected activity point increment as the current week's goal minus the past week's goal. The activity goal calculation module may calculate the actual weekly activity point increase as the current week's actual activity point level minus the last week's activity point goal. The activity goal calculation module may calculate the week's success percentage as the percentage of the expected activity point increment reached by the actual activity point increase of the user. The activity point calculation module may have certain actions based on the success percentage. For example, if the success percentage is less than 50%, then the user does not meet the goal. If the success percentage is between 50% -150%, then the user meets the goal. If the success percentage is above 150%, then the user exceeds the goal. If the next week's base activity point goal exceeds the daily activity points to complete the selected user phase, then the activity goal calculation module may set next week's activity point increment to zero. If the next week's base activity point goal does not exceed the daily activity point goal, then the activity goal calculation module may adjust the typical phase activity point goal for the past week's success according to the following percentages. In other words, the activity goal calculation module may multiply the activity point goal by a percentage amount. Illustratively, if the past week's success 1) does not meet the activity point goal, then the activity point increment percent adjustment may be 0%; 2) meets goal, then the activity point increment percent adjustment may be 100%; and 3) exceeds goal, then the activity point increment percent adjustment may be 150%. Under certain operating conditions, the activity goal calculation module may adjust the activity point goal by the user's readiness to change index. Under certain operating conditions, the activity point goal may be incremented by 50 points.

The Lifestyle Coach application software may also include a phase maintenance module. Under certain operating conditions, the phase maintenance module may be entered into after the user has completed a phase and decide not to move to the next phase or if the user has reached a last defined phase. The user activity point goal may remain the same as from the previous time period, e.g. week, if the user in the phase maintenance module. The phase maintenance module may also allow the user to not track activities for the current time period. Therefore, in the phase maintenance phase, the tracking email generated by the Lifestyle Coach application software may not contain activities or a listing of activities. Alternatively, the phase maintenance module may allow the user to track activities during the maintenance phase. The user may also have the option of selecting new activities to replace the current activities that were tracked in the last time period or that the user had previously input as planned activities for the current time period. Under certain operating conditions, the phase maintenance module may poll the user to determine if the user wants to progress to the next phase or if the user wants to return to the phase maintenance phase. If the user selects yes, e.g., moving to the next phase, the user may link to moving to the next phase.

A select activity module may also be included in the Lifestyle Coach application software. The select activity module may be utilized in developing a completed user activity grid. As discussed above, the activity grid may list the activities that the user completed last week, that the user is performing this week, and also that the user is planning for next week. The user may review the activity grid of the prior time period's activities. In operating conditions where the user is just starting or is in phase 1, the select activity module of the Lifestyle Coach application software may automatically fill in the suggested activities. The select activity module may also display the current activities for the current time period. The select activity module may also provide the user with the option of deleting the current activities. In addition, the select activity module may allow the user to modify current activities. Further, the select activity module may allow the user to add new activities. In embodiments of the invention, the select activity module may present the user with an option to allow the select activity module of the Lifestyle Coach application software to suggest an activity or a number of activities for the user. In other embodiments of the invention, the select activity module may present the user with the option to allow the select activity module to suggest a complete activity plan for the user. Under certain operating conditions, the select activity module may include point information for each of the activities and this may be displayed on the activity grid.

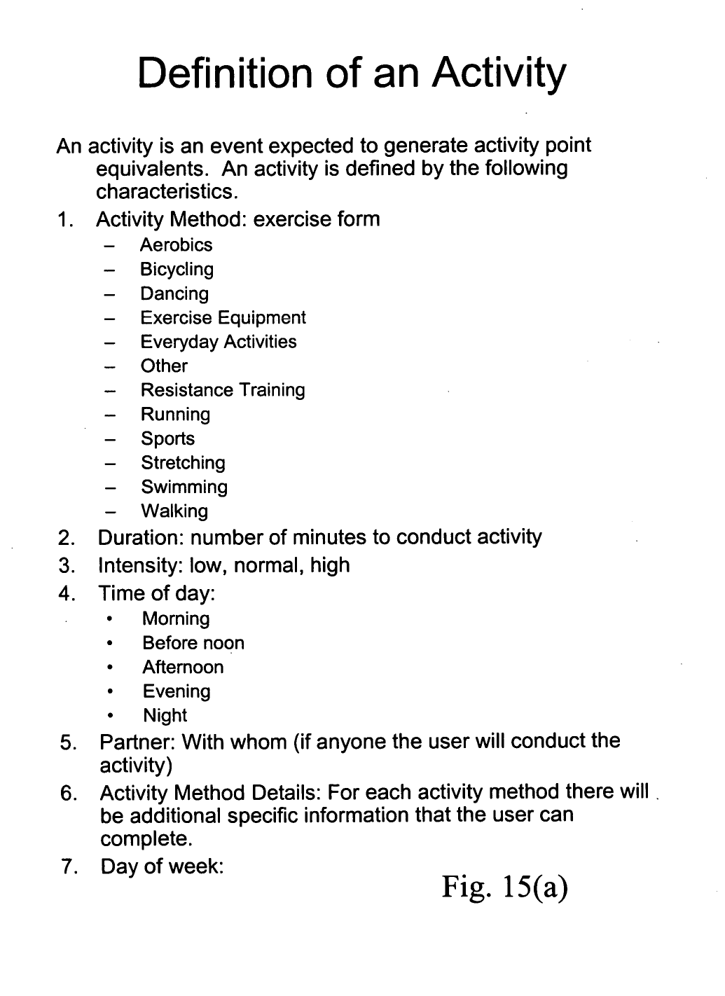

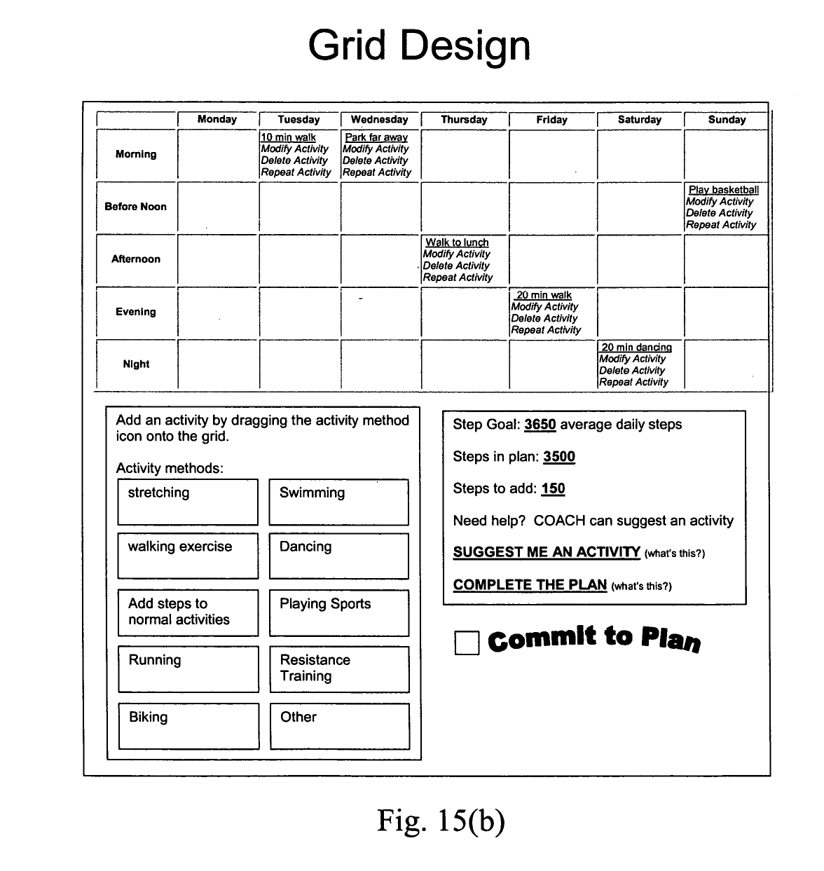

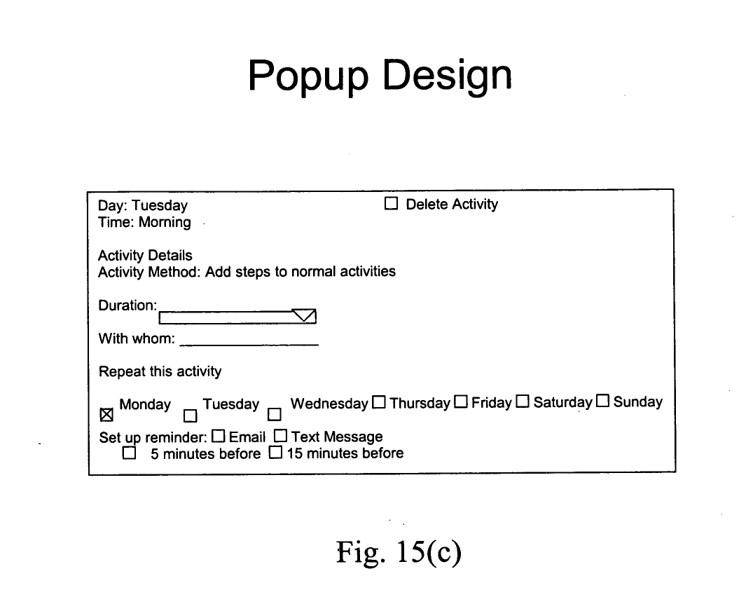

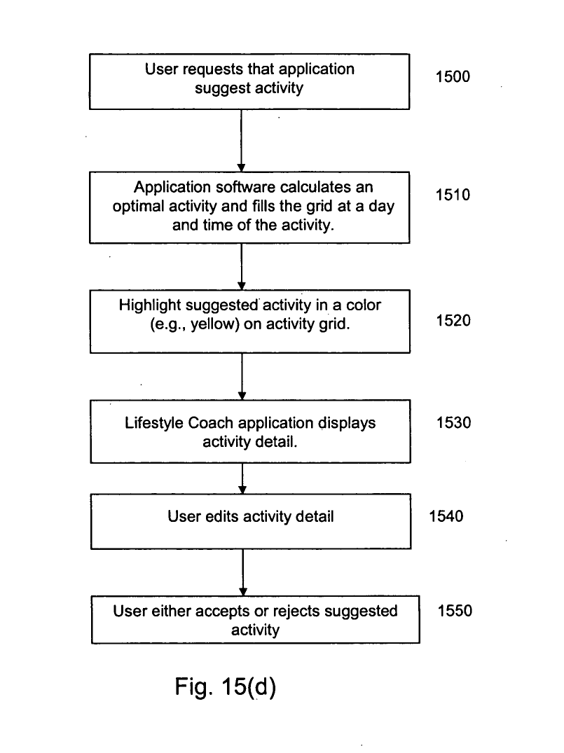

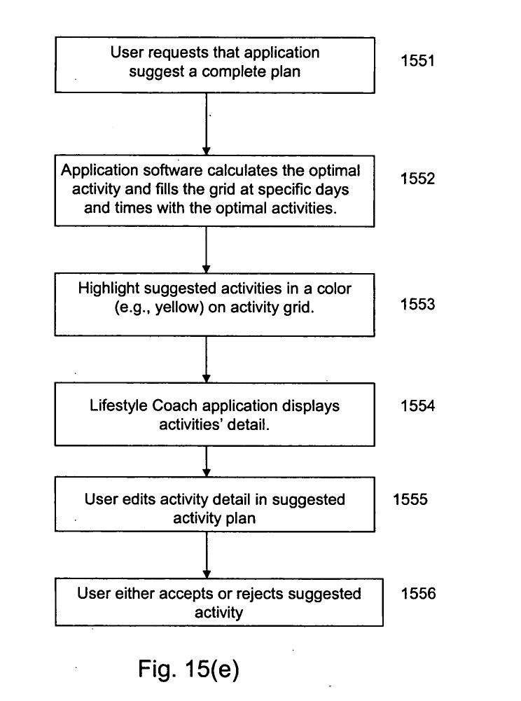

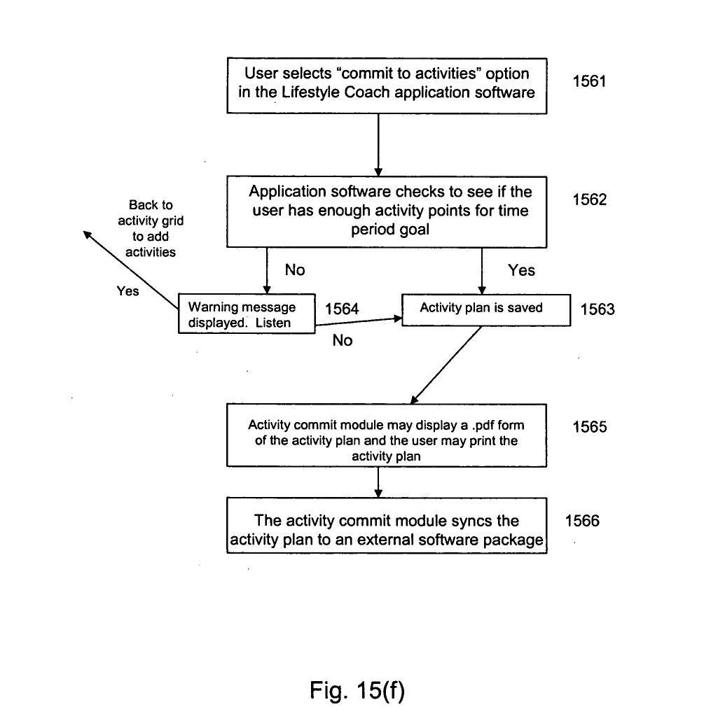

FIG. 15(a) illustrates a content page of the activity selection module which identifies activities along with classification of activities which may be selected in the Lifestyle Coach application software. Illustratively, if physical activity is the behavior to be modified and tracked, an activity may be defined as an event that is expected to generate activity points or activity point equivalents. An activity is defined as an activity method, a duration, an intensity, and a time of the day that the activity occurs. The activity selection module may also request information as to whether the activity was conducted with a partner or other individual (such as a teacher). The activity selection module may also request activity method details and/or the day the activity was completed. An activity method may be exercises such as aerobics, bicycling, dancing, utilizing exercise equipment, resistance training, running, sports, stretching, swimming, walking, or other similar activities. The duration of the activity may be the number of minutes required to complete an activity (or other time measurements). The intensity of the activity may be divided into a number of categories. For example, there may be three intensity categories, e.g., low, normal, or high. The time of the day may be divided into different timeframes, such as morning, before noon, afternoon, evening, and night. Based on the input information regarding activity method, intensity, and duration, the activity selection module may calculate the expected activity point (or an activity point equivalent) for completing the activity. In some embodiments of the invention, the activity selection module may allow the user to select the activity for multiple days. If the user decides to delete the activity, the activity selection module may allow the user to delete the activity for a number of days in the time period or for only a single day of the time period. Each activity may have a HTML file or linked HTML files. The HTML file for the activity may detail how to conduct the activity. Under certain operating conditions, the activity creating module may reference the HTML file for the activity method. Under other embodiments of the invention, the Lifestyle Coach application software may have a HTML file or HTML file for each time period, e.g., week, that displays activities. The Lifestyle Coach application software may display the file for each particular week and plan.

FIG. 15(b) illustrates a screen shot of an activity grid according to an embodiment of the present invention. In the activity grid illustrated in FIG. 15(b), the days of the weeks are column headings, and the times of the day are row headings. The activity grid also includes a step presentation section and an activity addition section. The activity grid illustrated in FIG. 15(b) may also include a link for suggesting an activity. The activity grid may also provide a link to complete the activity plan. The activity grid may include a link to a button which allows the user to commit to the activity plan. If an activity has been selected for a certain day and time of the day, then the activity selection module displays the activity in the corresponding row and column of the activity grid, as illustrated in FIG. 15(b). Under certain operating conditions, the activity is listed (and also the duration of the activity) and the activity selection module also presents the user with the option to modify the activity, delete the activity, or to repeat the activity. Illustratively, the behavior grid may allow a user to plan diet and nutrition actions into a grid with day and time slots.

Under certain operating conditions, the activity grid may highlight activities that were completed by the user in one color, e.g., green. The activity grid may highlight activities that were not completed by the user but were planned or committed to by the user in a second color, e.g., red. Under certain operating conditions, the user may select an activity in the grid, and the activity selection module may generate a pop-up that provides the user with the activity method, the duration of the activity, the activity intensity, the activity detail selection, and whether or not to repeat the activity. FIG. 15(c) illustrates a pop-up menu for the activity selection module according to an embodiment of the present invention.

The activity selection module includes functionality for deleting current activities from the activity grid. Under certain operating conditions, the activity grid may include a selection button to allow the user to delete the current activity. Under other operating conditions, the user may drag an activity to a trash can icon that is also on the activity grid. If the activity to be deleted is repeated during the week, the activity selection module may ask the user if the user wants to delete all instances of the activity during the time period displayed on the activity grid. After the activity has been deleted from the activity grid, the activity selection module informs the Lifestyle Coach application software and updates the activity point total (which is calculated by the activity point calculation module).

The activity selection module includes functionality for modifying certain activities in the activity grid. Under certain operating conditions, the user may click on the short description of the activity in order to modify the activity. Under other operating conditions, the user may select the modify option listed with the activity on the activity grid. The activity selection module may display activity detail in a popup in response to the modify activity functionality. If the modify activity option is selected, the user may not edit the activity method itself. In other words, the user cannot change the activity from swimming to running if the user is modifying the activity. The activity selection module may allow the user to select a different duration for the modified activity. For example, the activity selection module may display a drop down list allowing the user to select from one of the following duration options, 2 minutes, 5 minutes, 10 minutes, 15 minutes, 20 minutes, or 30 minutes. Under certain operating conditions, the activity selection module may also display the average activity points earned in each of the duration periods. The activity selection module may also allow the user to edit the intensity of the workout. Under certain operating conditions, the phase the user is in may limit whether the intensity of the activity may be modified. For example, in the first and second user phases, the activity selection module may not allow the user to edit the intensity of the activity. The activity selection module may also allow the user to edit the activity detail and/or whether or not the activity was performed with a partner. In the modify activity section of the activity selection module, the user may also be able to select if he or she would like to repeat the activity on other days within the time period displayed in the activity grid. In the modify activity section of the activity selection module, the user may also be able to delete the activity (which would result in the activity being removed from the activity grid). The activity selection module may also allow the user to set up a reminder to alert the user that an activity has been planned. The activity selection module may initiate that a message is sent via email (or text message). Illustratively, the message may be sent either 5 or 15 minutes before the start of the time period when the activity is planned or scheduled.

After each activity is modified, the activity selection module may send the modified activity information to the activity point calculation module which updates the user activity point total. Under other operating conditions, the activity selection module may wait until a number of activities have been modified before sending the plurality of modified activity point information to the activity point calculation module in order to update the user's activity point total.

The activity selection module may also allow the user to add new activities to the activity grid. The user may select an activity in the activity selection section of the activity grid and the activity detail popup may be displayed to the user so that the user may enter the information for the activity. Under other operating conditions, the user may select an activity from the activity selection section to a row and column of the activity grid. Under these operating conditions, the activity selection module may fill in the date and timeframe for the activity in the activity detail popup. The user may fill in the remaining parts of the activity detail popup, e.g., intensity, description, and save the new activity. The activity selection module may display a short description of the new activity on the activity grid. The activity selection module may also transmit the new activity information to the activity point calculation module to update the user activity point total.

The Lifestyle Coach application software also includes a suggest activity module to suggest activities for users enrolled in the Lifestyle Coach program. FIG. 15(d) illustrates a flowchart of the operation of the suggest activity module. Users in certain phases may have activities suggested to them in order to start the Lifestyle Coach journey in a way that is not too difficult. For example, users in phase 1 may have a number of activities automatically suggested to them. In other phases, the user may have to select the suggest activity link or button on the activity grid in order to receive a suggestion from the activity suggestion module. In an embodiment of the invention, the user may select 1500 to have the Lifestyle Coach application software suggest an activity. The activity suggestion module may calculate 1510 an optimal activity for the user and may fill in the activity grid at a day and time for the activity. Under certain operating conditions, the activity suggestion module may highlight 1520 the suggested activity in a first color, e.g., yellow. The activity selection module may display 1530 the activity detail in a popup. For suggested activities, the activity selection module may automatically calculate the activity detail. The activity selection module may allow the user to edit 1540 the activity detail in the suggested activity. The activity selection module may allow the user to either accept 1550 the suggested activity or the rejected activity.

The activity suggestion module may included logic to determine the activity to suggest. In an embodiment of the invention, the activity suggestion module may automatically execute after the Lifestyle Coach application software displays the activity point goal to the user. After the activity suggestion module automatically runs, an activity grid may be created which has all of the user's activities for a week. This may occur when the user is in the lowest phase (e.g., a non-active phase or a phase with an average activity level of 3,000 activity points). In this embodiment of the invention, the activity suggestion module may display a pop-up screen detailing the activities have been added to the user's plan and any additional information for the users. The activity suggestion module may display the added activities one at a time and the user may be allowed to modify/add/or delete the suggested activity. Under other operating conditions, the user may select activities from the activity grid to modify or delete. After the user has reviewed the activity grid generated automatically by the activity suggestion module, (and made his or her edits, adds, or deletes), the user may accept the weekly activity plan by clicking on the accept (commit to) plan indicator displayed on the screen.

In other phases of the Lifestyle Coach application software, the activity suggestion module may be utilized to suggest a single activity. Also, under certain operating conditions, the user may select an option which causes the activity suggestion module to complete activities for the remainder of a time period. For example, if a user has input 15 activities which result in 3,500 activity points and the user's goal is 5,000 activity points for the week, the activity suggestion module may fill in activities in open spaces in the activity grid to help the user meet the average activity goal of 5,000 points. Illustratively, the activities that may be added to the activity grid may be classified as one of four types: 1) activities to always add—these activities may be added to a user's activity grid irrespective of personal characteristics or other activities within the grid; 2) activities to add which are dependent on other activities—these activities may be added depending on what the user has already input into the activity grid; 3) activities to add depending on personal characteristics—these activities may only be added if the match characteristics that are already defined; and 4) activities that depend on the activities in the grid and the user characteristics.

The Lifestyle Coach application server may include a table, which may be named an activity table. The activity suggestion module may consult the activity table to add to the user's activity plan and increase the user's activity point goal. Under certain operating conditions, the activity suggestion module of the Lifestyle coach application software may add activities that depend on other activities in the activity plan. After the activity suggestion module has added the activities that depend on other activities, the activity suggestion module may check to see if the more activities are needed to reach the user's activity point goal. If more activity points are needed, the activity suggestion module adds activities that depend on other activities in the grid and user's characteristics (called activities/characteristics) to the user's activity grid. After these activities/characteristics have been added, the activity suggestion module determines if more points are needed to reach the activity point goal. If more activity points are needed to reach the activity point goal, the activity suggestion module may add activities that depend on personal characteristics (named characteristics) to the user's activity grid. If more activity points are needed to reach the activity point goal, then the activity suggestion module may add the always add activities to the user's activity grid.

In any of the cases listed above, the activity suggestion module checks to see if the suggested activity is already in the user's activity grid for the time period. Under certain operating conditions, the activity suggestion module may check to see if the activity is in the user's activity grid the required number of times. If the suggested activity is not in the activity grid the suggested number of times, the activity suggestion module may be added up to the required number of times. Under operating conditions where the suggested activity is in the activity plan the specified number of times, the activity suggestion module may replace the existing activity in the user's activity grid with the new suggested activity, as was stored in the table. Fore example, the suggested activity stored in the table may have a longer duration and/or a higher intensity as compared to the replaced activity. If the suggested activity is not in the activity plan (or in some cases, the activity is not in the activity plan a sufficient number of times), the activity suggestion module may add the activities to the activity plan. Under certain operating conditions, the table may also include a number of times that the activity should be added. Under certain operating conditions, if there is not a sufficient number of times that the activity was in the current activity plan, the activity suggestion module may add the activity to replace the previous times and up to the number of required times, as outlined in the activity table. Under certain operating conditions, an intensity for the activity and/or a number of times may be stored in the activity table. In the activity table, the user may also specify characteristics for the activity.

In an embodiment of the invention, the activity suggestion module may also select a single activity if a user selects this option. Under certain operating conditions, the user selects an option from the activity grid page. Under other operating conditions, the activity suggestion module consults the activity table to add certain activities. Illustrative criteria that the activity suggestion module may utilize are point range, the matching of user characteristics, and also the activity classifications that were described above. The activity suggestion module may identify activities whose point range would move the user up to the user's weekly activity point goal. Under certain operating conditions, the activity suggestion module may not suggest activities that have already been suggested to the user in the last four weeks unless there are no other activities that match the point ranged defined. In an embodiment of the invention, the activity suggestion module may first search for activities that match activities in the user's previous activity grids and also match the characteristics the user has input into the Lifestyle Coach application software. The activity suggestion module may then search for activities that match activities that the user already has in the activity grid. As noted above, for the activities in the grid, the activities should have at least the frequency that the activity has identified in the activity table. Note that these activities/characteristic activities and the activities/activities may not have options to add in the case that the user does not match any of the activities. The activity suggestion module may search to add activities that math the user characteristics. Finally, the activity suggestion module may add activities that are always add activities.

FIG. 15(e) illustrates operation of the activity suggestion module when the user selects a complete plan according to an embodiment of the present invention. Under certain operating conditions, the user may request 1551 that the Lifestyle Coach application software suggest a complete plan to increased the user's expected activity point count from the level of the current plan to the expected activity point level. The activity suggestion module may calculate 1552 the optimal activities to suggest and fills the activity grid at specific days and times with this generated list of optimal activities. The activity suggestion module may display 1553 the newly added suggested activities in a color, such as yellow. Under certain operating conditions, the activity suggestion module may display 1554 an activity detail screen (or popup) for each of the suggested activities. For activities that are repeated, the activity suggestion module may only display one activity detail screen and the activity detail screen may include repeat details. The activity suggestion module may edit 1555 the newly suggested activities in the activity grid. After editing of the activity details for the suggested activities, the user may select 1556 the accept option or the reject option for each of the activities. Under certain operating conditions, the activity suggestion module may allow the user to accept all of the suggested activities.

As discussed above, after any change (i.e., deleted, modified, or new activity), the activity point calculation module may recalculate and update the current activity points for the user. The activity point calculation module may also keep a running total of activity points required to meet the expected weekly activity points and display these results as the pending activity points to add to meet either the time period (weekly goal) and potentially the phase goal. In an embodiment of the invention, the current activity points and the remaining activity points to goal may be displayed on the activity grid. The current activity points and the remaining activity points to goal may be displayed on other screens of the Lifestyle Coach application software, such as the journey map screen.

FIG. 15(f) illustrates operation of the activity commit module according to an embodiment of the present invention. Illustratively, the user may select 1561 the commit to activities action off of the activity grid (illustrated in FIG. 15(b)). The activity commit module may check 1562 to see if the activity plan outlined in the activity grid results in the desired number of activity points for the time period. If the activity plan has enough activity points, the activity commit module saves 1563 the activity plan in the Lifestyle Coach application software. If the activity plan does not have enough activity points, the activity commit module displays 1564 a warning message to the user. In response, the user can save the activity plan. Alternatively, the user may return to the activity grid and continue adding activities to the user's activity grid. After the user's activity grid has been saved, the activity commit module displays 1565 a .pdf form of the time period plan (e.g., weekly plan) in a popup window. The user may print the .pdf form of the time period activity plan. The user may synchronize 1566 the activity plan with an external application software package, such as Outlook, Palm Pilot, Lotus Notes, etc.

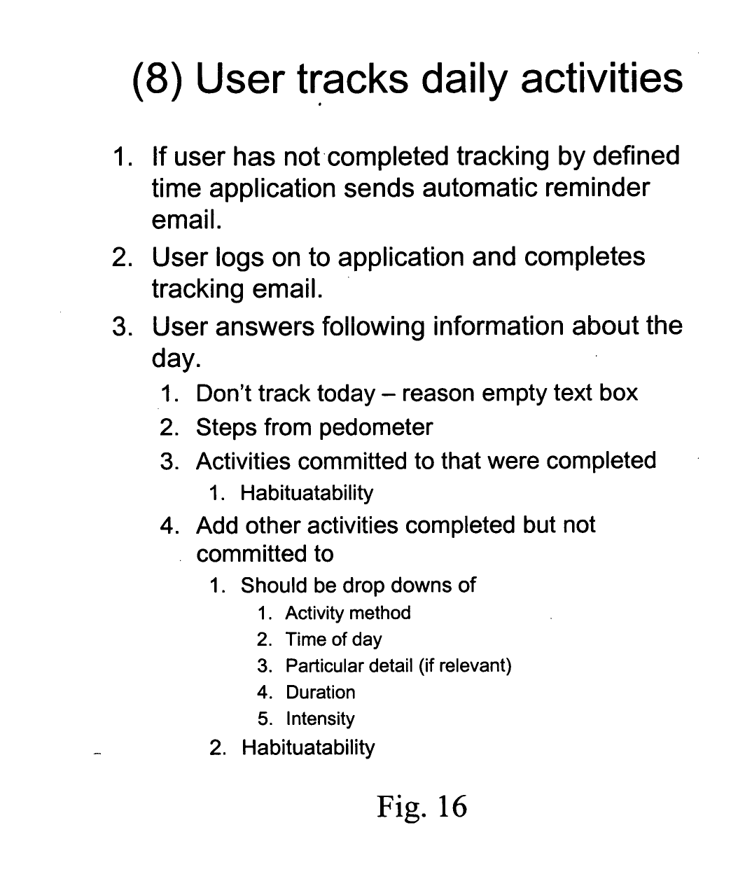

FIG. 16 illustrates operation of a part of an activity tracking module according to an embodiment of the present invention. The activity tracking module of the Lifestyle Coach application software determines whether a user has completed his or her activity tracking by a defined timeframe. For example, the user may establish that tracking may have to take place daily, one every two or three days, or weekly. If the activity tracking module of the Lifestyle Coach application determines that the tracking has not been completed, the activity tracking module initiates a process which causes the Lifestyle Coach application software to transmit a tracking email or text message to the user identifying that the user needs to complete the activity tracking for the defined timeframe. In response to the tracking email or text message, the user may logon to the Lifestyle Coach application software and compete the tracking to satisfy the activity tracking module. For example, the activity tracking module may ask the user to provide information regarding activities the user has completed. Illustratively, the user may select not to track activities for a timeframe within the defined timeframe. For example, the user may not track activities for a day. The user may also input steps from the user's pedometer. The user may also input activities that the user has committed to and were completed. The user may also input additional activities that were completed, but had not been committed to. Because these are new activities, the user may input the activity method, the time of the day, particular detail, the duration of the activity, and the intensity of activity.

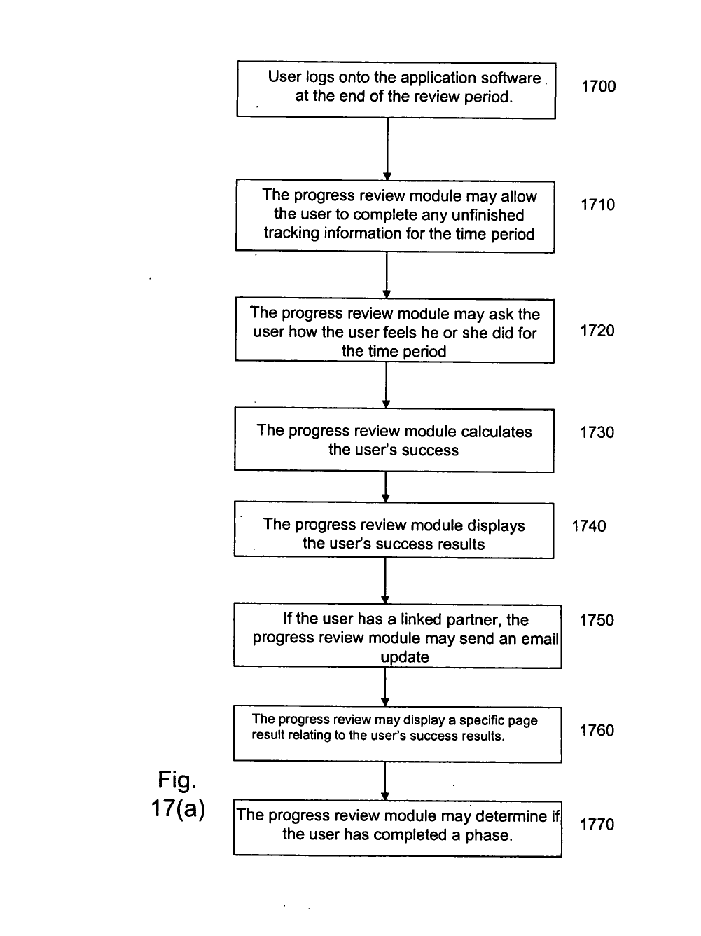

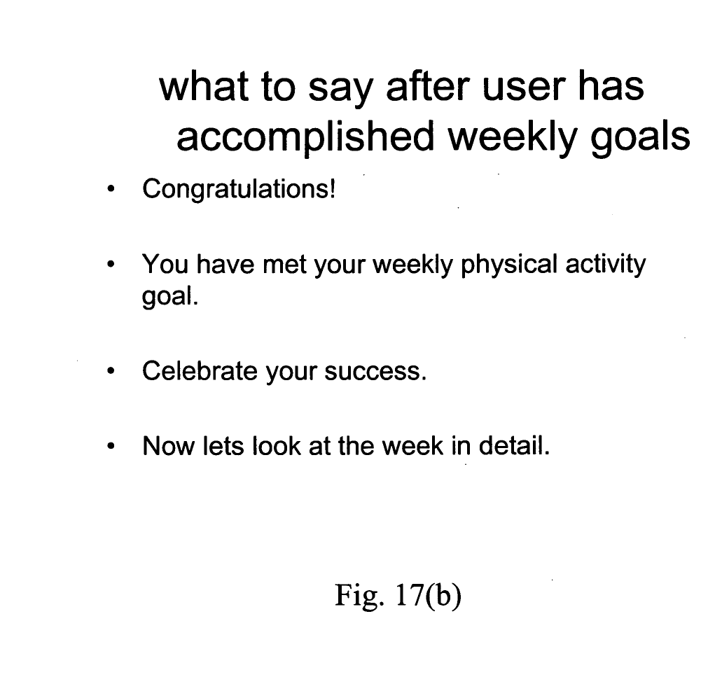

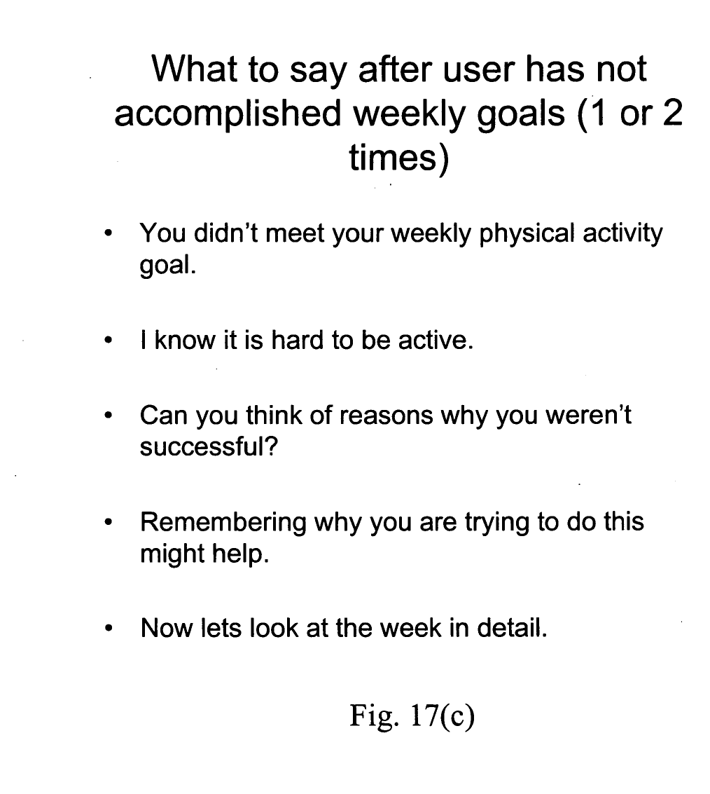

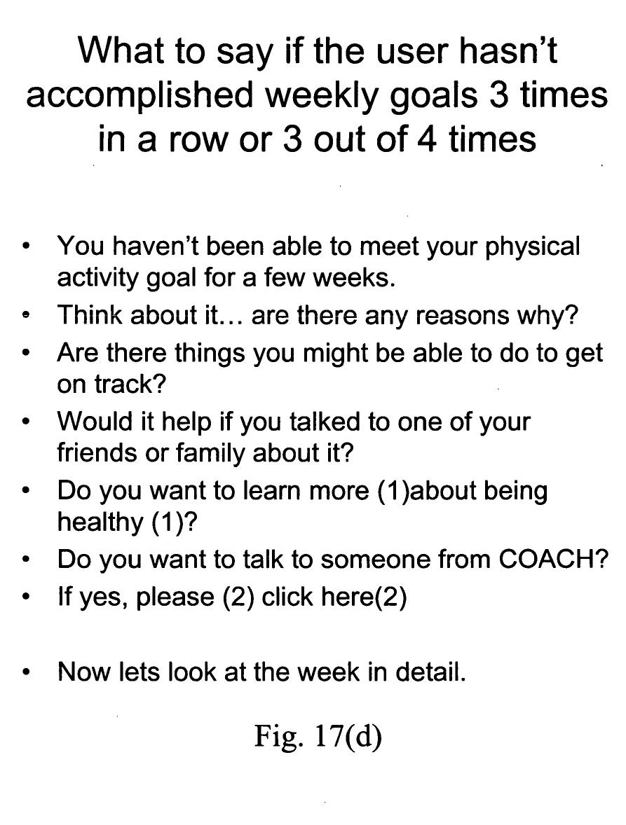

FIG. 17(a) illustrates operation of a progress review module according to an embodiment of the present invention. The user may logon 1700 to the application at the end of the review timeframe. The progress review module may allow 1710 the user to complete any unfinished tracking information for the time period, e.g., the week. The progress review module may ask 1720 the user how the user feels the user completed activities for the week The progress review module may calculate 1730 the user's success for the review timeframe. The progress review module of the Lifestyle Coach application software may display 1740 the user's success results for the review timeframe. Under certain operating conditions, the user may display specific text results depending on the user's success level (and maybe last several week's success). The progress review module may also display a graph of the average daily activity points against the activity point goal for the time period (e.g., week). Under certain operating conditions, the user may select to see additional user history.

If the user has defined a linked partner, the progress review module may initiate 1750 the sending of an email or text message by the Lifestyle Coach application software to the any identified partner. Illustratively, the email may include information about the user's success for the past week. The email may also include information about the last four time period's success. The email may also include information about activities that the user has committed to for the next time period (the next week).

The progress review module may display 1760 a specific page relating to the user's particular weekly success results. Under certain operating conditions, the progress review module may ask the user to identify reasons why the user was successful. The user may input multiple reasons for why the user was successful. If the user was not successful, the progress review module may identify reasons why the time period was unsuccessful. The user may input a number of reasons. The progress review module may then link to the barrier/motivation module.

The progress review module may also determine 1770 whether the user has completed the current phase. In an embodiment of the invention, if the user has exceeded the phase's activity point maximum for three weeks, then the progress review module may identify that the user has completed the phase. The progress review module may then link to a complete phase module.

The progress review module may calculate a user success against the target weekly activity points for the time period. Under certain operating conditions, if the user has an activity success percentage rate of less than 75%, then the progress review module may not indicate that the user has not been successful. If the user has an activity success percentage rate of greater than or equal to 75%, then the user has been successful. FIG. 17(b) illustrates a content page of text that the Lifestyle Coach application software that a user may display to a user if the user has achieved the user's goal. Illustratively, the software may identify that the user has achieved the weekly physical activity goal and should celebrate the user's success. The Lifestyle Coach application software may also present the user with a detailed look at the time period in review.

FIG. 17(c) illustrates a content page of text that the Lifestyle Coach application software may display to a user if the user does not meet the time period activity goals for one or two time periods, e.g., weeks. The application software may identify that the user did not meet the activity goal. The application software will attempt to motivate the user and may question the user to understand why the user has not met the activity points goal. The application software may then present the user with a detailed look at the reviewed time period. FIG. 17(d) illustrates a content page that the Lifestyle Coach application software may display to a user if the user does not meet the time period activity goals for three or more time periods. The application software presents more detailed feedback to the user. The application software asks the user if 1) there are any things that the user can think of to get back on track; 2) if anyone can be talked to (friend or family) who can help you achieve your activity point goals; 3) if the user needs additional information about being healthy; 4) if the user wants to talk to an individual familiar with the Lifestyle Coach application software. The application software then presents the user with a detailed look at the time period.

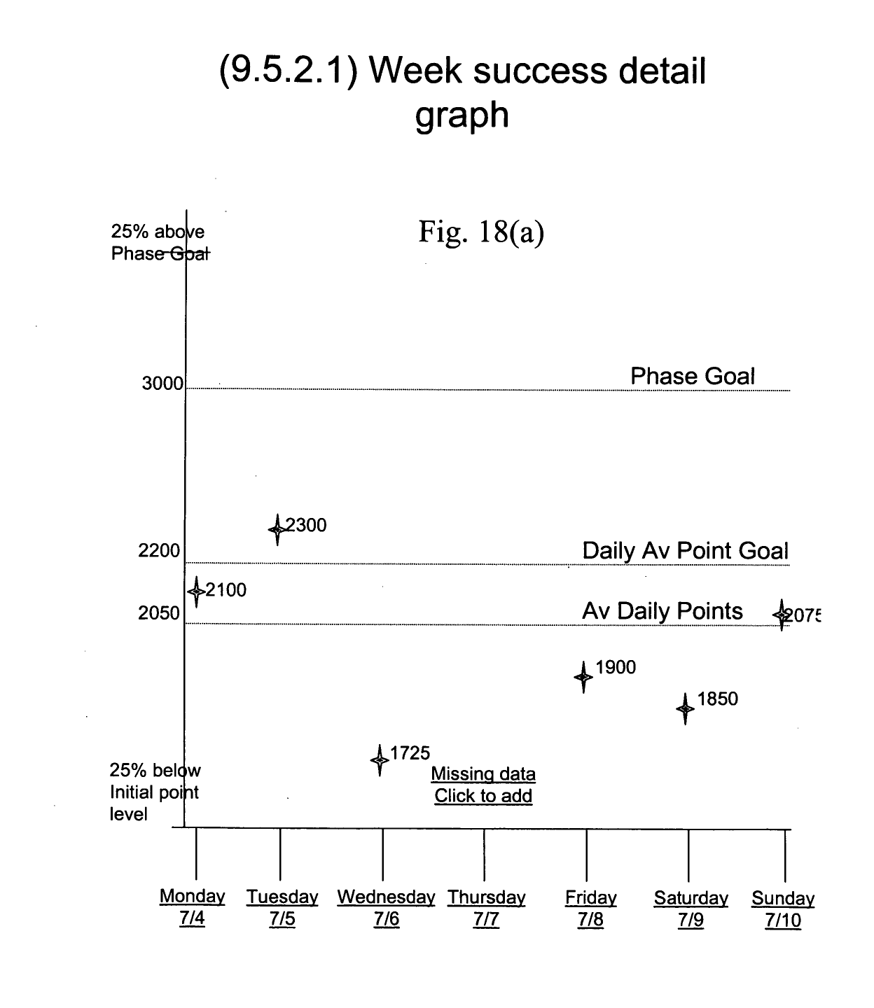

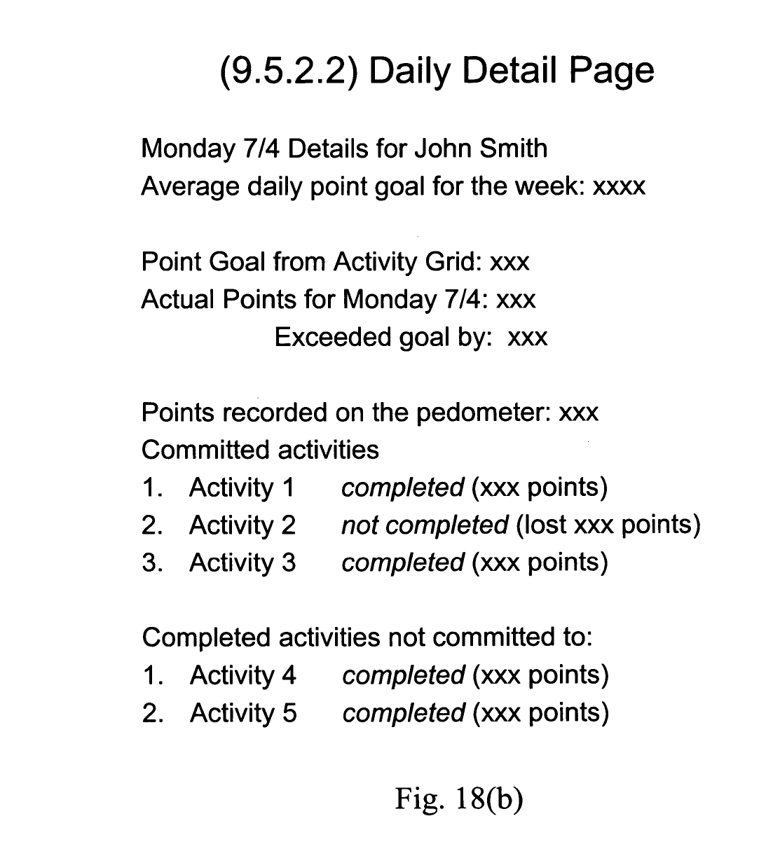

FIG. 18(a) illustrates a weekly success graph according to an embodiment of the invention. One axis of the graph is the activity point daily total and may range from 0-3000 activity points. Another axis of the graph are the days of the time period. The graph displays the activity point total for each of the days of the time period. The graph also presents an average daily point goal threshold, an average daily points for the user, and a phase goal for activity points that the user is attempting to achieve. The weekly success graph may also include an indicator identifying if any data for a day is missing. In the graph illustrated in FIG. 18(a), the data for Thursday, July 7, is missing, and the weekly success graph displays a message to add the missing data. FIG. 18(b) illustrates a daily detail page according to an embodiment of the present invention. The daily detail page may list an average daily point goal for the week. The daily detail page may list a point goal from the activity grid, the actual points for the measured day, and whether or not the user exceeded or missed the goal for that day. The daily detail page may list points recorded on the pedometer. The daily detail page may list points achieved for committed and completed activities. The daily detail page may also list points lost because committed activities were not completed. The daily detail page may list completed activities that were committed to along with the number of corresponding activity points.

The Lifestyle Coach application software may also include a barrier/motivation module. In using the Lifestyle Coach application software, the user will have completed a review of his or her success versus his or her goal for the past time period. The barrier/motivation module may be utilized to serve as a bridge between the past week's results and the activity level commitment and plan for the following time period or week. The content of the barrier/motivation module is intended to address specific barriers that participants in a behavior change program often feel. Illustratively, if the behavior is physical activity the barrier/motivation module may address specific barriers that participants in a fitness program or activity often feel. The application may also provide additional motivation text information. After completion of the barrier/motivation phase, the user is ready to move to planning the next week's activities. In other words, the barrier/motivation module may help the user prepare for a more successful following week.

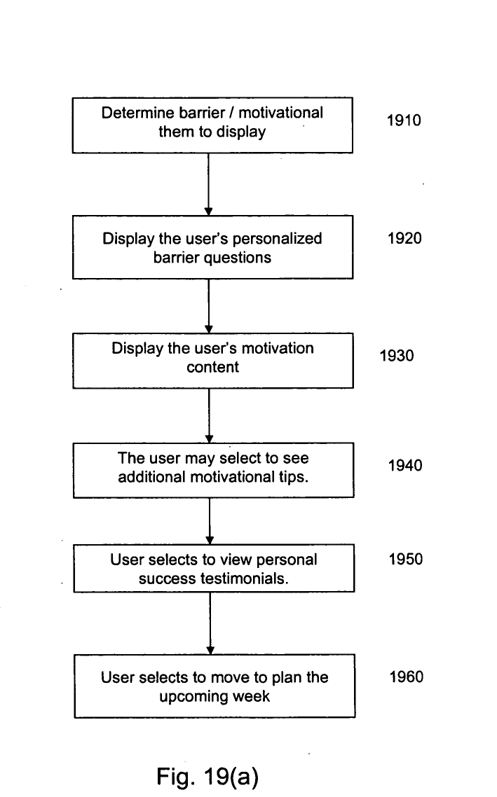

FIG. 19(a) illustrates operation of the address barrier and motivation module according to an embodiment of the present invention. The address barrier and motivational module may determine 1910 a barrier/motivational theme to display to the user. Under certain operating conditions, the barrier/motivational module may automatically decide which theme to display. In an embodiment of the invention, the user may determine the barrier/motivational theme to display. In response to the selection of the barrier/motivational theme, the barrier/motivational module may display 1920 personalized barrier questions. These questions may be developed based on the user's previous responses during the initial configuration of the Lifestyle Coach application software. The address barrier and motivation module may display 1930 motivational content. After displaying motivational content, the user may request that the barrier and motivational module display 1940 additional motivational tips. Under certain operating conditions, the barrier and motivational module may display 1950 personal success testimonials. If there are no testimonials in the database, then no testimonials may be displayed. After displaying any user testimonials, the user may select to plan the upcoming week.

Under certain operating conditions, the user may take a motivational/barrier survey where they answer a series of questions ranking the importance of barrier/motivational themes. Illustratively, there may be 21 current themes, which are divided into two categories (e.g., psycho-social and not-psycho-social). During this survey, the user is asked to group themes of each type into three sets, highly relevant, relevant, and less relevant. Based upon the user's answer to the motivational/barrier survey, the motivational/barrier module may create a user's specific ranking of the themes within each type. After the ranking is complete, the barrier/motivational module may display a choice of a number of themes to select, e.g., 4 themes. The barrier/motivational module may display two themes from each of the categories (psycho-social and not-psycho-social). Illustratively, if less than two themes in one category remain, the barrier/motivational module may display more themes from the other category. When the themes are displayed, the user then selects the theme to review and completes the review. After the review is completed, the barrier/motivational module marks that theme as being reviewed. As noted above, the barrier/motivational module may display determine a ranking of themes. The user may rank certain themes as highly relevant, relevant, and less relevant. The barrier/motivational module may have predefined rankings for each of the themes. Based on the user's inputs, the barrier/motivational module use the predefined rankings to rank the themes within each of the highly relevant, relevant, and less than relevant themes.

Under certain operating conditions, the barrier/motivational module may present the user with the option to view past themes. The user may then select one of the past themes to review. The barrier/motivational module may then present the user with text relating to the theme along with all of the user's answers to questions relating to the selected theme. Under certain operating conditions, the user cannot edit responses. As noted above, the user has the option to view motivational texts and also motivational testimonials. If the user selects this option, the barrier/motivational module may select a number of motivational texts. These texts may be displayed in a popup. The user may also be presented with the option of selecting more motivational texts. In an embodiment of the invention, the barrier/motivational module may allow the user an option to view testimonials. If the user selects this option, the barrier/motivational module to display a first testimonial in a popup window. The user may also have the option of displaying a next testimonial.

In order to develop personalized questions for the users, the barrier/motivational module may display a number of questions based on a theme importance. Illustratively, if theme importance is low, then a user may be shown two questions. If the theme importance is normal, then a user may be shown four questions. If the theme importance is high, the barrier/motivational module may display six questions. The barrier/motivational module may then determine an appropriate number of personalized questions to display. Questions may be ranked such that all questions ranked as 1 are shown to all users, questions ranked with 2 are shown to users with normal and high theme relevance and questions ranked with 3 are shown to high relevance users only. The barrier/motivational module may also include logic that is able to take into consideration individual user's characteristics in displaying several textual variations to display. After the user inputs answers to the personalized questions, the barrier/motivational module may store the answer to the personalize questions in the Lifestyle Coach application servers. The barrier/motivational module may support two types of responses to the motivational theme personalized questions, i.e., yes/no and free text. Upon loading into the Lifestyle Coach application software, the personalized questions may be marked as yes/no or free text. The barrier/motivational module may display yes/no questions with a radio button option of yes/no. The barrier/motivational module may display the free text questions with a text box display. Under certain operating conditions, only the yes/no questions may be used to personalize the motivational texts. Under certain operating conditions, only answers to free text questions may be saved so that the user may be able to view them later. These free text answers may not affect the logic of which motivational texts to display.

The barrier/motivational module may include logic to determine what theme to display. For example, the barrier/motivational module may display four motivational texts. The barrier/motivational module may store a number of motivational texts, each having a priority assigned to it. Each text may also have a personalized question associated with it along with personal characteristics. The barrier/motivational module may calculate the priority of the motivational texts for a particular user. For example, if a motivational text associated with a particular personalized question corresponds to a question that the user answered yes to, the motivational text may be assigned a high priority. A second priority may be given to motivational texts that match the user's personalized characteristics. The display screen may also contain an open text box that presents the user with information on how to minimize the motivational barrier. The barrier/motivational module may allow a user click on a link to go to more motivational tips to overcoming the barrier. The barrier/motivational module may allow a user to click on a link to go to personalize success testimonials.

FIG. 5(g) illustrates a sample screen shot for a personalized motivational screen according to an embodiment of the invention. The personalized motivational screen may display a number of the tips for the user, e.g., turn off the television or find more ways to be active during your work day. The personalized motivational screen may also provide an input box that the user can enter information into in order to address the barrier that the user faces. The personalized motivational screen may also allow a user to click on a link for overcoming time pressure. The personalized motivational screen may also allow a user to click on a link to see the personalized testimonials of people who have found ways to minimize their lack of time. Finally, the personalized motivational screen may also provide a use a link to go ahead and plan for the next week. The barrier/motivational module may include logic to display more tips. The application may display four additional tips to overcome a thematic barrier in a new popup window. The Application may display tips 5-8 which are the highest priority for the user.

The barrier/motivational module may present the user with the option to view personal success testimonials. If no personal testimonials are stored, the user may not have the opportunity to select testimonials. The barrier/motivational module may include logic that matches user's characteristics to stored personal success testimonials and then to display the testimonial that most closely matches the user's characteristic. When the testimonials are stored, they will include a number of stored characteristics. The barrier/motivational module may compare the user's characteristics with the stored characteristics for the testimonial and find the testimonial that shares the most characteristics with the user's characteristics. If there are more testimonials for the specific theme, the barrier/motivational module may display additional options for he user to view more testimonials. The barrier/motivational module may display the next best match, e.g., the testimonial having the next most common characteristics with the user characteristics. Under certain operating conditions, the barrier/motivational module may not display the same testimonial more than once.

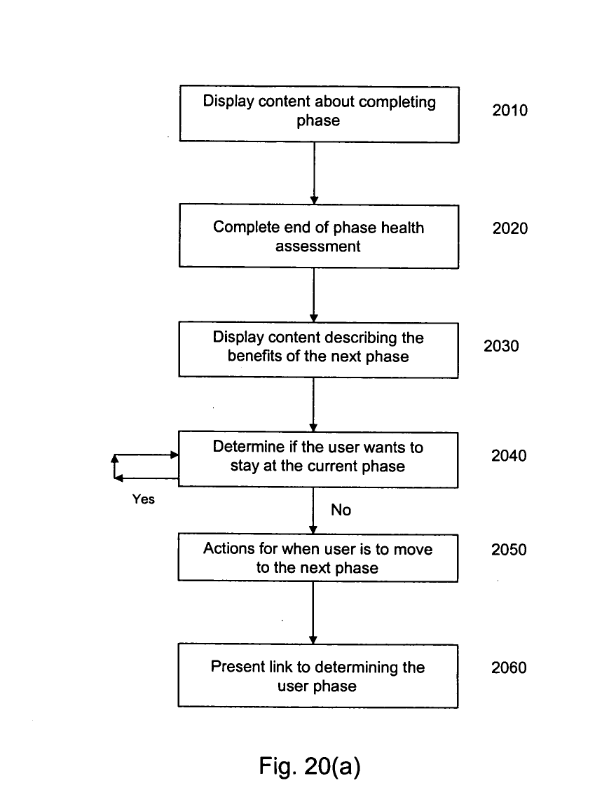

FIG. 20(a) illustrates actions which occur at the completion of a user phase according to an embodiment of the present invention. The Lifestyle Coach application software may display 2010 content about completing a phase. The user may respond by completing 2020 an end of a phase user assessment. The Lifestyle Coach application software may display a number of health assessment questions, such as weight and a fitness scale. Based on the user's answers, the application software may display health assessment results. Based on the results, the application software may update the user profile.

After the user profile is updated, the application software may display 2030 the benefits of the next user phase in the Lifestyle Coach application. The user may be asked if the user would like to go to the next phase. If the user is in the final phase of the program, the user may remain in a maintenance phase. If the user wants to stay 2040 at the current user phase, the user may have to provide additional information to the Lifestyle Coach application. The user may provide information to questions regarding barriers to achieving the next phase. The application software may display motivational content about the barrier. The application software may display additional content about phase maintenance.

If the user wants to move onto the next phase, the user moves 2050 to the next phase. The application software may display content about the next user phase's barriers and motivators. The application software may ask questions about the user's level of commitment. The application software may utilize the answers provided by the user to update the user's readiness to change parameter. The application software may display content habituating activities. The application software may have an option of allowing the user to select for the activities be automatically transferred over from the last phase utilizing the same duration and frequency. The application software may also ask the user if he or she wants to actively continue to track daily activities from the past phase. The user may also have the option to link 2060 to module for determining a user phase.

The Lifestyle Coach application software may also include a review history module. The review history module may allow the user to access the user's personal program history. The user may select to review the current week's activity points and the activity successes. These may be presented in list form. The review history module may also allow the user to review any past week's successes. Illustratively, the user may select a particular week. In response, the review history module may display a graph of activity points for each day. The review history module may also display summary of user activity results for each activity and activity classes. The review history module may also allow a user to see trend results for multiple weeks. Illustratively, the user may select a week range. In response, the review history module may display a graph including: 1) an average daily activity point goal for each week; 2) an actual average daily activity point for each week; 3) a word summary result of activity point successes, daily activity successes, and exercise activity successes for each week. The review history module may also allow a user to select to review past week's activities and commitments. Illustratively, the user may select a week range. The review history module may display the activity commitments by day for the week range. The review history module may also allow a user to update personal profile.

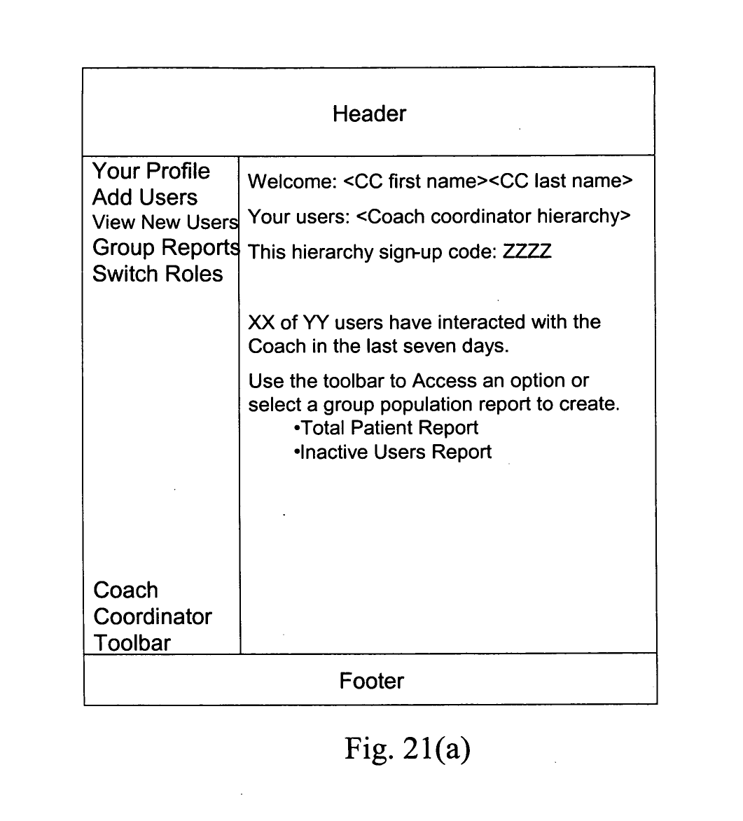

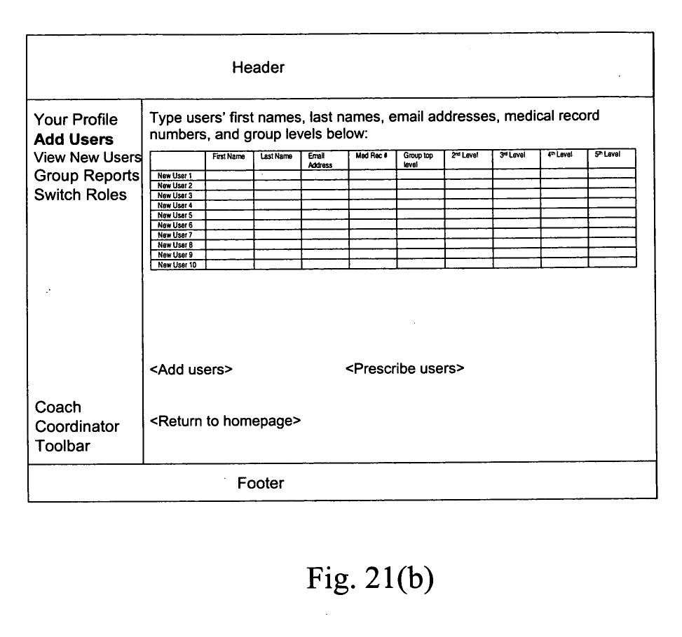

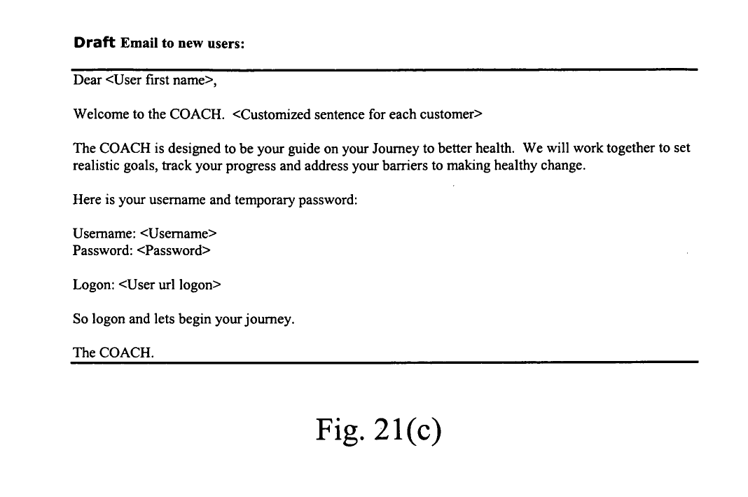

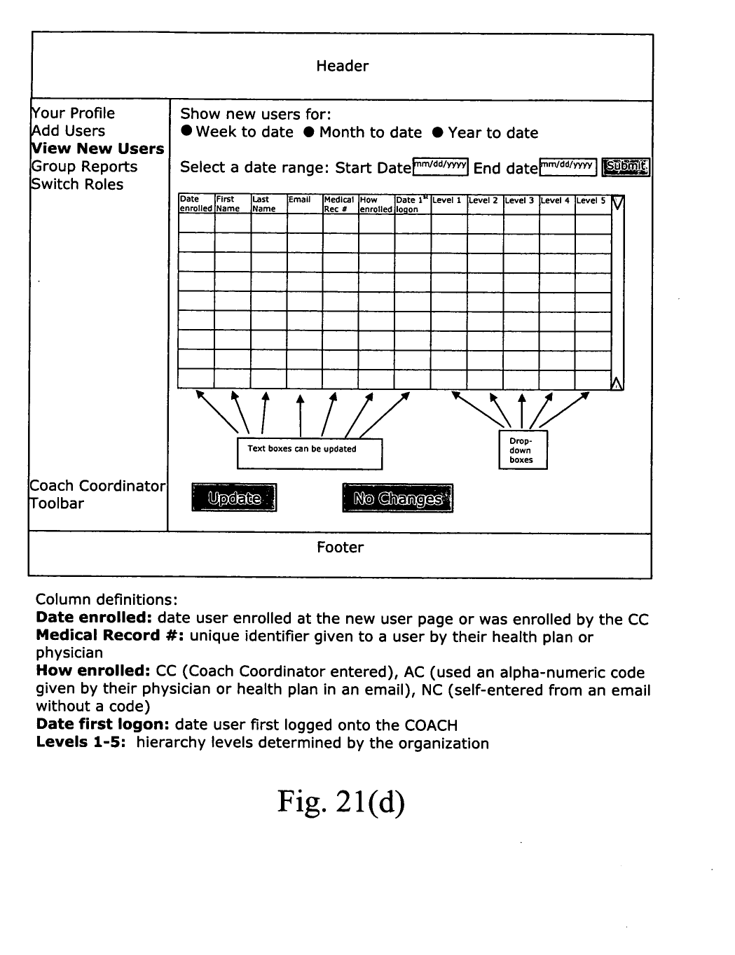

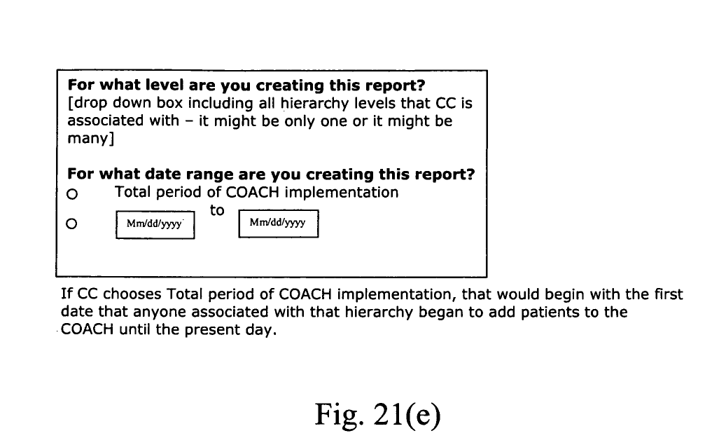

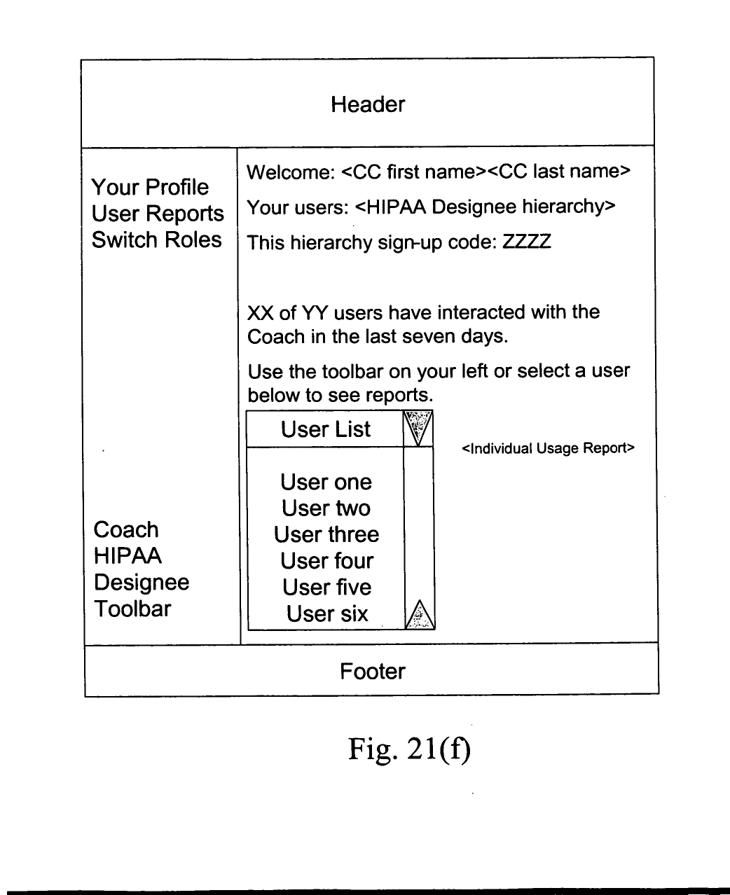

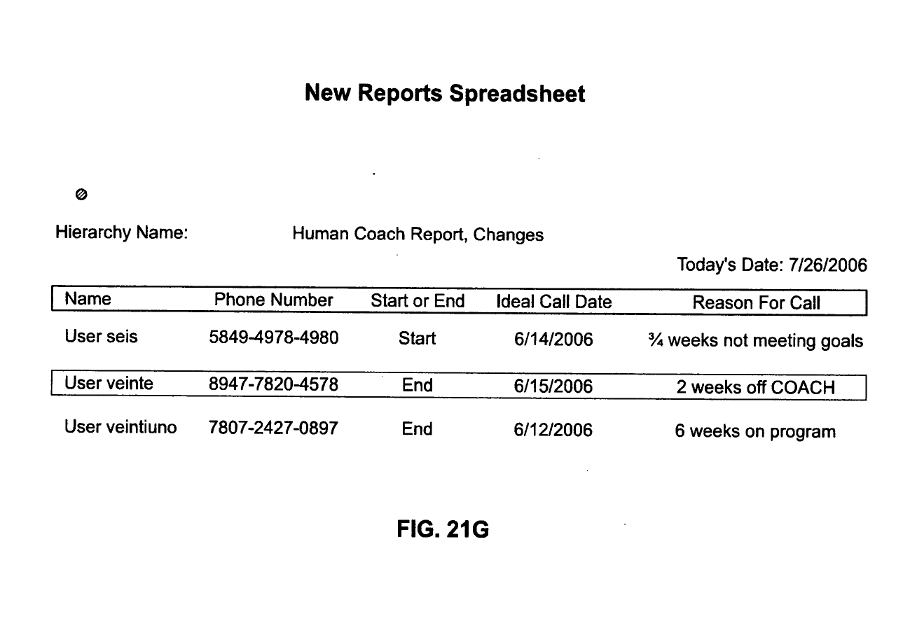

The Lifestyle Coach application software may include a coach coordinator module. A coach coordinator is an individual who may help a number of users interact with the Lifestyle Coach application software and achieve their goals. The coach coordinator module allows the coach coordinator to login into the Lifestyle Coach application software to track performance of the coach coordinator's users and to perform administrative functions. The coach coordinator may access a logon page for one of his user's instance by entering a user name and password. In response to the entering of the user name and password, the coach coordinator module may display a coach coordinator homepage. The user can then select one of the options from the toolbar or a report from the homepage. FIG. 21(a) displays a coach coordinator homepage according to the present invention. The coach coordinator may be associated with more than one role. The coach coordinator module, after entering the Lifestyle Coach application software, may allow a user to select a switch role option according to an embodiment of the present invention. The coach coordinator module may display a switch roles screen for the coach coordinator. The coach coordinator may select the role and submit that role change to the coach coordinator module for saving. Based on the role change, the coach coordinator module may display different screens to the coach coordinator. This allows the coach coordinator to switch from one of his or her roles to another roles. The coach coordinator module may also have an option for resetting a forgotten password.

The coach coordinator module may allow a coach coordinator to add a user. The coach coordinator may display a page to add names and emails of new users. Under certain operating conditions, the coach coordinator may type in the name, the emails, unique medical record numbers, and hierarchy levels of new users. After this, the coach coordinator may select the add users option. After the new users are added, the coach coordinator module may send an automatic email to newly enrolled users. Under certain operating conditions, the email may contain a personalized sentence that is customized based on the user's level within the hierarchy. Under certain operating conditions, the coach coordinator module may allow the coach coordinator to select a prescribe users option. If the coach coordinator selects this option, the coach coordinator module may automatically email users informing the users they have been prescribed into the Lifestyle Coach application software. FIG. 21(b) illustrates an add users page of the coach coordinator module according to an embodiment of the present invention. FIG. 21(c) illustrates a sample email of the coach coordinator module according to an embodiment of the invention.

The coach coordinator module may also include a view all users or a view new users option. Under certain operating conditions, the coach coordinator module may display a page in which all users under the guidance of the coach coordinator are displayed. In an embodiment of the invention, the coach coordinator module may display a list of all the new users within a specified time period, e.g., 30 days. The coach coordinator may modify this specified time period to weekly, biweekly, quarterly, etc. The coach coordinator module displays information about the new users such as date enrolled, first and last name, unique medical record number, how the user enrolled, the date of first logon, the number of levels in the Lifestyle coach application software and where the user is within the number of levels (or phases). Under some operating conditions, the coach coordinator may have to enter the hierarchy level where the user resides. The coach coordinator can modify the dates on what users to display. The coach coordinator module may also present the coach coordinator with certain behavior or activity performance information for the user. The user can change a viewing option for the performance information. If the coach coordinator has updated any information, the coach coordinator may select an update option. If no users have been added in the specified time frame, the coach coordinator module may display that no new users have been added. FIG. 21(d) illustrates a view new users page according to an embodiment of the invention. FIG. 21(e) illustrates a sample input screen for selecting what users are viewed according to an embodiment of the invention.

The coach coordinator module may include a view group reports option. Under certain operating conditions, the coach coordinator module may display a page identifying all of the users which are related or under the control of the coach coordinators along with selection icons or buttons which a coach coordinator may utilize to select reports to be generated. Illustratively, the coach coordinator may select a total patient report as well as an inactive users report. In response to the coach coordinator selecting a report, the coach coordinator module may display (in a pop-up window, for example) an input screen asking for a hierarchy level and/or a date range. The coach coordinator module may respond by generating a report and displaying the selected report to the user, e.g., in a .pdf format. The coach coordinator module may allow the user to view the report, print the report, or save the report. After interacting with the selected report, the coach coordinator may return to a home page of the Lifestyle Coach application software.

The coach coordinator module may allow the coach coordinator to update his or her personal profile or to update personal profiles of users that are under the guidance of the coach coordinator. The coach coordinator module may present a screen with the coach coordinator's personal information, such as first name and last name (which are editable) and username (which is not editable). The coach coordinator module may also display the coach coordinator's group hierarchy information. In response, the coach coordinator may edit the editable information. If any information is changed, the coach coordinator may save the modified personal information. The coach coordinator may also be able to change a password or reset a password. After completion of editing or viewing the coach coordinator's information, the coach coordinator module may send the coach coordinator back to a homepage of the Lifestyle Coach application software application.

The Lifestyle Coach application software may also include a Health Insurance Portability and Accountability Act (HIPAA) designee module. Under certain operating conditions, when a user logons to the Lifestyle Coach application software, the Lifestyle Coach application software may present the user with a number of roles, e.g., if the user has been assigned a number of roles. The user may select the HIPAA designee role and if the HIPAA designee role is selected, the HIPAA designee module may display a HIPAA designee page. FIG. 21(f) illustrates a HIPAA designee homepage according to an embodiment of the present invention.

The HIPAA designee homepage may include a option to select a user report. If the HIPAA designee selects this option, the HIPAA designee module may display a page with all users that are related to the HIPAA designee. The HIPAA designee module may also allow a HIPAA designee to run individual user's usage reports. For example, the HIPAA designee may select one particular user of the Lifestyle Coach system. The HIPAA designee may also select the view individual user usage report option. In response, the HIPAA designee module may display the individual user's usage report as a .pdf in a separate window of the Lifestyle Coach application software. The HIPAA designee may then view the usage report, print the usage report, and save the usage report. After the HIPAA designee is done with the report, the user may select to return to the Lifestyle Coach application software homepage. In an embodiment of the invention, the HIPAA designee module may display a number of users and the HIPAA designee may select a user and also a report type option immediately after the user has been selected. Additionally, in an embodiment of the invention the HIPAA designee may select a user and view a report of that user's progress in the application. The HIPAA Designee may also view a report of events related to an individual user or all the user that are triggered by some action in the application. FIG. 21(g) illustrates an example of these reports.

The HIPAA designee module may allow the HIPAA designee to update his or her personal profile or to update personal profiles of users that are under the guidance of the HIPAA designee. The HIPAA designee module may present a screen with the designee's personal information, such as first name and last name (which are editable) and username (which is not editable). The HIPAA designee module may also display the designee's group hierarchy information. In response, the HIPAA designee may edit the editable information. If any information is changed, the HIPAA designee may save the modified personal information. The HIPAA designee may also be able to change a password or reset a password. After completion of editing or viewing the HIPAA designee's information, the HIPAA designee module may send the HIPAA designee back to a homepage of the Lifestyle Coach application software application. The HIPAA designee module may also allow the HIPAA to select a different role. If the HIPAA designee selects a different role, the HIPAA designee module is exited and the HIPAA designee may assume another role in the Lifestyle Coach Behavior Modification system.

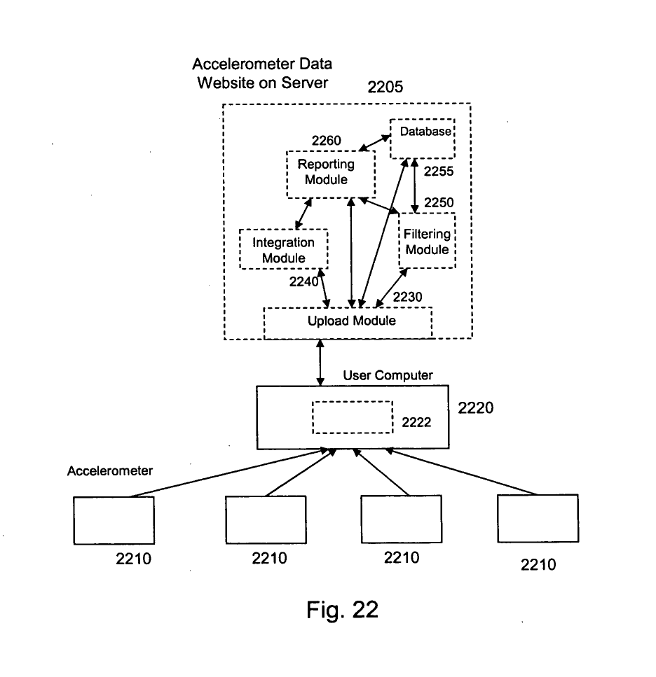

FIG. 22 illustrates an accelerometer data research site according to an embodiment of the invention. Researchers who are conducting studies where physical activity levels are measured outcome face a number of challenges. First, users may be wearing physical activity monitoring devices and the users may not interact frequently with the researchers. The users may also be geographically dispersed. Once data is input into the accelerometer data research site, the researchers may need to filter the data to determine when certain activities or time periods have occurred. The researcher may also want to analyze and compare the physical activity between subjects. The researcher may want to create trend analysis and key indicators of the activity outcomes. The researcher may also wish to integrate activity monitoring data with other information on the subjects in order to create a more complete assessments of the determinants of the activity levels.

As illustrated in FIG. 22, the accelerometer data center system includes an accelerometer data center server 2205, a computing device 2220 including a desktop application 2222, and a plurality of accelerometers 2210. The accelerometer data website may be located on an accelerometer data center server 2205. The accelerometer data website 2205 may include an uploading module 2230, an integration module 2240, a filtering module 2250, and a reporting module 2260.

The accelerometers 2210 may gather physical activity data for a number of users. The desktop application software 2222 on the user computer 2220 may control the uploading of information from the accelerometer 2210. The desktop application software 2222 may also control the upload of data from the user computer 2220 to the accelerometer data center server. The uploaded data is then loaded into the database 2255 of the accelerometer data center server. The uploaded data may pass through the uploading module 2230. In the embodiment of the invention illustrated in FIG. 22, a plurality of accelerometers may input data into a computing device 2220 (for example, if the computing device is a researcher's computing device). Under an alternative embodiment of the invention, one accelerometer 2210 may be paired with a single computing device 2220. In this embodiment, the desktop application software 2222 may control the uploading of information from the one accelerometer 2210.

The integration module 2240 may add additional information about the research subjects to the uploaded data. Illustratively, the uploaded data may be sent to the integration module 2240 where the uploaded data is integrated with other subject information. The other information may be input to the accelerometer data center server 2205 or may be input into the user computer 2220 and uploaded to the accelerometer data center server. For example, a treatment limb applicable to the subject may be integrated with the uploaded accelerometer data. Illustratively, basic demographic information for the user may be integrated with the uploaded accelerometer data. In addition, identifying information about the user may also be integrated with the uploaded accelerometer data. Further, there may be additional customizable fields that are integrated with the uploaded accelerometer data.

The filtering module 2250 may filter the uploaded data or the integrated data according to researcher selected criteria. For example, the researcher may define a number of hours of accelerometer data that are necessary for a countable day. The researcher may also define a number of days that are necessary for a countable week. The researcher may define a number of minutes that are necessary for a countable bout (or activity bout). The researcher may also establish filters that remove data anomalies, such as data readings that are above a certain threshold.

The reporting module 2260 may allow the user to view summary results and present a graphical display of information. The reporting module 2260 may apply basic filters before generating the reports. The reporting module 2260 may gather information from the database 2255 before generating the reports. Illustratively, a report may graph activity level over time for a user. Another report may graph activity versus intensity for the user. An additional report may graph the bouts of activity for the user. The reporting module may also provide reports that summarize group information. The group reports may display averages of all of the users. The group reports may also display graphical comparisons between user's activity information. The reporting module 2260 may also export information to other applications. For example, the reporting module 2260 may create export files in formats such as .csv files, Excel files, Stat files, and SAS files.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A computer-implemented method to support a user adopting healthy habits and behaviors, the method implemented when instructions stored on a computer-readable storage medium are executed by a computer, the method comprising:
displaying lectures on healthy habits and behaviors, the lectures being stored on a computing device;
providing a user with a current level of the user's behavior after receiving background information from the user;
receiving an action goal and storing the action goal;
creating an action plan to reach an action goal and storing the action plan
tracking behaviors of the user by receiving input regarding the behaviors, the tracking of the behaviors resulting in behavior measurements;
generating results by comparing the behavior measurements against the action goal and the action plan; and
displaying information to assist the user to overcome barriers to reach the action goal.

2. The computer-implemented method of claim 1, wherein the behavior is physical information, the action goal is an activity point goal, and the action plan is an activity plan.

3. The computer-implemented method of claim 1, wherein the behavior is adopting healthy nutritional and dietary habits, the action goal is a diet and nutrition goal, and the action plan is diet and nutrition plan for the user.

4. The computer-implemented method of claim 1, wherein the behavior is the user adhering to a medical regiment, the action goal is an adherence goal, and the action plan is a listing of specifics of adhering to the medical regiment.

5. A computer-implemented method to allow a member of an organization to support an individual's adoption of healthy behaviors and habits, the method implemented when instructions stored on a computer-readable storage medium are executed by a computer, the method comprising:
altering appearance of user interface screens and application functioning to match the organization's approach to adopt the healthy behaviors and habits;
monitoring the individual's progress using a behavior change support module;
generating reports based on the individual's behaviors;
transmit personalized messages regarding the individual's performance;
receiving data from other software applications and exporting data regarding the individual's behaviors to a first software application; and
complying with privacy and security requirements of the organization.

6. The computer-implemented method of claim 5, wherein the organization is a health care organization, the data is exported to the health care organization's patient portal and/or electronic medical record system, and the privacy requirements are HIPAA requirements.

7. A computer-implemented method of claim 5, wherein the member is a human resources personnel.

8. A computer-implemented method for behavior modification, the method implemented when instructions stored on a computer-readable storage medium are executed by a computer
displaying a plurality of types of actions related to the behavior;
displaying an action grid, wherein the user can select an action from the plurality of types of actions and place the action on the action grid into a grid place representing a time slot of a day; and
calculating an impact on an action plan in response to the placement of the action onto the action grid.

9. The computer-implemented method of claim 8, wherein the behavior is physical activity and the action may be one of different physical activity types.

10. A device to support a user adopting healthy habits and behaviors, the device including:
a reminder module to generate automated reminders of planned actions;
a tracking module to provide automated tracking of completed actions;
an activity grid module to allow the user to view planned actions and adjust an action plan;
a progress review module to view completed actions against the action plan; and
a reporting module to transmit information to an behavior change server.

11. The device of claim 10, wherein the behavior is physical activity, the completed actions include a number of steps and the intensity of motion in the number of steps, and the plan is an activity plan.

12. A computer-implemented method to allow a user to build a support community to help adoption of healthy habits and behaviors, the method implemented when instructions stored on a computer-readable storage medium are executed by a computer, the method comprising:
establishing a community of individuals in a server by storing an identification corresponding to each of the community of individuals;
sharing individual goals, plans and results with the community of individuals by sending a message to the identification corresponding to the community of individuals; and
inviting other individuals to participate in the healthy behavior change by sending an invitation message to the other individuals.

13. A computer-implemented method to customize and personalize an experientially learning process regarding an individual's behaviors and adoption of healthy behaviors and habits, the method implemented when instructions stored on a computer-readable storage medium are executed by a computer, the method comprising:
receiving an individual's personal characteristics;
displaying a lecture which teaches importance of healthy behaviors based on the received personal characteristics for the individual;
generating a personal profile of the individual's actions based on input received from the user;
creating an action plan and an action goal based on the received personal characteristics; and
addressing barriers by displaying motivational information to adopt healthy habits based on the received personal characteristics.

14. The computer-implemented of claim 13, wherein the behavior is physical activity, the action plan is an activity plan, and the action goal is an activity point goal.
